(19) United States
(12) Patent Application Publication
(10) Pub. No.: US 2002/0120906 A1
(43) Pub. Date: Aug. 29, 2002

(54) Behavioral modeling and analysis of galvanic devices

(76) Inventors: Lei Xia, Acton, MA (US); Tom Hartley, Mogadore, OH (US)

Correspondence Address: Ray L. Weber, Renner, Kenner, Greive, Bobak, Taylor & Weber, Fourth Floor, First National Tower, Akron, OH, 44308-1456, US

(21) Appl. No.: 09/906,466

(22) Filed: Jul. 16, 2001

Related U.S. Application Data
(60) Provisional application No. 60/218,715, filed on Jul. 17, 2000.

(51) Int. Cl. G06F 17/50

(52) U.S. Cl. 716/2

(57) ABSTRACT

A new hybrid modeling approach was developed for galvanic devices including batteries and fuel cells. The new approach reduces the complexity of the First Principles method and adds a physical basis to the empirical methods. The resulting general model includes all the processes that affect the terminal behavior of the galvanic devices. The first step of the new model development was to build a physics-based structure or framework that reflects the important physiochemical processes and mechanisms of a galvanic device. Thermodynamics, electrode kinetics, mass transport and electrode interfacial structure of an electrochemical cell were considered and included in the model. Each process of the cell is represented by a clearly-defined and familiar electrical component, resulting in an equivalent circuit model for the galvanic device. The second step was to develop a parameter identification procedure that correlates the device response data to the parameters of the components in the model. This procedure eliminates the need for hard-to-find data on the electrochemical properties of the cell and specific device design parameters. Thus, the model is chemistry and structure independent. Implementation issues of the new modeling approach were presented. The validity of the new model over a wide range of operating conditions was verified with experimental data from actual devices.

### CROSS REFERENCE TO RELATED APPLICATION

This is a non-provisional application of copending provisional patent application Serial No. 60/218,715, filed Jul. 14, 2000, entitled “Behavioral Modeling And Analysis Of Galvanic Devices.”

### TECHNICAL FIELD

The present invention is directed generally to the operation of galvanic devices. In particular, this invention is directed to methodologies of improving the construction of galvanic devices, such as batteries and fuel cells, and how best to control their charging and discharging processes.

### BACKGROUND ART

As a primary power source, batteries have been widely used in portable devices such as cellular phones, hand tools, and electrical back-up equipment such as Uninterrupted Power Supply (UPS). Batteries are used in these applications where the main electrical power source is not conveniently or dependably available. However, the economic driving forces for the recently intensified research on batteries and fuel cells has come mainly from the automotive and electrical utility industries. Automotive companies, whose products are a major source of air pollution, strive to use alternative technologies to minimize this negative side effect. Electrically powered vehicles seem to be an ideal solution for this dilemma. Although batteries have been used in electrical vehicles, it is now generally accepted that a pure battery-powered vehicle would not likely be the choice of the mass transportation market in the near future. This is because current battery technologies cannot offer the same features that customers are accustomed to, such as long driving range and short energy replenishing time, which are found in a gasoline engine vehicle. Fuel cells overcome these disadvantages by storing fuels separately from the converter, and appear to hold a more promising future in the transportation industry. Recently, many automotive manufacturers have announced their ambitious fuel cell-powered vehicle programs.

In the electric power utility industry, the debate has been on the relative merits between a traditional centralized power generation system versus a decentralized, or distributed but connected, power network. There are two major advantages of using a distributed power system: 1) to reduce the cost and power loss associated with power transmission; and 2) to increase the reliability of the whole power network through a more fault-tolerant power infrastructure. It was proposed, and implemented in a small-scale, that stand-alone fuel cells be used as the primary power source, in residential, commercial and industrial sites. Small fuel cells were also proposed to replace batteries in portable devices.

The critical components for these potentially large emerging markets are the power generating and storage devices, whose performance would directly affect their acceptability in these markets. The electrochemical energy conversion process has the advantages of high conversion efficiency, high power and energy density, large power output, environmental friendliness and a large selection of working fuels. Therefore, electrochemical devices are considered the most promising alternative technology to the conventional electrical power source. Batteries and fuel cells are all based on electrochemical processes and are known as galvanic devices.

On the other hand, there are still many challenges before galvanic devices can be more widely accepted. In many critical measures of a power device, notably, the energy and power density, convenience of energy replenishment (battery charging), manufacturing and usage cost, galvanic devices still cannot compete with more conventional devices such as an internal combustion engine (ICE). Improvements in galvanic devices are being made in three areas: 1) higher performance chemistry, materials, and operating condition, e.g., lithium-ion batteries and high-temperature fuel cells; 2) better device design and construction, e.g., thin film electrode and Micro Electro-Mechanical Systems (MEMS) construction; and 3) better utilization of a device, e.g., pulsed discharge.

Research on galvanic devices is conducted in two broad areas. The first of these areas is in the device design, where the goal is to investigate and better understand various factors that control the conversion process and develop materials and construction having characteristics best suited for device performance. The result of the research in this area is usually a higher performance device. The second research area is in the application of a device, where the goal is to understand the performance characteristics of the device and design a better solution for an application. The quality of the solution can be defined in many different ways depending on the requirements of specific applications. For example, faster charging time, higher instant power output, longer device life, and accurate estimate of the state of charge of a battery, are all considered to be desirable features of an application.

The research conducted in the device design area has, by far, been the majority of the work on galvanic devices. Understandably, any breakthrough or progress in this area will receive the most attention, justifiably so since it usually represents the performance improvement of a device. On the other hand, research in the application issues of a galvanic device has been very limited, or even overlooked in some areas. In fact, ever since their invention, batteries have been used in rather primitive ways. Even today, determining the state of charge of a battery during its operation is not possible except in the most sophisticated applications. Few means are available to monitor the health of a battery even when it is used in mission-critical applications. Little thought has been given to more efficient utilization of a battery. Methods for the analysis of device characteristics and the knowledge of device behavior under various operating conditions are nearly non-existent. Dynamic control of galvanic devices has not been considered. These application issues, if not adequately addressed, can limit the performance of galvanic devices while, on the other hand, if properly considered, can enhance the performance of the whole system.

Research in the design and application of galvanic devices can effectively be conducted with assistance of theoretical models. Not surprisingly, the majority of the numerous models that have been developed for galvanic devices were aimed at the design issues of the devices, where the goal was to relate the device performance to the materials and construction of the devices. In these models, the so-called First Principles method was invariably used. This method uses numerical simulation techniques, such as Finite Difference Element (FDE), Finite Element Analysis (FEA) or Computational Fluid Dynamics (CFD), to divide the continuous structure of a device into small partitions. Physical and chemical relationships are then applied to each element. One advantage of the First Principles model is its capability to reflect the detailed design factors in the model, such as the material and device configuration, and examine the effect of these variables on the device performance. Although empirical relationships are frequently used to represent some processes that cannot be theoretically determined, First Principles models are generally physics-based, i.e., the behavior of a device is determined by the physical relationships used in the model. Again, the strength of the First Principles models is to understand the effect of design factors on the performance of a device during the design stage.

Once a device is available and being considered for an application, the First Principles model is no longer effective or appropriate to provide information on the device characteristics to the users of the device for the following reasons. First, the First Principles method for a galvanic device model is not practical for device users. Extensive electrochemical knowledge is required to determine the processes and parameters of a galvanic device using the First Principles method. The mostly non-electrochemical specialist users of galvanic devices do not generally have this knowledge. The First Principles method needs information on the detailed mechanical configuration of a galvanic device in order to correctly determine boundary conditions. Again, this information is generally not available to device users. Second, First Principles models are usually very complicated since they are often expressed by large-scale matrices. Each First Principles model is only valid for an individual device of specific chemistry and mechanical design. If the materials and design of a device are changed, the model must be changed accordingly, which limits the flexibility of this method. Third, analysis and application using the First Principles models are difficult. First Principles models are normally verified with only limited response, usually the constant current discharge. Other device characteristics, such as the dynamic response or the state of charge of a battery, are difficult, if not impossible, to analyze using the First Principles models since it is generally difficult to study device behavior using a high-order system model. First Principles models are also computationally intensive, due to their complexity; hence, any real-time, on-line application using the models is limited.

Because of these drawbacks, First Principles models for galvanic devices have not been widely used by device users. In practice, when the information of behavioral characteristics of a galvanic device is required, an empirical model is often used. Empirical models describe the performance behavior of a galvanic device using somewhat arbitrary mathematical relationships. The physical basis for the observed device behavior is not the main concern of this approach. The empirical models are relatively simple, which is probably the main reason why they are used more often in practice than the First Principles models. However, there are also several serious drawbacks for the empirical models. First, the empirical models only describe certain behavior of a device such as the constant current discharge and the state of the charge of a battery. Complete information on the performance characteristics of a device cannot be obtained from any one of the empirical models. Second, First Principles models are inconsistent. Each model uses different assumptions and formats to describe the functions of a device. It is difficult to study different galvanic devices in a consistent way using the empirical modeling approach.

The above discussion indicates that the existing modeling methods for galvanic devices are not suitable to study the performance characteristics of the devices. On the other hand, many application issues of great practical significance, such as efficient utilization and precise control of a galvanic device powered system, need a thorough understanding of the characteristics of the device.

### SUMMARY OF INVENTION

Therefore, there is a need to develop a new modeling method that can be used by users of galvanic devices and overcome the drawbacks of the First Principles and empirical methods. The new modeling process is easy to implement while preserving the physics of a galvanic device. A suitable method to achieve this balance is to use an equivalent electrical circuit to represent the physical processes of a device. The structure of the model is consistent for all galvanic devices. Lumped parameter models are used, which simplifies the modeling process and simulation. The model parameter identification process uses the response data of a device, which eliminates the need for the data on the electrochemical properties and specific design of a device. The new model is thus chemistry and construction independent. The behavior predicted by the new model is valid over a wide range of operating conditions.

The utility of the new model lies in the analysis of device characteristics to solve practical problems. One advantage of the new model is that the analysis of the device characteristics can be performed with existing theories, techniques and tools from other engineering disciplines. For example, nonlinear behavior of a device can be linearized; the dynamic response properties can be analyzed using a small-signal model. Knowledge of the device characteristics from the analysis can be used to explain the effect of the pulsed discharge, and charge termination during the charging of a battery. Further, the knowledge can be used to solve practical problems such as determining the state of charge of a battery.

The contributions of this research represent progress in the understanding and application of galvanic devices. A practical approach is established to obtain an accurate and effective model of galvanic devices. The device characteristics, such as the steady-state response, the transient response and the frequency response, are effectively used to obtain both large-perturbation models and small-signal models. Using these models, practical application problems are considered. These include the effect of discharge frequency on deliverable charge, tracking the maximum power output point of a fuel cell, and battery health monitoring. Furthermore, using the hybrid model, a tracking observer can be designed as a virtual battery, which can be used to estimate the state of charge of the battery, as well as other internal variables. Thus the new hybrid model allows innovative solutions to practical usage problems that are difficult to obtain with existing First Principles models and empirical models.

### BRIEF DESCRIPTION OF THE DRAWINGS

For a complete understanding of the objects, techniques and structure of the invention, reference should be made to the following detailed description and accompanying drawings, wherein:

FIG. 1 is a flow chart embodying the concepts of the present invention;

FIGS. 2A and 2B are schematic drawings, wherein FIG. 2A is a schematic of an energy conversion process and wherein FIG. 2B is a two-port device for an energy conversion process;

FIG. 3 is a transmission line representation of CPE;

FIG. 4 is a schematic diagram of a new model with diffusion process;

FIG. 5 is a new model schematic with an approximate CPE;

FIG. 6 is a schematic of a new model utilizing a charge transfer polarization;

FIG. 7 is a schematic diagram of a distribution of voltage drop for discharge;

FIG. 8 is a schematic diagram of distribution of voltage drop for charging;

FIG. 9 is a schematic drawing of a new model with concentration polarization;

FIG. 10 is a schematic drawing of a new model with Ohmic resistor;

FIG. 11 is a schematic diagram of a new model with a double-layer capacitor;

FIG. 12 is a schematic diagram of a new battery model;

FIG. 13 is a graphical representation of constant current discharge;

FIG. 14 is a graphical representation of an expanded view of transient response;

FIG. 15 is a graphical representation of OCV/Nernst relationship for a generic battery;

FIG. 16 is a graphical representation of charge transfer polarization for a generic battery;

FIG. 17 is a graphical representation of a search for “q” for a generic battery;

FIG. 18 is a graphical representation of the value of “i*taoˆ q” for a generic battery;

FIG. 19 is a graphical representation of a simulation without concentration polarization;

FIG. 20 is a graphical representation of a concentration polarization for a generic battery;

FIG. 21 is a graphical representation of a simulation with concentration polarization;

FIG. 22 is a graphical representation of a response of internal variable;

FIG. 23 is a graphical representation of frequency response of CPE and its realization;

FIG. 24 is a graphical representation of a step response of CPE and its realization;

FIG. 25 is a schematic diagram of a cauer form realization;

FIGS. 26A and 26B are graphical representations of a source and impedance combined, and a source and impedance separated, respectively;

FIG. 27 is a schematic diagram of a representation of CPE with a capacitor and impedance;

FIG. 28 is a graphical representation of a determination of an energy storage capacitor;

FIG. 29 is a graphical representation of a step response of an original CPE and a synthesized system;

FIG. 30 is a graphical representation of a step current discharge for a lead-acid battery;

FIG. 31 is a graphical representation of a charge and energy of a battery;

FIG. 32 is a graphical representation of a determination of state of charge (SOC) by terminal voltage;

FIG. 33 is a graphical representation of an arbitrary discharge pattern;

FIG. 34 is a graphical representation of a response of Cₑ and terminal voltage;

FIG. 35 is a graphical representation of the comparison of V_{g} and Cₑ for SOC;

FIG. 36 is a graphical representation of a comparison of Cₑ and V_{g} for SOC during pulsed discharge;

FIG. 37 is a schematic diagram of a virtual battery concept;

FIG. 38 is a state diagram of an observer design for battery SOC;

FIG. 39 is a graphical representation of a response of a virtual battery design;

FIG. 40 is a schematic diagram of a Thevenin equivalent circuit;

FIG. 41 is a schematic diagram of a battery model with constant source;

FIG. 42 is a schematic diagram showing illumination of a two-port device;

FIG. 43 is a schematic diagram of a Thevenin circuit of large perturbation model;

FIG. 44 is a schematic diagram of a battery model with energy storage capacitor;

FIG. 45 is a schematic diagram of a small-signal model of a battery;

FIG. 46 is a circuit diagram for an equivalent impedance for a small-signal model;

FIG. 47 is a graphical representation of the impedance of a small-signal model;

FIG. 48 is a graphical representation of the frequency response of a small-signal model impedance;

FIG. 49 is a wave form representation of a pulsed discharge current pattern;

FIG. 50 is a graphical representation of a comparison of continuous and pulsed discharge;

FIG. 51 is a graphical representation of an effect of duty cycle on delivered charge;

FIG. 52 is a graphical representation of the effective frequency on delivered charge;

FIG. 53 is a graphical representation of a frequency response at different operating points;

FIG. 54 is a schematic representation of a diffusion process of a fuel cell;

FIG. 55 is schematic of a fuel cell model;

FIG. 56 is a graphical representation of a terminal voltage response of a fuel cell;

FIG. 57 is a graphical representation of the response of Cₑ of a fuel cell;

FIG. 58 is a schematic diagram of a steady state model of a fuel cell;

FIG. 59 is a graphical representation of a source characteristic of a fuel cell;

FIG. 60 is a graphical representation of a source characteristic and power output of a fuel cell;

FIG. 61 is a graphical representation of a step response of a small-signal model of a fuel cell; and

FIG. 62 is a graphical representation of an impedance of a small-signal model of a fuel cell.

### BEST MODE FOR CARRYING OUT THE INVENTION

There are several goals in developing a new modeling approach for galvanic devices. First, the model needs to be easy to build. Part of the difficulty in the First Principles modeling method is the requirement for knowledge of electrochemistry and information of device construction. Therefore, the First Principles models are both chemistry and device dependent. In contrast, the new modeling approach attempts to overcome this difficulty by building a general and consistent framework that includes all important processes and mechanisms of a battery. This approach is based on the understanding that practical batteries, regardless of their chemical reactions and device construction, have the same physiochemical processes and mechanisms that are responsible for their performance behavior. For battery users, this framework will be the starting point in the actual modeling process; all that is left is to use the response data of the device to determine the parameters of the components in the model. Since the structure of the new model does not vary with different batteries and device construction, the new model is thus independent of the chemistries and specific designs of batteries.

The new modeling approach uses some of the concepts from an AC impedance technique. Specifically, the physical processes of a galvanic device in the framework of the model are represented by an equivalent electrical circuit. Each component in the circuit represents a specific process or mechanism of the galvanic device. The physical meaning of each component in the circuit is clearly defined and easy to understand. The equivalent circuit model makes it possible to use existing electrical engineering techniques to analyze the behavior of a galvanic device.

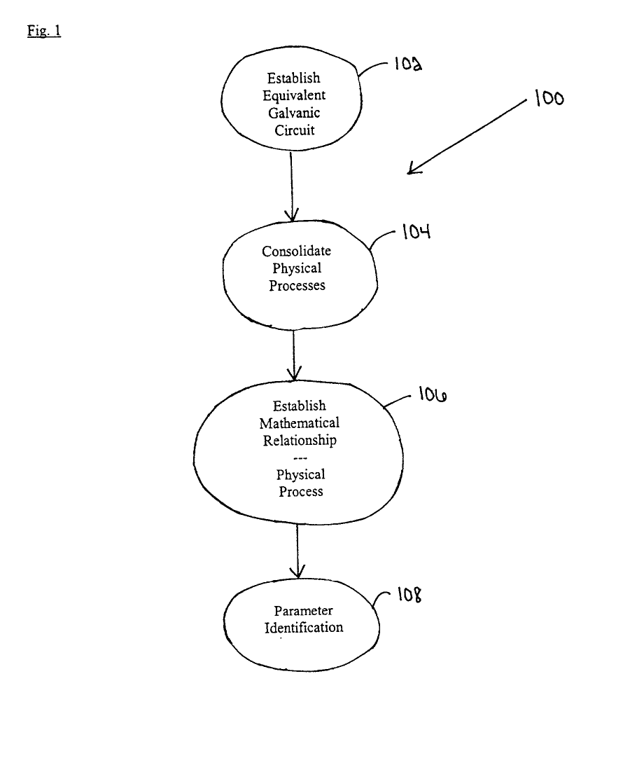

The new modeling approach 100 is shown in FIG. 1 developed in two major steps. The first major step 102 is to establish the framework, i.e., the equivalent circuit of a galvanic device. Since the proposed model is physics based, decisions need to be made as to what electrochemical processes should be included in the model. This process determines the model structure or framework. The following processes—energy conversion process, electrode kinetics, mass transport and the electrical double-layer are included in the model. Another decision that needs to be made is how to consolidate these physical processes for each component of a device at step 104. A galvanic cell has two electrodes, each of which has its own associated electrochemical processes. Instead of modeling the processes occurring on each of the electrodes separately, the new modeling approach combines them into an effective, or averaged, entity. This approach is taken for three reasons: 1) since the response data used for parameter identification comes as the behavior of the whole device, it is not possible to distinguish the individual effect or contribution from each electrode to the device behavior, 2) there are some physical justifications to combine the electrochemical processes of a galvanic device. The main reason is that for each electrochemical process, one electrode usually accounts for the major portion of the behavior of the whole cell while the effect from the other electrode is not significant. This point will be explained in more detail in the model development, and 3) consolidated processes avoid the undue complexity of the model. Using the averaged approach, the nature of each process in the model becomes effective rather than actual.

Once a physical process is decided to be included in the model, a mathematical relationship is given at step 106 to describe its behavioral characteristics based on electrochemical knowledge. Each of these relationships has some parameters that need to be identified.

As opposed to the empirical method, the new approach follows a first principles modeling technique. However, the new model reduces the complexity of First Principles models, while incorporating some empirical observations of a specific battery. Therefore, the new modeling approach is called a hybrid modeling technique.

The second major step of the new model development is step 108, wherein the parameter identification process that determines the parameters of each component in the model using the response data of a device. In contrast to the First Principles modeling method where electrochemical data is used to predict a device's behavior, the new modeling approach uses available device response data to determine the parameters of model components. This approach overcomes another drawback of the First Principles method in its requirement for large amounts of electrochemical data. The most commonly available data for a battery is the constant current discharge response. Distinctive features in the battery response are due to the behavior of specific components in the model. The parameter identification procedure shows how this correlation is made to uniquely identify the parameters of each component.

To prove the applicability of the modeling approach described above, it will be used to obtain models for four batteries. These batteries have different chemical reactions and cell configurations. Results produced by the new model need to match closely with actual response data to prove its usefulness. The new model needs further verification to correctly predict responses from other operating modes in addition to constant current discharge. Several operating conditions, which include variable-rate discharge, pulsed discharge and charging, will also be discussed.

### Description of Model Structure

The first step in the new model development is to determine what processes and mechanisms of electrochemical reactions of a battery should be included in the model. As reviewed in Chapter II, the following processes mainly contribute to the function of a battery and will be included in the model:

energy storage characteristics of a battery;

processes that convert chemical energy to electrical energy and conversely;

mass transport processes;

charge transfer polarization;

concentration polarization;

Ohmic bulk resistance;

electrical double-layer.

These processes have been chosen as they appear to be the most significant for the users of galvanic devices.

### Energy Storage Component

The most fundamental function of a battery is that it stores a certain amount of energy that is consumed during discharge. An equivalent electrical capacitor (C_{g}) is suitable for representing this function. When a capacitor with capacitance of C Farads is charged at terminal voltage VVolts, the charge stored in the capacitor is Q=CV and the stored energy is

$$\frac{1}{2} {CV}^{2} or \frac{1}{2} QV$$

Joules. This view is consistent with how battery energy is normally rated. For example, if a battery has nominal capacity of Q ampere-hours (Ahr) at nominal terminal voltage of VVolts, the nominal available energy of the battery is then QVx3600 Joules. Interestingly, a battery seems capable of storing twice as much energy as a capacitor for the same charge and terminal voltage. This primitive view is strictly from the perspective of total available energy in a battery. Two factors complicate this view. One is that the energy in a battery is stored in chemical form. If a capacitor is used to represent a battery's energy storage property, it cannot be charged and discharged only by electrons as a normal electrical capacitor. The physical meaning of the terminal voltage at C_{g} represents the concentration of the active materials, which is a measure of the amount of active materials available in a battery. The other complication is that active material in a battery is spatially distributed in an electrolyte instead of being lumped into one component as represented by a capacitor. The effects of these complications will be further explained and clarified later. For now, however, a lumped parameter equivalent capacitor Cg is used for the energy storage function of a battery.

### Energy Conversion Process

Chemical energy in a battery is converted to electrical energy through chemical reactions occurring at electrode surfaces. During electrode reactions, a voltage is generated at an electrode, and current passes through the electrode-electrolyte surface. For fast electrode processes, as is the case for most practical batteries, the voltage at an electrode generally follows the Nernst relationship, i.e.,

$$E = {E}_{0} + \frac{RT}{nF} ln {C}_{e} \qquad ( 1 )$$

where Cₑ is the concentration of active species at the electrode surface and E₀ is the standard potential. It is noted that an effective concentration Cₑ is used here instead of a more general expression involving concentrations of all participating species. For example, for an anode electrode reaction where two species A₁ and A₂ are oxidized into B₁ and B₂, the Nernst equation can be written in a general form:

$$E = {E}_{0} + \frac{RT}{nF} ln \frac{[ {A}_{1} ] [ {A}_{2} ]}{[ {B}_{1} ] [ {B}_{2} ]} \qquad ( 2 )$$

where [A₁], [A₂], [B₁], and [B₂] are the concentrations for species A₁, A₂, B₁, and B₂, respectively.

The assumption made above to use an effective concentration to replace a more general form is based on the fact that in many electrode reactions, solid electrodes and water are usually involved. Both solid materials and water have a concentration of one; thus, according to the properties of electrochemical potential, their concentration effect for the OCV is not significant in Equation. The omission of the effect of the solid material and water usually results in no more than one concentration term (usually the concentration of the electrolyte) in the Nernst relationship, which was defined as the effective concentration Cₑ.

For each electrode in a battety, there is a corresponding Nernst relationship. Let E₀a and E_{0c} be the standard potentials and Cₑₐ and C_{ec} be the effective concentrations of active material for the anode and cathode respectively. Two Nernst equations can then be written for each electrode voltage process:

$$\begin{matrix}{E}_{a} = {E}_{0 a} + \frac{RT}{nF} ln {C}_{ea} & ( 3 ) \\ {E}_{c} = {E}_{0 c} + \frac{RT}{nF} ln {C}_{ec} & ( 4 )\end{matrix}$$

For practical batteries, one electrode is usually over-designed in that it still has active material left when the other one is used up toward the end of discharge. This is the so-called “starved electrode” design in battery engineering. The effect of this practice is that the OCV governed by one of the Nernst equations does not change appreciably during the cell reactions. As a result, the two Nernst equations for two electrodes can be consolidated into one. The standard potential E₀ in the consolidated Nernst equation is the algebraic sum of E₀ₐ and E_{0c} and the concentration effect of each electrode can be combined into an effective concentration Cₑ. The consolidated Nernst relationship can be written as:

$$E = ( {E}_{0 a} + {E}_{0 c} ) + \frac{RT}{nF} ln {C}_{e} = {E}_{0} + \frac{RT}{nF} ln {C}_{e} \qquad ( 5 )$$

The above discussion attempts to justify using a consolidated Nernst equation in relating the concentration of active species to the OCV. From a practical modeling point of view, this technique is also strongly favored because from normally available battery response data, it is not possible to distinguish the voltage contribution from each electrode and different active materials.

In the above discussion, it is assumed that the OCV is related to the material concentration through a general Nernst equation. For some batteries, however, the OCV relationship of an electrode can be found to be different from the one predicted by Nernst equation. In these cases, a more accurate empirical relationship can be determined and used in place of Nernst equation. An example of this point is given later in the battery modeling section. In general, however, with no specific OCV relationship available, the Nernst equation is assumed to be valid.

Another phenomenon of the energy conversion process is the current flow through the electrode-electrolyte interface. In this process, reaction materials in a cell are consumed in chemical reactions to generate electrical current. The ion flow inside a cell and electrical current flow in the external circuit are related through Faraday's Law, discussed in Chapter II:

$$v = \frac{i}{nFA} = \frac{j}{nF} \qquad ( 6 )$$

where v is the flux of ion movement inside an electrochemical cell to support the current flow in the external circuit.

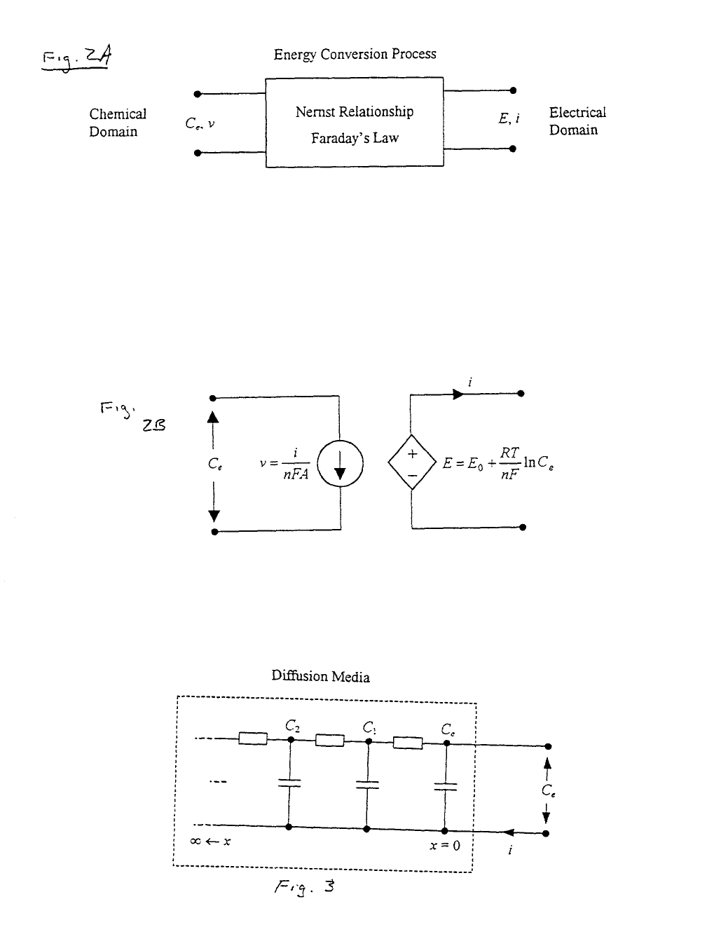

The Nernst equation and Faraday's Law relate quantitatively the material properties, Cₑ and v, (chemical energy) in an electrochemical cell to the electrical properties, E and i, (electrical energy) to describe the energy conversion process. Schematically, this process is shown in FIG. 2A.

This representation partitions the energy conversion process into a chemical side and an electrical side. On the chemical side, the active material with effective concentration Cₑ at an electrode has a flux rate of v. On the electrical side, the current i flows at the terminal voltage E. Cₑ and E are related through the Nernst equation and v and i through Faraday's Law.

One implementation for this representation is through an equivalent two-port device. A two-poll device is specified by two voltages (Cₑ, E) and two currents (v, i). Two of the four quantities can be selected as the independent variables. In general, the independent variables cannot be selected arbitrarily. For the energy conversion process of a battery, it is appropriate to select Cₑ and i as independent variables because Cₑ is determined by mass transport process inside the battery and i is determined by the external electrical circuit, or the load characteristic. The ether two variables, E and v, are dependent variables whose relationships are determined by the Nernst equation (5) and the Faraday's Law of Equation (6). In the two-port device, the dependent variable E can be represented by a voltage-controlled voltage source and v by a current-controlled current source. A two-port device representing the energy conversion process of a battery discussed above is shown in FIG. 2B.

### Mass Transport Process

The effective concentration (Cₑ) in the Nernst equation is the concentration of the active species that reaches the surface of an electrode. Inside an electrochemical cell, other than those in immediate contact with an electrode, the majority of active materials stays in the bulk solution. During the cell reaction, the reactant ions move to the reaction site on the electrode and the products of the reaction move away from the electrode. Ion movement mechanisms which include diffusion, convection and migration, wherein for active species, diffusion is the most important process in the mass transport while convection and migration are generally secondary. Therefore, only the diffusion process will be considered for the active materials in the new model development.

Each active species has its own associated diffusion process. Ion movement to the reaction site through a porous electrode also resembles a complicated diffusion process. If each of these diffusion processes is treated separately in the model, the resulting model will be very complicated. In addition, it is not possible to distinguish the contribution of each diffusion process from battery response data. Therefore, an averaged diffusion process is used to account for all possible mass transport involved in a battery.

Traditionally, a diffusion process is considered to follow the Fick's second law. This can be expressed with the partial differential equation (PDE):

$$\frac{\partial C ( x , t )}{\partial tt} = D \frac{{\partial }^{2} C ( x , t )}{\partial {x}^{2}} \qquad ( 7 )$$

For the initial and boundary conditions that normally apply to the diffusion process in an electrochemical cell, it can be shown that the transfer function of the concentration at electrode surface (x=0) to the discharge current t is:

$$H ( s ) = \frac{{C}_{e} ( S )}{i ( s )} = \frac{K}{{s}^{0.5}} \qquad ( 8 )$$

This is known as the Warburg impedance that is most commonly used in the AC impedance techniques. However, it is understood that there is more than one diffusion process involved inside a battery and their behaviors can collectively deviate from Fick's second law. It is known that the parallel diffusion processes behaves like a Constant Phase Element (CPE). In addition, the diffusion processes of ions through a porous electrode structure also display a CPE behavior. Therefore, a more general CPE component is used to represent the overall diffusion processes in a cell. A CPE component can be represented with the transfer function:

$$H ( s ) = \frac{{C}_{e} ( s )}{i ( s )} = \frac{K}{{s}^{q}} , 0 < q < 1 \qquad ( 9 )$$

The physical meaning of this relationship needs to be explained further. First, Equation (9) is the transfer function that relates the electrode surface concentration to the discharge current. This transfer function comes from the partial differential equation:

$$\frac{{\partial }^{2 q} C ( x , t )}{\partial {t}^{2 q}} = D \frac{{\partial }^{2} C ( x , t )}{\partial {x}^{2}} , 0 < q < 1 \qquad ( 10 )$$

This fractional order PDE can be considered the governing equation for a more general diffusion process that behaves like a CPE. Therefore, Fick's second law is a special case of Equation (10) when q=0.5. A diffusion process is analogous to a semi-infinite lossy transmission line. In this analogy, Equation (10) that describes the diffusion processes can be modeled by an equivalent circuit of a transmission line, as shown in FIG. 3. The input to the circuit is the discharge current land the output is the effective concentration at the electrode surface Cₑ. Therefore, the physical meaning of the CPE component of Equation (9) becomes clear; it represents the transfer function of the two terminal variables of the equivalent circuit looking into the diffusion media.

Now a dilemma arises: if the equivalent circuit of FIG. 3 is used to model the diffusion process, the initial condition at each capacitor needs to be specified. Since the voltage on these capacitors represents the concentration of active material at each spatial location in the electrolyte, the equivalent circuit of FIG. 3 actually represents a more realistic mechanism of how energy is stored in a battery, as compared to a single capacitor. After all, the chemical energy in a battery cell can only be related to the active material spatially distributed in the electrolyte. There does not exist a single component that holds all the active materials in a battery. This understanding makes it unnecessary to use a single capacitor to represent the energy storage feature of a battery as proposed previously. However, in some situations that will be revisited later, it is still desirable to use a bulk capacitor in the battery model.

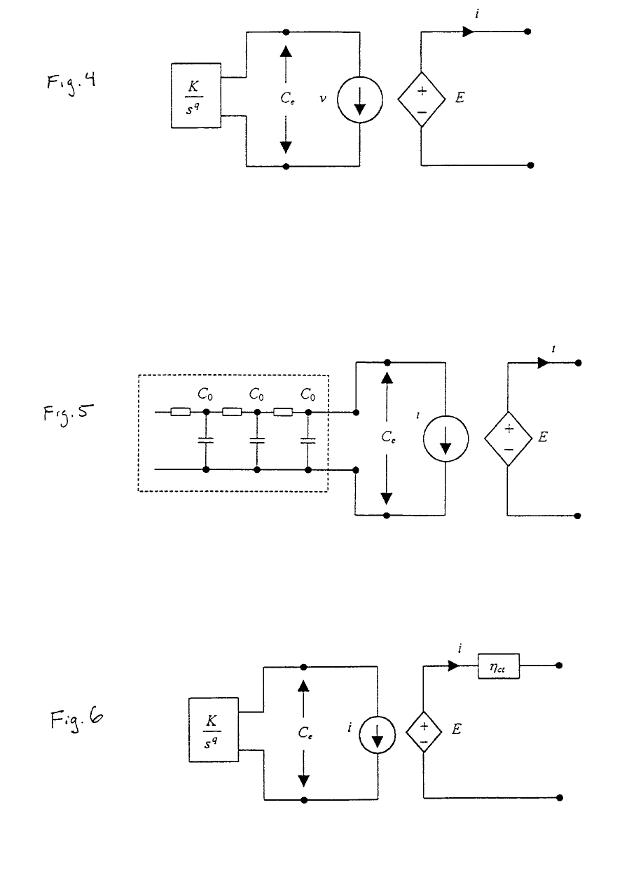

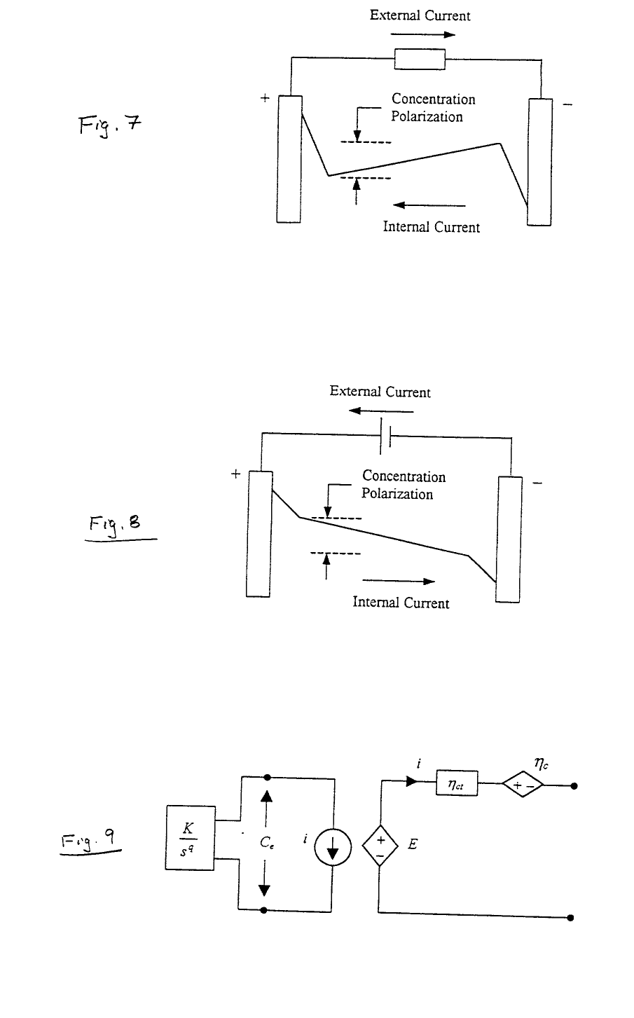

In summary, the mass transport mechanism in a battery cell is modeled with an averaged diffusion process that can be described by a general CPE. The diffusion process as determined above can now be combined with an energy conversion process into the new equivalent circuit model for a battery as shown in FIG. 4.

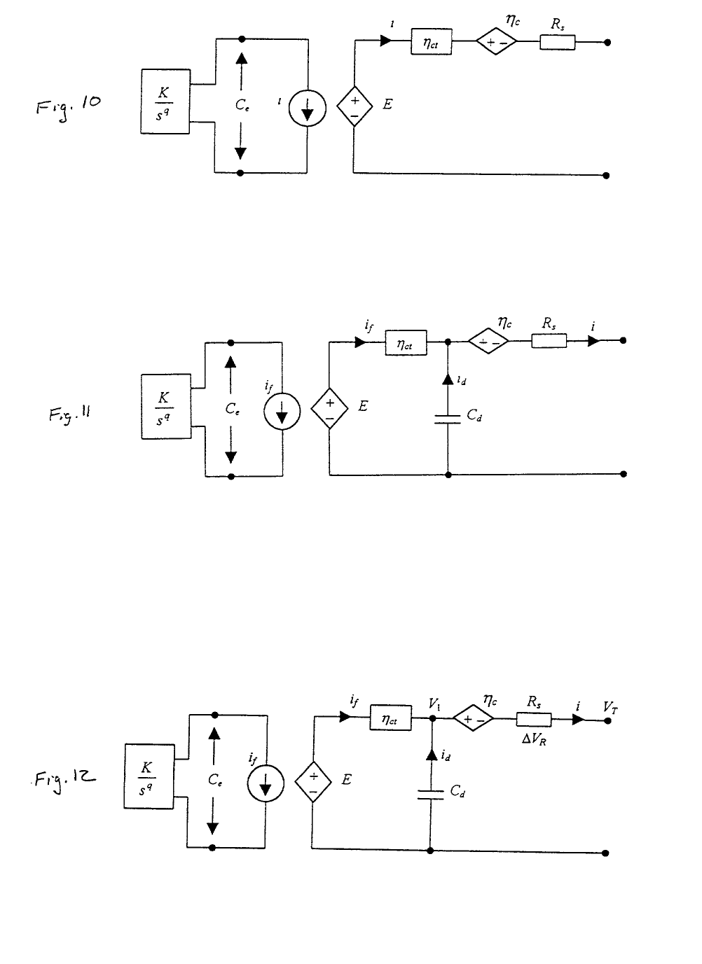

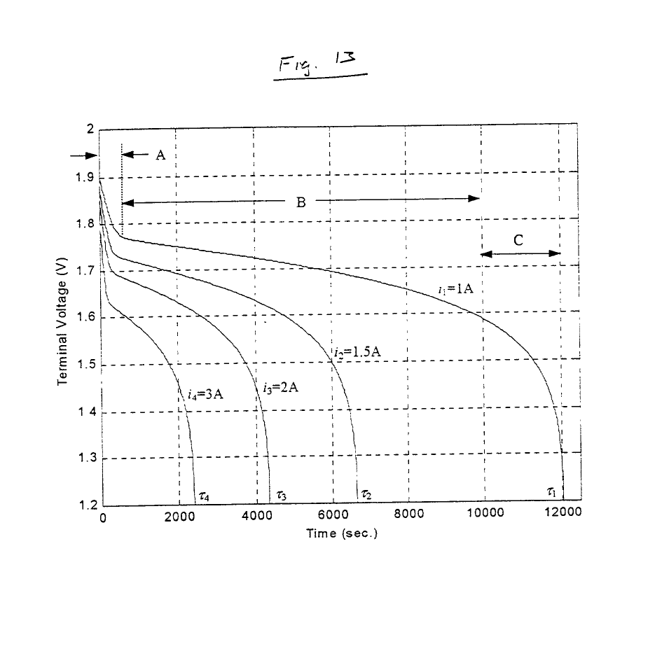

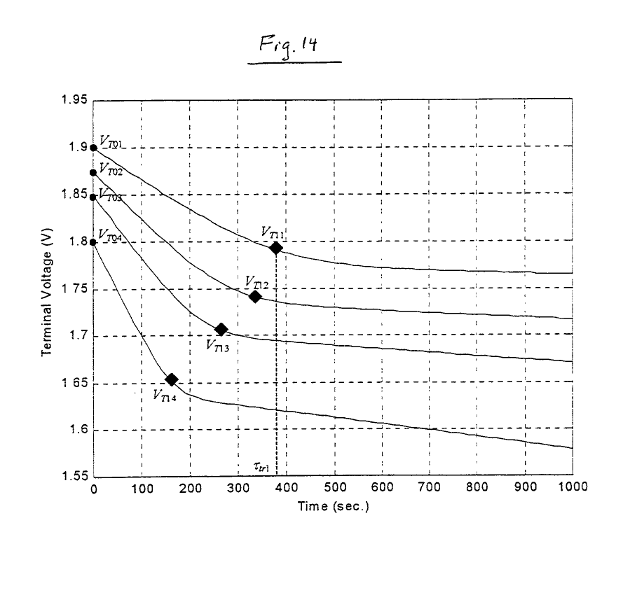

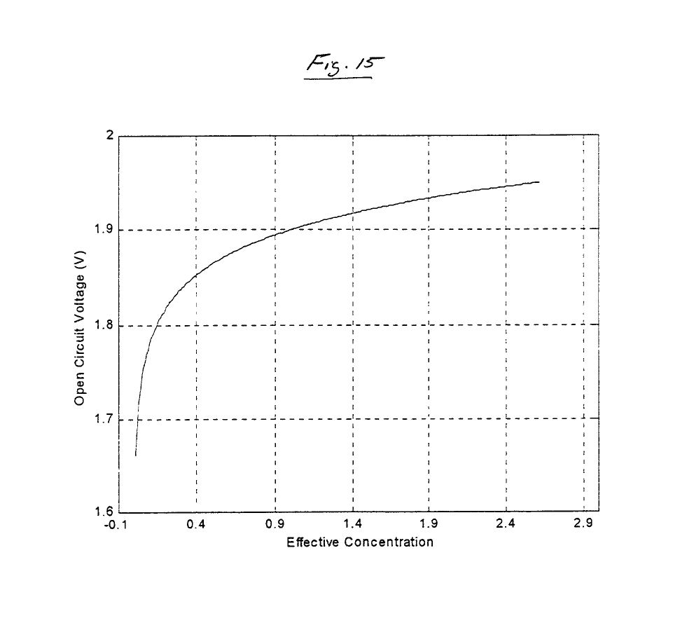

There is no existing tool that can directly implement a fractional order system such as the one of Equation (9). Therefore, in practice, a fractional order system is usually approximated with other forms of realizations that are easier for simulation. Two forms are possible for the approximation: a transfer function without fractional terms in its expression, or an equivalent electrical circuit. If the realization method uses an equivalent electrical circuit, the model of FIG. 4 can be represented by the one shown in FIG. 5. In FIG. 5, every component is familiar and can be handled with existing circuit analysis tools.

It is also noted that in FIG. 5, the dependent current on the chemical side is changed from the flux rate of active species v to the discharge current i. This is because it is more convenient to use discharge current, instead of the flux rate of active materials in the diffusion process to describe material consumption. Mathematically, in solving the PDE in Equation (10), the discharge current is introduced as a boundary condition and the scaling factor in the Faraday's Law is reflected in the constant K in the transfer function form of Equation (9). Thus, the current source in the chemical domain is still a dependent source, only the scale changes—now the dependent current source is equal to the controlling current i, which is the battery discharge current. This practice will be followed throughout this paper from now on.

Before leaving this subject, it is interesting to consider the use of the term “impedance,” which, in electrical engineering, normally implies a passive component. But it is also widely used in electrochemistry to describe a diffusion process as in the Warburg impedance. Depending on the initial status of the diffusion media, a diffusion process can certainly be an active element in the sense that it can store energy and be a source to the other part of a circuit. Therefore it may not be entirely appropriate to use the term “impedance” to describe the diffusion process in a battery. The meaning that a diffusion process can itself be a source will become more clear in the later discussion.

### Charge Transfer Polarization

When Faradaic current passes through an electrode, an electrical voltage drop is introduced across the electrode-electrolyte boundary. This is the effect of charge transfer polarization (_{ct}). The effect is similar to the situation of a conventional resistance but with some important differences. First, the cause for charge transfer polarization is due to the electrode kinetics rather than the conventional electrical resistance. At open circuit when there is no current flowing, an electrode assumes a certain equilibrium voltage. When current starts to flow, it needs a driving force that disturbs the equilibrium condition. This driving force is the charge transfer polarization, i.e., the difference in voltage between the equilibrium voltage and the voltage at current flow. The transfer polarization is a major source of energy loss and it must be included in the model. Another difference between charge transfer polarization and a conventional resistor is that the former has a nonlinear relationship in general. It is known that the Butler-Volmer relationship

$$i = {i}_{0} [ {ⅇ}^{- anfη} - {ⅇ}^{( 1 - α ) nfη} ] \qquad ( 11 )$$

is the most general form describing charge transfer polarization. Depending on the magnitude of the charge transfer polarization, two approximations can be made to the Bulter-Volmer relationship. For large charge transfer polarization, a Tafel equation in the form

η_{ct}=a+b ln(i) (12)

can be used. For small polarization, a linear approximation

η_{ct}=c+di (13)

can be used. In either case, charge transfer polarization can be represented by an equivalent resistor defined by

$$\frac{ⅆ {η}_{ct}}{ⅆ i} ,$$

which is nonlinear for the Tafel relationship and linear for small polarization.

It may be argued that since the electrode kinetics is already reflected in the model through the Nernst equation in the energy conversion process, why does it need to represent the charge transfer polarization again in the model? The reason is as follows. It is true that the Nernst relationship used in the energy conversion process comes from the electrode kinetics. Recall that the Nernst equation from thermodynamics only applies to the equilibrium condition; therefore, it cannot be used for dynamic situation when there is a current flow. However, it is known that for very fast chemical reactions, the electrode kinetics relationship could be approximated by a Nernst form relationship.

Electrode processes for practical batteries are usually fast enough for the Nernst kinetics relationship to apply. However, it is found that the Nernst relationship alone is not enough to account for all the electrode kinetics for practical batteries. Other representations, such as the Tafel relationship, are also needed to fully reflect the behavior attributed by electrode kinetics processes.

Charge transfer polarization occurs at each of the two electrodes in a battery. Therefore, two relationships exist for each charge transfer polarization. Obtaining individual polarization relationships for each electrode is not always possible. Even for the electrodes commonly used in batteries, there is often no associated kinetics data. From experimental data, it is again not possible to distinguish between which electrode polarization contributes to how much of the total polarization. Therefore, for the behavioral modeling approach adopted here, it is natural to combine the polarizations from each electrode into one equivalent component to account for the total charge transfer polarization effect.

Including the charge transfer polarization component in the equivalent circuit model produces a new model structure shown in FIG. 6. Since the charge transfer polarization occurs exclusively in the electrical domain, it is included in the electrical side.

### Concentration Polarization

As cell reactions proceed during discharge, excessive charges are accumulated inside the cell that tends to impede the continuing chemical reaction by forming an opposite electrical field to the reacting ions' movement. This effect is the concentration polarization (c), which manifests itself in a voltage drop reflected to the terminal voltage. The concentration polarization is also a source of energy loss in a battery because more energy is required to push current through the cell, or fewer ions will be able to reach the reaction sites. The concentration polarization is represented by the following relationship:

$${η}_{c} = \frac{RT}{nF} ln \frac{{C}_{e}^{i}}{{C}_{0}^{i}} \qquad ( 14 )$$

where Cⁱₑ and Cⁱ₀ are the concentrations of 1-th kind of inert ions at electrode and bulk solution, respectively. It is important to note that only the ions that do not directly participate in the cell reaction are responsible for the concentration polarization. Therefore, Cⁱₑ and Cⁱ₀ for inert ions are not included in other part of model established so far; and they cannot be directly identified with battery response data. However, Cⁱₑ and Cⁱ₀, or the concentration polarization, are related to the state of charge of cell reactions. Thus, Cⁱₑ and Cⁱ₀ are proportional to the effective concentration of active material at the electrode Cⁱₑ, and the bulk concentration C₀. As reactions proceed, more and more inert ions are accumulated, increasing the effect of _{c}, while the active material in the bulk solution is consumed. Therefore, numerically, concentration polarization of Equation (14) can be related to Cⁱₑ and Cⁱ₀ through:

$${η}_{c} = h ln \frac{{C}_{e}}{{C}_{0}} \qquad ( 15 )$$

This expression is valid for discharge operation. A modification is necessary for charge operation. If an “empty” battery is charged from a rest condition, i.e., no relaxation of electrolyte immediately prior to the charging current, the effect of the concentration polarization does not become significant until toward the end of the charging operation. However, when a battery is “empty,” Cₑ=0. Then, if Equation (15) is used, the concentration polarization is the very large at the beginning of the charge. This contradicts experimental results. To account for this phenomenon, the following equation is used for concentration polarization in charging operation.

$${η}_{c} = h ln \frac{{C}_{0} - {C}_{e}}{{C}_{0}} \qquad ( 16 )$$

Numerically, Equation (16) implies that as charging goes on, Cₑ approaches C₀, thus, the value of _{c}, becomes larger. This relationship is consistent with experimental results for battezy charging operations. Equations (15) and (16) combined are the specific approach used in this research to account for the effect of the concentration polarization in the model. Other interpretations for the general expression of the concentration polarization of Equation (14) are possible.

A question arises in using Equations (15) and (16) for the effect of the concentration polarization in battery operation. In the practical usage of a battery, its operation may be switched from discharge to charge or vice versa. An example is when a battery is used to power an electric vehicle; its operation could be from the discharge mode to regeneration during braking or slowing down. In this situation, the concentration polarization will have two different instant values because two different equations are used for the same Cₑ. It may be argued that this is physically unfeasible because the electric field established by concentration polarization cannot change instantly. However, a close examination of the mechanism of the concentration polarization indicates that this process is a good interpretation of the actual physical process. This is explained as follows.

During battery discharge, as seen in FIG. 7, the voltage drop distribution in a cell is shown. The voltage drop due to the concentration polarization effectively reduces the terminal voltage of the cell. This is true because the concentration polarization is caused by migration of inert ions; the voltage drop must be in the direction of current flow. During battery charge, the direction of voltage drop in a cell is shown in FIG. 8. Therefore, the direction of the voltage drop in the bulk electrolyte is reversed when the current changes direction. The question is, how fast can the concentration polarization change its direction. For all practical purposes, this process is instantaneous. The reason is that, again, the concentration polarization is the result of a migration process, rather than a diffusion process. Recall that a migration process is determined by the mobility coefficient, concentration of conducting ions and others, through:

i=z₊C₊Fv₊z_{—}C_{—}Fv_{—} (17)

Electrical neutrality requires a migration process to follow Ohm's law in the form:

$$i = - k \frac{ⅆ Φ}{ⅆ z} \qquad ( 18 )$$

The electrical field in Equation (18) is attributed to the concentration polarization. There is no time term explicitly involved in a migration process. When current stops, the Ohmic voltage drop collapses instantly. The Ohmic voltage drop due to the concentration polarization differs from the Ohmic resistance in that the former is nonlinear and the nonlinearity is reflected through Equations (15) and (16). Essentially, the migration process that produces the concentration polarization is a much faster process than the diffusion process. In other words, the mobility coefficient and the concentration of inert ions are much higher than the diffusion coefficient and the concentration of the active ions. The relaxation processes that result from the diffusion of active species still exist, but their effect is reflected in the slower recovery of the electrode potential.

The cause of the concentration polarization is in the chemical domain, but its effect is in the electrical domain. The concentration polarization can be represented by a voltage-controlled voltage source in the model that has been established so far as shown in FIG. 9. The controlling voltage is the effective concentration of active species at electrode following one of the relationships of Equations (15) and (16) depending whether it is in discharge or charge operation, while the controlled variable is the voltage drop in the electrical domain. The polarity of the voltage drop is always to oppose the direction of current flow.

### Ohmic Resistor

Ohmic resistor (Rₛ) is a pure electrical resistance that may be caused by the bulk electrolyte resistance and electrode contact resistance. The latter may be contributed by the electrical resistance of the electrodes and the some non-conducting film formed during cell reactions. The resistance introduced by reaction residuals that forms a non-conducting film is a very complicated phenomenon. There are no explicit rules governing its characteristic in genera]. This phenomenon is not included in the new model; instead, a linear resistor is used in the equivalent circuit model to represent the bulk resistance of a battery. Inclusion of bulk resistance in the equivalent circuit model is shown in FIG. 10.

### Electrical Double-Layer Capacitor

One basic fact about the structure of an electrochemical cell is the existence of an electrical double-layer at the electrode-electrolyte interface. It is believed that the effect of the double-layer capacitor is critical in correct prediction of a cell's behavior, especially the transient response of the cell. However, this important mechanism is not included in many existing models. The reason for this omission is not clear but it is speculated that it might be due to the difficulty of including this lumped parameter component in a distributed numerical model. It has been shown that the electrical double-layer could be modeled with a nonlinear capacitor. However, there was no general rule to determine the nonlinear characteristics of the capacitance. Therefore, a linear capacitor will be used to model the double-layer at the present time. When data becomes available to more clearly define the nonlinear relationship of a double-layer capacitor, it can be used in place of the linear model.

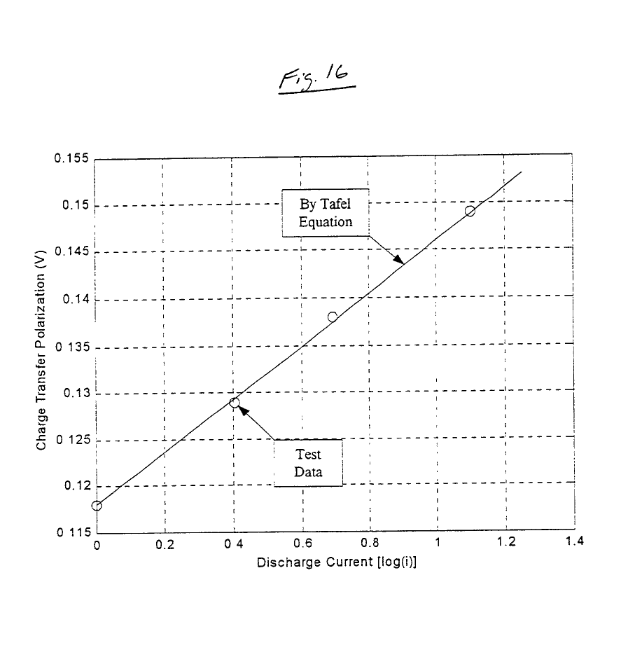

Each electrode has an associated double-layer. As in the treatment for the OCV of each electrode, two double-layers at each electrode are consolidated in one equivalent capacitor (C_{d}). The double-layer capacitor is treated as an electrical phenomenon. Therefore, it is placed in the electrical domain of the equivalent circuit model. The electrical current contribution from the double-layer capacitor is non-Faradaic; thus, the double-layer capacitor needs to be placed in parallel with Faradaic current branch. Since the Faradaic current portion only affects charge transfer polarization while bulk resistance and concentration polarization see the total discharge current, the double-layer capacitor is placed after the charge transfer polarization but before the bulk resistance and concentration polarization. Inclusion of the electrical double-layer capacitor in the equivalent circuit model is shown in FIG. 11. When the double-layer capacitor is included in the model, the current on the chemical side should be changed to the Faradaic current, as shown in FIG. 11.

### Summary of New Model Structure

A physics-based model is developed for batteries, which includes all important electrochemical processes and mechanisms. The model is represented by an equivalent circuit. Each component in the circuit represents a specific process or structure of the physical system of a battery. In determining the behavior of each component, the First Principles modeling technique is used. Electrochemical knowledge is embedded in the clearly defined and easy-to-understand circuit components whose physical meaning is justified. It is important to point out that the new model includes most major processes and mechanisms that have previously been suggested and that are important for engineering purposes. Therefore, the new modeling approach is comparable to existing models in its completeness. It is believed that the general model, as shown in FIG. 11, can be used for most batteries of different chemistry and device construction. Thus, the new model is chemistry and device independent.

For convenience, the complete new model structure, the definition of each component, and the electrical relationships, are summarized below. Those equations are used in the simulation of the new model.

Processes Definition and Relationship is of Equivalent Component

$$\begin{matrix} Energy Conversion Process : E = {E}_{o} + \frac{RT}{nF} ln {C}_{e} & ( 19 ) \\ ( Chemical Side ) if = if ( Electrical Side ) & ( 20 ) \\ Charge Transfer Polarization : \begin{matrix}{η}_{ct} = E - {V}_{1} for discharge or \\ {η}_{ct} = {V}_{1} - E for charge\end{matrix} & ( 21 ) \\ {η}_{ct} = a + b ln ( if ) or {η}_{ct} = c + dif & ( 22 ) \\ Current Relationship : i = if + {i}_{d} & ( 23 ) \\ Diffusion Process : H ( s ) = \frac{{C}_{e} ( s )}{if ( s )} = \frac{K}{{s}^{q}} , 0 < q < 1 & ( 24 ) \\ Double - Layer Capacitor : \frac{ⅆ {V}_{1}}{ⅆ t} = - \frac{1}{{C}_{d}} {i}_{d} & ( 25 ) \\ Ohmic Resistor : Δ {V}_{R} = {iR}_{s} & ( 26 ) \\ \begin{matrix}Concentration Polarization : {η}_{c} = h ln \frac{{C}_{e}}{{C}_{o}} for discharge or \\ {η}_{c} = h ln \frac{{C}_{o} - {C}_{e}}{{C}_{o}} for charge\end{matrix} & ( 27 ) \\ \begin{matrix}Terminal Voltage : {V}_{T} = E - {η}_{ct} - \vert {η}_{c} \vert - Δ {V}_{R} = {V}_{1} - \vert {η}_{c} \vert - Δ {V}_{R} \\ For discharge\end{matrix} & ( 28 ) \\ or {V}_{T} = E + {η}_{ct} + \vert {η}_{c} \vert + Δ {V}_{R} = {V}_{1} + \vert {η}_{c} \vert + Δ {V}_{R} For disharge & ( 29 )\end{matrix}$$

### Parameter Identification

The parameters for each component in the equivalent circuit model developed in the last section need to be determined to complete the model. The new modeling approach adopts a different approach in parameter identification from the one used in the First Principles modeling method. In the latter method, parameters for each component were determined from electrochemical properties of the processes. For example, if the charge transfer polarization process follows the relationship:

$$i = {i}_{0} [ {e}^{- anfn} - {ⅇ}^{( 1 - a ) nfn} ] \qquad ( 30 )$$

the exchange current iₒ and transfer coefficient a are assumed to be known parameters, determined from electrochemical testing, for example. The behavior of charge transfer polarization _{ct} can then be predicted from the relationship of Equation (19) once the current i passing across the electrode is known. On the other hand, if the relationship between the input and output of a device is known, the parameters used in the relationship can be determined from the behavior or response of the device. This is the method used for parameter identification in the new modeling approach.

There are several reasons for this decision. First, in using an existing device, one is often more interested in “what it does” rather than “how it does.” The first question is related to device behavior while the second is a device design issue. Second, the electrochemical relationships are idealized abstractions of the underlying physical phenomena. This knowledge itself is evolving constantly. In reality, actual processes may not follow exactly the mathematical relationships. Therefore, “perfect” data does not ensure a perfect result, which also depends on the correctness of the underlying relationship. Third, in an electrochemical device, there are many processes occurring simultaneously. Even if the governing equations for each process are slightly inaccurate, the total error for the whole system may multiply. Last, the large amount of electrochemical information that is required to model each process using the numerical method is generally not available to a device user. Even if this information is available, it is not practical for a battery user to apply the data because of the required electrochemical knowledge.

In the last section, each important process of battery dynamics was determined in a model structure using an equivalent circuit component. Further, the input and output relationship for each component was defined. If the input and output data is available, it is possible to determine the parameters in these relationships. In applying this principle to battery modeling, however, a difficulty arises from the fact that the available device response is normally the combined effects of all processes included in the model. Therefore, it must be decided first what is the specific contribution of each process in the device response. Only after this isolation of effect is made can the input and output for each process be determined and be used to identify its associated parameters.

### Analysis of Battery Response Data

At the present time, the most commonly available data for commercial batteries is the constant current discharge response, which, in fact, is usually the only data describing the performance and characteristics of a battery. Although other tests may be performed by battery manufacturers, the most valid assumption is that only the constant current discharge data is available for a battery.

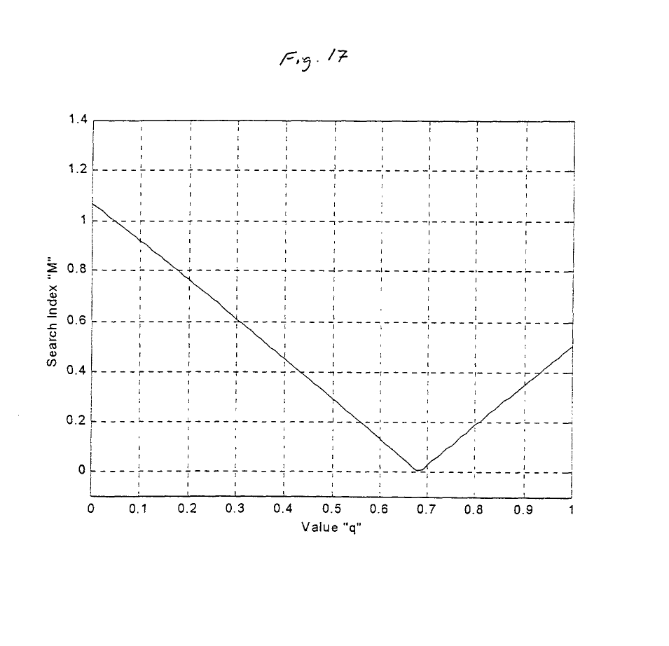

The constant current discharge response data is a series of curves representing the time response of the battery terminal voltages at different discharge currents. A typical response curve is shown in FIG. 13, which represents the constant current discharge curves of a generic battery. The response data for this battery is representative of the response of actual batteries and it will be used throughout this section to illustrate the parameter identification process.

For each curve corresponding to a discharge current, there are three regions with distinctive characteristics. In region A when current starts to flow, the terminal voltage displays a response that is transient in nature in which the voltage rapidly decreases to a lower value. In region B, the battery reaches a plateau where the terminal voltage starts a more steady discharge pattern, representing a quasi-steady state response. The reason it is referred to as “quasi” is because the terminal voltage is still changing in this region, but at a much lower rate compared to the response in other regions. At a later stage toward the end of discharge, the terminal voltage displays another rapid decrease as shown in region C. Test data for a battery normally stops at a voltage Voff, which in general is above zero Volts. Commonly known as “cut-off voltage,” Voff has different values for different types of batteries depending on the lowest allowable working voltage without shortening battery life due to the depth of discharge. The time it takes for the terminal voltage to reach the cut-off voltage from the start of discharge is referred to as “cut-off time,” denoted by. The cut-off time is also known as transition time in electrochemistry. Obviously, cut-off time and the cut-off voltage are related to each other.

The following analysis gives the reasons for these three distinctive regions of response of a battery. Each particular behavior in the battery response can be attributed to a specific component in the equivalent circuit model. Thus, the input and output relationship for each component can be isolated from the overall response data, from which the parameters of the components can be determined.

### Determination of Double-Layer Capacitance

Referring to the model of FIG. 12, it can be seen that before a discharge starts, the voltage V₁ across the double-layer capacitor is the same as the terminal voltage V, as well as the Nernst potential E, all because there is no current flow. When current starts to flow, the double-layer capacitor discharges via the non-Faradaic current i_{d}, supplying most of the total current i at this time. Meanwhile, the voltage V₁ of the double-layer capacitor decreases as the double-layer capacitor discharges. A charge transfer polarization voltage is thus established to be _{ct}=E−V₁, which drives the Faradaic current flow (i_{f}). The Faradaic current if is reflected to the chemical side through Faraday's Law, causing active species to move through the CPE component.

As the charge transfer polarization increases, it drives more Faradaic current to the terminal. When the Faradaic current increases to a point that the charge transfer polarization does not change appreciably, the current contribution from the double-layer capacitor becomes minimum and the Faradaic current starts to supply the majority of the total load current. An actual dynamic response of the Faradaic current and the double-layer capacitor's current (non-Faradaic) will be given to verify the dynamic response of the current later after the complete model is obtained.

The above analysis indicates that the transient response of a battery at the start of discharge is related to the double-layer capacitor. During this period of time, the double-layer capacitor supplies most of the total discharge current i. For parameter identification purposes, however, it is assumed that the double-layer capacitor supplies all the discharge current. This approximation is necessary because at this time, the exact relationship between the current contribution from the double-layer capacitor and the Faradaic current is not known. With this approximation and the fact that the electrical double-layer is modeled with a liner capacitor component, its capacitance can be determined from the relationship of a capacitor's discharge at a constant current:

$${C}_{d} = \frac{{i}_{1} {τ}_{tr1}}{{V}_{T01} - {V}_{T11}} \qquad ( 31 )$$

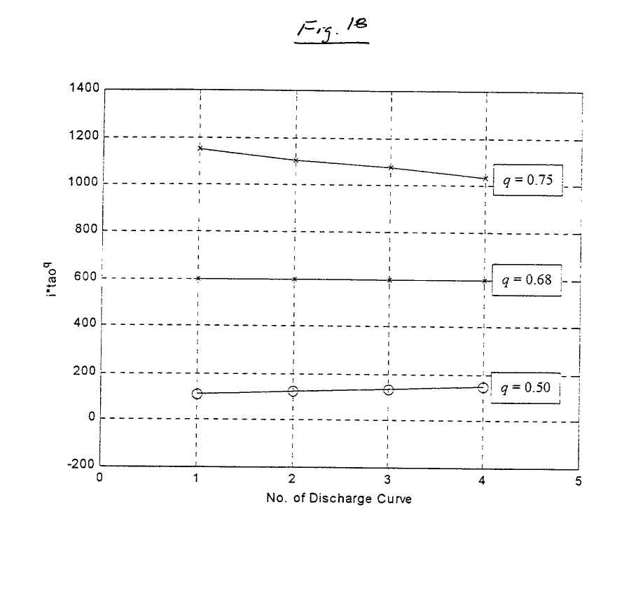

Definition of the variables in Equation (31) is shown in FIG. 14, which is an expanded view of the transient response region A for the generic battery. V₀₁ is the terminal voltage at the start of discharge and V₁₁ at the end of transient response. The corresponding discharge current is i, and ₜᵣ₁ is the time period of the transient response.

For the generic battery, Vₒ₁=1.90V, V₁₁=1.78V, i₁=1 A, ₜᵣ₁=370 sec. The capacitance of the double-layer capacitor is thus:

$${C}_{d} = \frac{1 \times 360}{1.90 - 1.78} = 3 , 000 F$$

In applying the relationship of Equation (31), the discharge curve that corresponds to the smallest discharge current should be used. This is because at smaller discharge currents, the transient response period is longer and the effects of the other components are the smallest. Thus, it is easier to determine all the constants from the response data. The assumption that the double-layer capacitor supplies all discharge current during the transient response period was found to be satisfactory in most cases. If this approximation causes an unacceptable discrepancy, the capacitance C_{d} can be fine-tuned during simulation. Several other parameters can also be determined from the response at the beginning of discharge as explained below.

### Determination of Ohmic Resistance

At the beginning of discharge (t=0), the terminal voltage starts at different levels with respect to the discharge current: those with smaller discharge current start at a higher voltage and vice versa. As explained in the last section, at the very beginning of discharge, charge transfer polarization is small and the double-layer capacitor has not started to discharge. Meanwhile, the concentration polarization is also small. The only major voltage drop that is reflected to the initial terminal voltage is due to the Ohmic resistor Rₛ. Let the terminal voltage at zero discharge current be E_{OCV0}. The voltage drops due to the Ohmic resistor for discharge current iⱼ, j=1, 2, . . . N, where N is the number of the available discharge curves, are then:

ΔV_{jR}=iⱼRₛ (32)

Therefore, the terminal voltage at t=0 for discharge current iⱼ is:

V_{T0j}=E_{OCV0}−ΔV_{jR}=E_{OCV0}−iⱼRₛ (33)

If there are more than two discharge curves available, E_{OCV0} in Equation (4.3.4) can be eliminated to solve for the Ohmic resistance Rₛ. For example, using discharge curves corresponding to discharge current i₁ and i₂ to solve for Rₛ results in:

$${R}_{s} = \frac{{V}_{T01} - {V}_{T02}}{{i}_{2} - {i}_{1}} \qquad ( 34 )$$

For the generic battery example, the terminal voltage starts at:

V_{T01}=1.900V, V_{T02}=1.875V and V_{T04}=1.800V

for the discharge currents i₁=1.0 A, i_{2,}=1.5 A, i₃=2.0 A, and i₄=3.0 A, respectively. Using any two pairs of the data (V_{Oj}, iⱼ) in Equation (4.3.5) yields Rₛ=0.05.

In practice, if there are more than two discharge curves, all of them can be used to find the Rₛ using a curve fitting method such as the Least Square technique.

### Determination of Initial Concentration and Nernst Equation

After Rₛ is determined in the last step, the open circuit voltage (OCV) at zero current, E_{OCV0}, can be determined from any one of the discharge curves using Equation (33). For example:

E_{OCV0}=V_{T0j}+iⱼRₛ (35)

Using discharge current i₁ data for the generic battery, it is found:

E_{OCV0}=1.90+1×0.05=1.95V

It is noted that E_{OCV0} is not determined directly from any response data, but from the characteristic of the Ohmic resistance. For a linear resistor, which is assumed for the Ohmic resistor, at zero current, the voltage drop across the resistor is also zero. This is the same statement as expressed by Equation (35).

The OCV at the beginning of discharge (E_{OCV0}) corresponds to the terminal voltage generated by the effective initial concentration C₀, as previously discussed, through the Nemst equation, i.e.,

$${E}_{OCV0} = {E}_{0} + \frac{RT}{n F} ln {C}_{0} \qquad ( 36 )$$

Once E_{OCV0} is determined, if E₀, the effective standard potential of the whole cell, is also known, C₀ can be determined from Equation (36). However, no method has been found to determine E₀ directly from the response data. In fact, E₀ is the only parameter in the new modeling method that cannot be directly determined from device external behavior. In other words, no correlation has been found between E₀ and the response data. Therefore, different methods must be used to determine E₀.

As previously discussed, the physical meaning of E₀ is the algebraic sum of the standard electrochemical potentials of each electrode. Fortunately, the standard electrochemical potential data for most electrodes is readily available. Let E_{0c} and E₀ₐ be the algebraic value of standard potential for cathode and anode, respectively. The effective standard potential for the whole cell is then:

E₀=E_{0c}−E₀ₐ (37)

For the generic battery example, assume the standard potential for one electrode (cathode) is 1.4V and other (anode) is −0.5V, the effective standard potential for the whole cell is then:

E₀=1.4V−(−0.5V)=1.9V

Once E₀ is known, the initial effective concentration of the active species of the cell can be found from Equation (36) as:

$${C}_{0} = exp [ \frac{n F}{RT} ( {E}_{OCV0} - {E}_{0} ) ] \qquad ( 38 )$$

For the generic battery, Equation (38) yields C₀=2.616. The unit of C₀ is dimensionless, but it represents the numerical value of the concentration of the active materials. The value of C₀ will be used frequently later in the modeling process.

The above procedure has also determined the Nernst equation parameters. For the generic battery:

E=1.95+0.052 ln Cₑ (39)

The behavior of the OCV from Equation (39) for the generic battery is shown in FIG. 15.

It is important to point out that the determination of E₀ from electrochemical data is not absolutely necessary. For simulation purposes, any convenient number can be selected for E₀, and a corresponding C₀ will result from Equation (38). For example, E₀ can always be selected to be the same as E_{OCV0}, i.e., E₀=E_{OCV0}. In this case, C₀ will always be one. The E₀ and C₀ determined this way will produce the same numerical result as E₀ and C₀ determined from Equations (37) and (38). This statement will be made clear later through an example. The only consideration in selecting E₀ is to ensure that the corresponding C₀ has a proper scale with other simulation variables. Therefore, there are two ways to determine the standard potential E₀. If it is desired to preserve the physical meaning of the parameters, E₀ can be determined using electrochemical data. Otherwise, a somewhat arbitrary selection of E₀ can be made to obtain a numerical value C₀ as long as E₀ and C₀ satisfy the relationship of Equation (38). There is no difference in the final result and no preference for either approach.

### Determination of Charge Transfer Polarization

At the end of transient response, nearly all the discharge current is supplied by the Faradaic current, therefore, i≈i_{f}. The charge transfer polarization _{ct} starts to reach its steady state corresponding to the given discharge current. The full effect of the voltage drop due to the charge transfer polarization is now reflected in the terminal voltage. Also at this point, other processes affecting the terminal voltage such as reduced voltage due to the Nernst relationship and the concentration polarization are not significant because the Cₑ is still close to the initial concentration C₀.

Therefore, at the end of the transient response (t=ₜᵣ), the terminal voltage drop is mainly due to the charge transfer polarization and the bulk resistance as determined above. This relationship can be expressed:

V_{T1j}=E_{OCV0}−ΔV_{jR}−η_{ctj} (40)

Since V₀ⱼ=E_{OCV0}−V_{jR} from Equation (33), the charge transfer polarization _{ctj} can be found from Equation (40) to be:

η_{ctj}=V_{T0j}−V_{T1j} (41)

For the generic battery example, V₀ⱼ, determined in the discussion of Double Layer Capacitance, the V₀ⱼ are:

V_{T01}=1.900V, V_{T02}=1.875V, V_{T03}=1.850V and V_{T04}=1.800V V_{T11}=1.782V, V_{T12}=1.746V, V_{T13}=1.712V and V_{T14}=1.675V

Therefore, the charge transfer polarization Ctj's are:

η_{ct1}=V_{T01}−V_{T11}=1.900−1.782=0.118V

η_{ct2}=V_{T02}−V_{T12}=1.875−1.746=0.129V

η_{ct3}=V_{T03}−V_{T13}=1.850−1.782=0.138V

η_{ct4}=V_{T04}−V_{T14}=1.800−1.782=0.149V

It was previously shown that the relationship of _{ctj} with respect to discharge current i will normally follow one of two the forms of approximation for a general Volmer-Bulter relationship of the charge transfer polarization. One of these forms is the Tafel equation for large charge transfer polarization; the other is a linear relationship for small polarization. The Tafel equation has the form:

η_{ct}=a+b ln(i_{f}) (42)

Therefore, if _{ctj} is plotted against ln(i_{f}), a straight line will result with slope of the line equal to b and intersection on the _{ct} axis equal to a. Two parameters, a and b, need to be determined from the response data. For small charge transfer polarization, the following relationship holds:

η_{ct}=c+di_{f} (43)

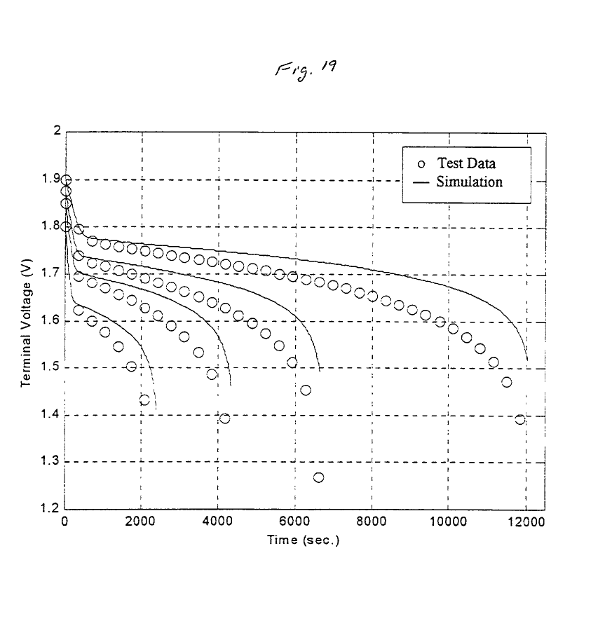

Therefore, _{ct} is linear with respect to i_{f}. Again two parameters, c and d need to be determined. For the generic battery example, the charge transfer polarization ct is plotted against discharge current ln(i_{f}), where i_{f}=i is used, as shown in FIG. 16 with symbol marks.

The plot shows that the charge transfer polarization closely follows the Tafel equation. The two parameters in the Tafel Equation (42) can be found to be a=0.118, and b=0.028, in order for the Tafel relationship to fit closely with the experimental data.

In summary, the charge transfer polarization for the generic battery determined from the above procedure is:

η_{ct}=0.188+0.028 ln(i_{f}) (44)

The behavior of this relationship is also shown in FIG. 16 in a continuous line.

### Determination of Diffusion Processes

When a battery discharge reaches the quasi-steady state operation, represented by region B in FIG. 13, the discharge current now is entirely supplied by Faradaic current. As discussed in the Section “Energy Conversion Mechanism,” it was seen that the Faradaic current is supported by the flux of the active ions inside the battery. As the battery discharge continues, active material in the battery is consumed. This is reflected in a decrease of the effective concentration Cₑ. The decrease of Cₑ is, in turn, reflected to the OCV E through the Nernst relationship. Eventually, Cₑ decreases to a point corresponding to the terminal voltage reaching the cut-off voltage V_{off}. At this time (t=), the battery discharge is finished. Now it will be shown that the cut-off time of discharge is related to the parameters of the diffusion process.

It also has been shown that the diffusion process is governed by the fractional order PDE:

$$\frac{{\partial }^{2 q} C ( x , t )}{\partial {t}^{2 q}} = D \frac{{\partial }^{2} C ( x , t )}{\partial {x}^{2}} \qquad ( 45 )$$

The transfer function of the effective concentration (Cₑ) at the electrodes (x=0) to the discharge current, which is the Faradaic current in nature, is a constant phase element (CPE), i.e.,

$$H ( s ) = \frac{{C}_{e} ( s )}{{i}_{f} ( s )} = \frac{K}{{s}^{q}} \qquad ( 46 )$$

The initial and boundary conditions for the fractional order PDE (45) are normally defined for the diffusion process in an electrochemical cell to be:

Initial conditions: C(x)=C₀ for all x, at t=0

Boundary Condition 1

$$D \frac{ⅆ C ( x )}{ⅆ x} {\vert}_{x = 0} = \frac{{i}_{f}}{nFA} ,$$

where D is the coefficient of diffusion.

Boundary Condition 2:

C(∞)=C₀

The initial conditions say that the concentration everywhere in the electrolyte is C₀ before the discharge starts. The first boundary condition is the repetition of Faraday's Law and the second boundary condition is the semi-infinite assumption. Under these conditions and using the total discharge current i for the Faradaic current if, the time response of Equation (45) for Cₑ can be shown to be:

Cₑ(t)=C₀−Kit^{q} (47)

Let the cut-off voltage be V_{off}. Then through the Nernst relationship, the effective concentration at an electrode that corresponds to the cut-off voltage is:

$${C}_{off} = exp [ \frac{n F}{RT} ( {V}_{off} - {E}_{0} ) ] \qquad ( 48 )$$

Equation (47) can be rearranged for the C_{off} to be:

$$i {τ}^{q} = \frac{{C}_{0} - {C}_{off}}{K} \qquad ( 49 )$$

The right side of this equation is a constant and the current and cut-off time on the left apply to any discharge curve. Therefore, an important observation can be made: for each discharge curve in a battery response with its associated iⱼ, and j, the product of iⱼ and ^{q}ⱼ is a constant whose value is defined by Equation (49).

From the response data for different discharge currents and their associated cut-off times, the diffusion parameter q can be determined. A graphical method is used for this purpose. Equation (49) implies that the plot of the product iⱼⱼ^{q} at a certain q for all discharge curves in a battery response data is a straight line with zero slope. The parameter q can then be determined by searching between 0 and 1 to reach a value that produces a plot for Equation (49) with each discharge curve to fit most closely with a straight line. Different criteria can be used to measure the “straightness” of a line. Here, a simple yet effective approach is used.

Define a Fig. of merit M as:

$$M = \frac{max ( {i}_{j} {τ}_{j}^{q} ) - min ( {i}_{j} {τ}_{j}^{q} )}{average ( {i}_{j} {τ}_{j}^{q} )} , j = 1 , 2 , … , N \qquad ( 50 )$$

where N is the number of individual discharge curve available in a battery response data. The smallest M(Mₘᵢₙ) indicates that iⱼⱼ^{q} are closest to a constant. The corresponding q at the Mₘᵢₙ is then used for the diffusion process in the equivalent circuit battery model.

For the generic battery example, the cut-off time for the cut-off voltage V_{0ff}=1.2V for each discharge current is as follows:

(i₁,τ₁)=(1.0 A, 12,060 sec.), (i₂,τ₂)=(1.5 A, 6,648 sec.)

(i₃,τ₃)=(2.0 A, 4,368 sec.), (i₄,τ₄)=(3.0 A, 2,412 sec.)

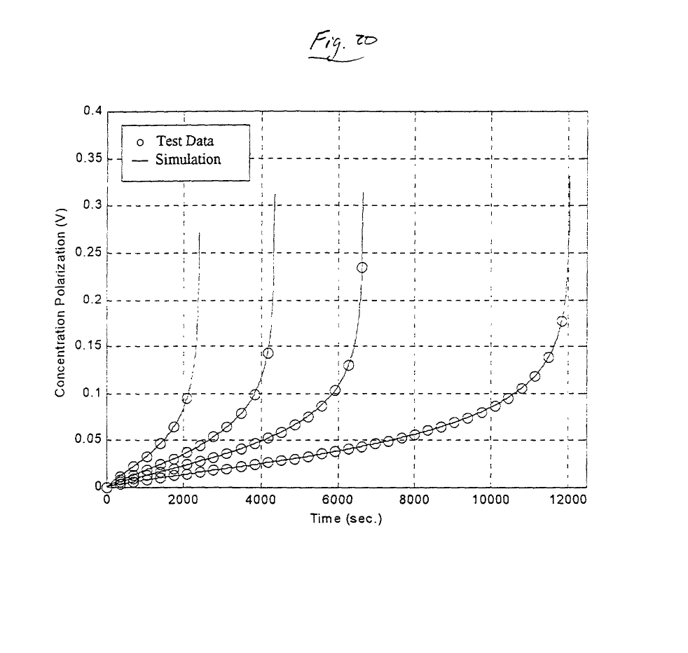

The Fig. of merit Mused in the search process described above is shown in FIG. 17. At q=0.68, M reaches a minimum and iⱼⱼ^{q}=596 for j=1, 2, 3, and 4. The value of iⱼⱼ^{q} for each discharge curve of the generic battery is shown in FIG. 18 with different q values. It is seen that q=0.68 produces a line with zero slope for all iⱼⱼ^{q}. These Figs. demonstrate the effectiveness of developed parameter identification procedure for the diffusion process.

After q is determined from the above process, another parameter in the diffusion process, K, can be determined using Equation (49) which can be rearranged into:

$$K = \frac{{C}_{0} - {C}_{off}}{i {τ}^{q}} \qquad ( 51 )$$

For the generic battery, C_{off} is calculated from Equation (4.3.19) for V_{off}=1.2V to be C_{off}=1.42 e⁻⁶. Plugging C_{off} in Equation (51) and using iⱼⱼ^{q}=596 yields

$$K = \frac{1}{227.5} .$$

To summarize the identification procedure for the parameters of the diffusion process, a CPE component is used to model the mass transport properties of an electrochemical cell. An important conclusion was made to relate the time response of the battery discharge to the parameters of the CPE. An effective method was developed to determine the parameters from the response data.

It was previously stated that the selection of E₀ does not have to come from the electrochemical data. The reason can now be explained. Any value of E₀ has a corresponding value of C₀ from the Nernst equation. For each C₀, there, in turn, exists a K as determined from Equation (51). Therefore, any combination of C₀ and K will produce the same numerical result in the time response for the system of Equation (47). The parameter q is not affected by the selection of C₀ and K Therefore, a somewhat arbitrary selection of E₀ can be made to produce the same simulation result. However, the reason to choose E₀ based on the electrochemical information, as explained above, is still valid.

### Determination of Concentration Polarization

At this time, parameters for all but the concentration polarization in the equivalent circuit model have been identified. Parameters of the concentration polarization cannot be determined directly from the battery response data. It needs data from the simulation that is not available yet.

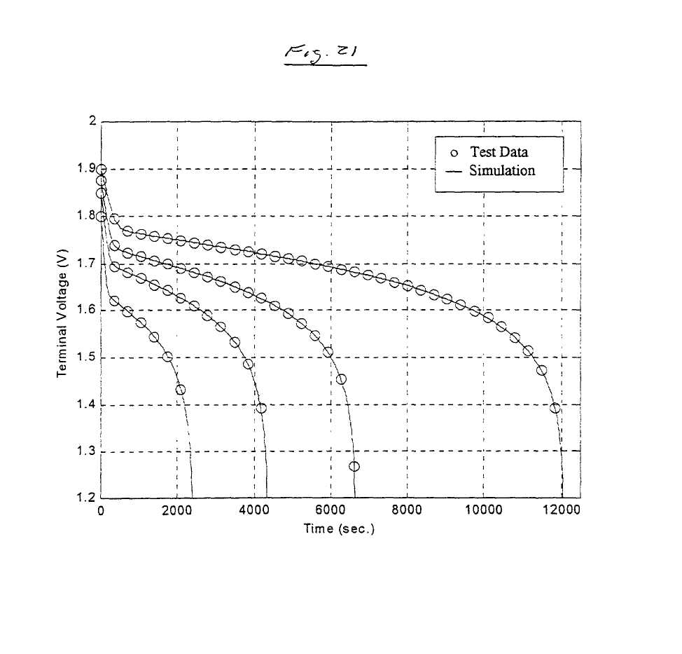

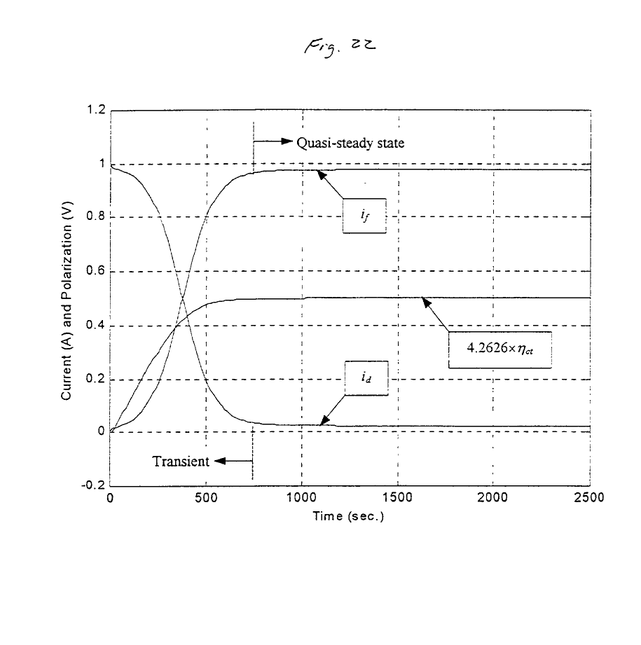

Ignoring the effect of concentration polarization for now, the response from the model up to this point can be simulated. FIG. 19 is the simulation result without concentration polarization effect for the generic battery. The simulation based on the new model as depicted in FIG. 10 correctly predicts the transient response and cut-off time for the generic battery. One major discrepancy is that the model predicted terminal voltage is higher than actual data, especially toward the end of discharge. The reason for this discrepancy is because the concentration polarization was ignored in the simulation. With the simulation result and the experimental data, the parameter for concentration polarization can now be determined. It will be recalled that concentration polarization for the battery discharge was modeled with the relationship:

$${η}_{c} = h ln \frac{{C}_{e}}{{C}_{0}} \qquad ( 52 )$$

in which only one parameter h needs to be identified. If the experimental data of the terminal voltage is subtracted from the simulation data, the difference is considered to be the effect due to the concentration polarization. Performing this operation produces a series of curves corresponding to the time response of concentration polarization at different discharge currents. This response is shown in FIG. 20 with marked symbols. The single parameter h is determined from the trial and error for the concentration polarization to match this data with smallest error.

For the generic battery example, the value h=0.04 in Equation (52) produces the closest match with the actual data. The model predicted response for concentration polarization is also shown in FIG. 20 in continuous lines.

Adding the effect of the concentration polarization just determined to the equivalent circuit model, simulation of the complete model produces a response that closely matches actual data. This is shown in FIG. 21 with simulated data in continuous line and actual data in the marked symbol.

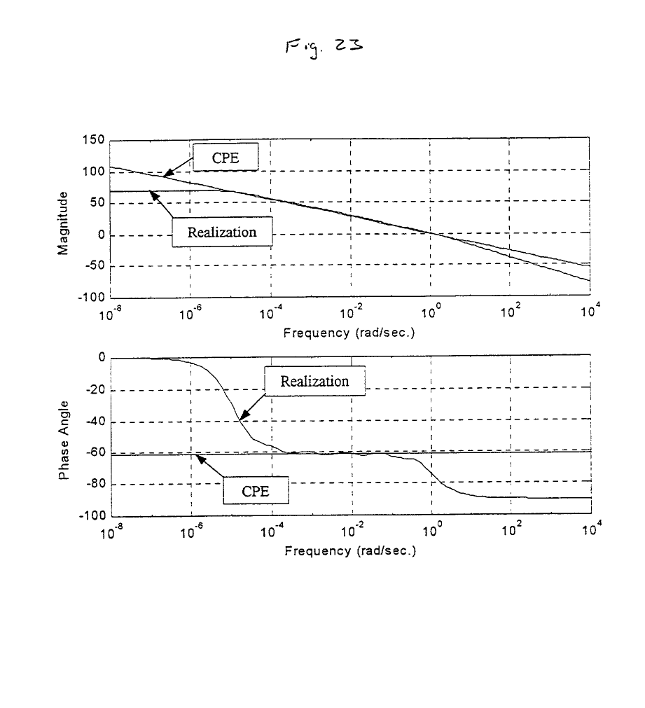

Since the complete model is available now and simulation performed, some assumptions that were made for the parameter identification process can be verified. The most important assumption made in the parameter identification process is the transition from the transient response to the quasi-steady state response. FIG. 22 shows the response of the Faradaic current i_{f}, the double-layer capacitor current i_{d} and the scaled (for clarity) charge transfer polarization _{ct} during the discharge of the generic battery for the discharge current i=1 A. It was assumed that during the transient response period, the discharge current is mainly supplied by the double-layer capacitor current i_{d} while during the quasi-steady state by the Faradaic current i_{f}. Also, the charge transfer polarization _{ct} will reach a steady state as the battery discharges. These assumptions are clearly shown to be correct in the Fig.

Another issue that needs to be pointed out is that for some batteries, the transient response of the discharge is not available with the battery's response data or its value is difficult to determine. This does not mean that the batteries do not have the transient response; it simply indicates that the battery manufacturers do not consider this data to be important for the assumed usage of the batteries. In this situation, the double-layer capacitor does not need to be included in the model since its capacitance cannot be uniquely determined. Also, it is not possible to separate the effects of the Ohmic resistor and charge transfer polarization from the transient response. It is recommended in that case that the initial voltage drop due to the Ohmic resistor and the charge transfer polarization be combined into the charge transfer polarization process. An example to illustrate this procedure will be given in the next section.

### Summary of Parameter Identification

To summarize the parameter identification process, the correlation between the specific aspects of the constant current discharge response of a battery and the components in the equivalent circuit model is established. Unique methods of determining the parameters of the diffusion process and concentration polarization are developed. Using the behavioral relationship defined for each component and the battery's response data, the parameters of the component can be uniquely determined. The constant current discharge response is selected because it is the most commonly available. The parameter identification process in the new modeling method does not need the electrochemical data and device design information. For convenience, parameter identification processes for each component of the new battery model are summarized below.

### Summary of Parameter Identification Process

Definitions. N: number of curves in the constant current discharge; iⱼ, j=1, 2, . . . , N: discharge current, i₁ is the smallest current; V₀ⱼ: terminal voltage at t=0; V₁ⱼ: terminal voltage at t=ₜᵣⱼ where ₜᵣⱼ is the transient time; V_{off}: cutoff voltage; ⱼ: cutoff time; E₀ₐ, E_{0c}: standard potentials of the anode and cathode; Vₛᵢₘ: terminal voltage from the simulation without concentration polarization; V: terminal voltage from response data.

$$\begin{matrix} Component & Parameter & \begin{matrix}Input \text{-} Output \\ Relationship\end{matrix} & Identification Method \\ \begin{matrix} Double \text{-} Layer \\ Capacitor\end{matrix} & {C}_{d} & \frac{ⅆ {V}_{1}}{ⅆ t} = \frac{{i}_{d}}{{C}_{d}} & {C}_{d} = \frac{{i}_{1 {τ}_{tr 1}}}{{V}_{T 01} - {V}_{T 11}} \\ Ohmic Resistor & {R}_{s} & Δ V = {iR}_{s} & {R}_{s} = \frac{{V}_{T 01} - {V}_{T 02}}{{i}_{2} - {i}_{1}} \\ Nernst Equation & {E}_{0} & E = {E}_{0} + 0.052 ln {C}_{e} & \begin{matrix}{E}_{0} = {E}_{0 c} - {E}_{oa} or {E}_{0} = {E}_{OCV 0} \\ where {E}_{OCV 0} = {V}_{T 0 j} + {i}_{j} {R}_{s}\end{matrix} \\ \begin{matrix} Diffusion \\ Process\end{matrix} & {C}_{0} & Initial Condition & {C}_{0} = exp [ \frac{n F}{RT} ( {E}_{OCV 0} - {E}_{0} ) ] \\ \begin{matrix}Charge Transfer \\ Polarization\end{matrix} & \begin{matrix}\begin{matrix}a , b \\ or\end{matrix} \\ c , d\end{matrix} & \begin{matrix}\begin{matrix}{η}_{ct} = a + b ln ( {i}_{f} ) \\ or\end{matrix} \\ {η}_{ct} = c + {di}_{f}\end{matrix} & \begin{matrix}{η}_{ctj} = {V}_{T 0 j} - {V}_{T 1 j} \\ and then data fit\end{matrix} \\ \begin{matrix} Diffusion \\ Process\end{matrix} & q & H ( s ) = \frac{{C}_{e} ( s )}{{i}_{f} ( s )} = \frac{K}{{s}^{q}} & M = \frac{max ( {i}_{j} {τ}_{j}^{q} ) - min ( {i}_{j} {τ}_{j}^{q} )}{average ( {i}_{j} {τ}_{j}^{q} )} \\ & K & H ( s ) = \frac{{C}_{e} ( s )}{{i}_{f} ( s )} = \frac{K}{{s}^{q}} & K = \frac{{C}_{0} - {C}_{off}}{{iτ}^{ q}} \\ & & & where {C}_{off} = exp [ \frac{n F}{RT} ( {V}_{off} - {E}_{0} ) ] \\ \begin{matrix}Concentration \\ Polarization\end{matrix} & h & {η}_{c} = h ln \frac{{C}_{e}}{{C}_{0}} & {η}_{c} = {V}_{sim} - {V}_{T} and then data fit\end{matrix}$$

### Implementation and Validation of New Model

A new modeling approach was developed and used to obtain models for several actual batteries. The new approach is effective in obtaining a battery model and accurate in describing the constant current discharge operation of the battery. For other operating modes, however, the model in its original form may not be the most effective and convenient.

### Equivalent Variations of Model

The battery model using the approach discussed above contains a constant phase element (CPE). For a simple operation such as the constant current discharge, the time response of the CPE is easy to solve and can be used directly in the simulation. However, for a more complicated discharge current, it is much more difficult, sometime impossible, to obtain an analytical solution for the CPE. In this situation, it is better to use a computer software package to simulate the CPE numerically. Unfortunately, there is no software at the present time can handle a fractional order system such as a CPE directly. A solution to this dilemma is first to convert the CPE into a form that can be used by software. This conversion process is described below.

Another issue about the model developed is that it is difficult to analyze certain characteristics of a battery using the model in its current form. This difficulty arises from the nature of how a battery stores its energy. In the model, the battery energy is represented by the concentration of the active material spatially distributed in the electrolyte. However, the diffusion process also acts on the electrolyte, and thus the energy storage and mass transport is coupled in a battery. Reflection of this property in the model results in a coupled source and impedance from the electrical perspective. This arrangement makes it difficult for the analysis of the device characteristics in some cases. For example, for a clear analysis of device impedance characteristics, it is best to separate the source and impedance. Another example is that in determining the state of charge (SOC) of a battery, it is desirable to use a single parameter. With a distributed model for energy storage, accurate information about SOC can only be obtained by accounting for the status of the active material at all spatial locations. clearly, this is not very convenient. These issues motivate the development of a decoupled model that separates the source from the impedance of a battery. The resulting models are functionally equivalent to the original coupled model, but more effective in some particular applications of the battery model. The development of the equivalent variations of the model is also presented below.

### Realization of Constant Phase Element

One of the key components in the equivalent circuit model developed in the last chapter is the CPE that is used to represent the diffusion process of the active species. A CPE is governed by a fractional order partial differential equation (PDE):

$$\frac{{\partial }^{2 q} C ( x , t )}{\partial {t}^{2 q}} = D \frac{{\partial }^{2} C ( x , t )}{\partial {x}^{2}} \qquad ( 53 )$$

Under the initial and boundary conditions that apply to an electrochemical cell, the time response for the concentration of active species at the electrode surface (x=0) for a constant current discharge is:

Cₑ=C₀−Kit^{q} (54)

Equation (54) was used in identifying parameters of the diffusion process and simulation of the constant current discharge response in the last chapter. More generally, the transfer function of Cₑ to the discharge current i is:

$$H ( s ) = \frac{{C}_{e} ( s )}{i ( s )} = \frac{K}{{s}^{q}} \qquad ( 55 )$$

If the discharge current i is not constant, as long as its Laplace transform exists, the time response of Cₑ can be solved from Equation (56) by taking the inverse Laplace transform of H(s)i(s), i.e.,

$${C}_{e} = {C}_{0} - {L}^{- 1} [ \frac{K}{{s}^{q}} i ( s ) ] \qquad ( 56 )$$

where L⁻¹ is the inverse Laplace transform operator. The solution of Cₑ from this approach usually involves the convolution operation with the input signal in the time domain.

For an arbitrary discharge current, however, it is generally more difficult or impossible to obtain its Laplace transformation; hence, the time response of Cₑ is difficult to obtain analytically. In this situation, it is desired to avoid using the time domain solution altogether for the CPE component in the simulation. Instead, each component is expressed by its transfer function in the frequency domain and a simulation package such as MATLAB is used to obtain the time response of the whole system.

A difficulty arises, however, in using the transfer function involving a fractional order system such as a CPE due to the fact that no existing simulation tools can directly handle a fractional order system. Therefore, the fractional order system has to be converted to other forms that can be used by existing simulation tools. This conversion process sometimes is known as the realization of a fractional order system. The result is summarized as follows.

Any conversion technique is an approximation of the original fractional system since the latter is a distributed parameter system that can only be fully described by an infinite order system realization. However, a transfer function with all integer orders of the Laplace variable s can be used to approximate the original fractional order system with acceptable accuracy. The approximate system can have a close match in its frequency response to the original fractional order system in the selected frequency range of interest. For example, for the fractional order system from the CPE in the generic battery:

$$H ( s ) = \frac{{C}_{e} ( s )}{i ( s )} = \frac{1}{227.5 {s}^{0.68}} \qquad ( 57 )$$

The following transfer function can be used to approximate Equation (57) with a maximum error of y=2 dB in the frequency range=[10⁻⁵, 1] rad/sec.

$${H}_{R} ( s ) \approx \frac{{C}_{e} ( s )}{I ( s )} = \frac{\begin{matrix}{s}^{5} + 0.34 {s}^{4} + 0.012 {s}^{3} + \\ 5.17 {e}^{- 5} {s}^{2} + 2.63 {e}^{- 8} s + 1.44 {e}^{- 12}\end{matrix}}{\begin{matrix}{s}^{6} + 0.66 {s}^{5} + 0.047 {s}^{4} + 3.95 {e}^{- 4} {s}^{3} + \\ 4.00 {e}^{- 7} {s}^{2} + 4.83 {e}^{- 11} s + 6.26 {e}^{- 16}\end{matrix}} \qquad ( 58 )$$

where e⁻ⁿ stands for 10⁻ⁿ. This transfer function has zeros at locations:

$${z}_{1} = - 6.21 {e}^{- 5} , {z}_{2} = - 5.16 {e}^{- 4} , {z}_{3} = - 4.28 {e}^{- 3} , {z}_{4} = - 3.55 {e}^{- 2} , {z}_{5} = - 2.95 {e}^{- 1}$$

and poles at:

$${p}_{1} = - 1.47 {e}^{- 5} , {p}_{2} = - 1.22 {e}^{- 4} , {p}_{3} = - 1.02 {e}^{- 3} , \\ {p}_{4} = - 8.43 {e}^{- 3} , {p}_{5} = - 6.99 {e}^{- 2} , {p}_{6} = - 5.81 {e}^{- 1}$$

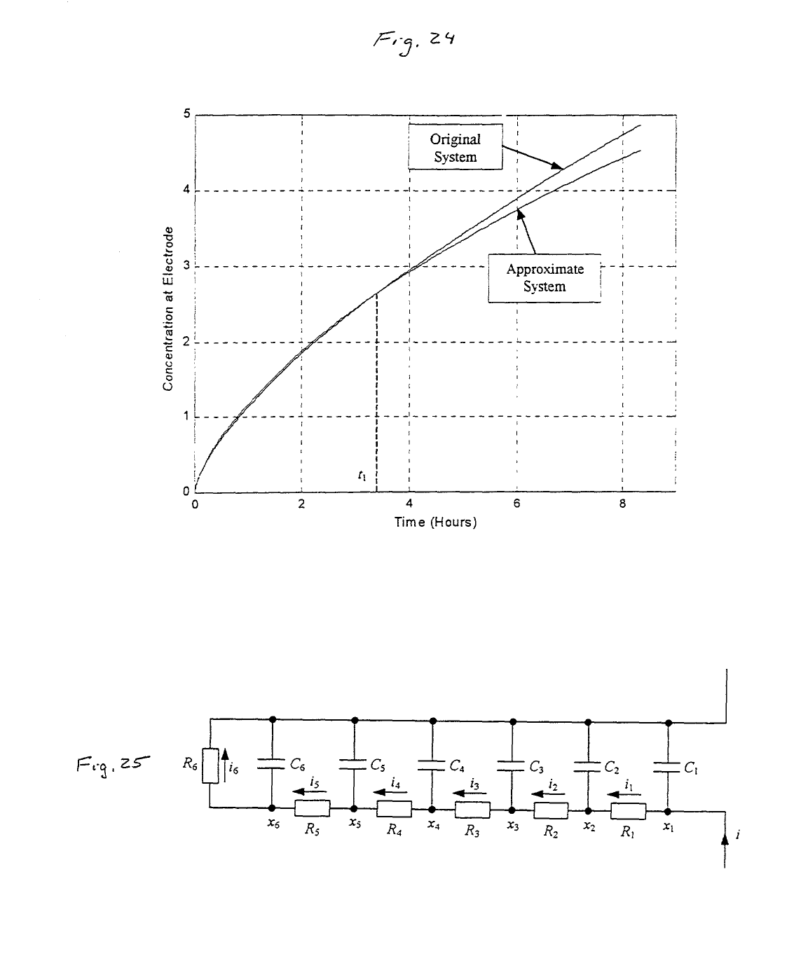

The frequency response of the original fractional system of Equation (57) and its realizations of Equation (58) is shown in FIG. 23, where a close match between the approximate system realization and the original system in the selected frequency range is displayed.

To verify the validity of the approximate system realization, the time response of the original fractional order system Equation (57) and the approximate system Equation (58) is compared with a step response with zero initial condition as shown in FIG. 24. It is seen that the response of the approximate system matches closely with that from the original system until time t₁. The time t₁ is dependent on the frequency range for a valid approximation and is usually selected to cover the complete response time. For example, if the response of the original fractional system reaches C₀ at time t₁, t₁ can then be used to determine the frequency range for the approximate system. Beyond t₁, which is the end of discharge corresponding to Cₑ=0, the response has no physical meaning any longer.

Once the transfer function of a system is available, it can be converted into other functionally equivalent forms. Two of these forms are of interest. One is the state space representation of the system and the other is using an equivalent electrical circuit. Different from a transfer function representation which has only input and output information, these equivalent representations of a system contain internal information of the original fractional system. For example, the following state-space representation is equivalent to the transfer function of Equation (58):

\dot{x}=AX+Bu

y=Cx

$$A = [ a \begin{matrix}- 6.60 {e}^{- 1} & - 4.68 {e}^{2} & - 3.95 {e}^{- 4} & - 4.00 {e}^{- 7} & - 4.83 {e}^{- 11} & - 6.26 {e}^{- 16} \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] \\ B = {[ 100000 ]}^{T} \\ C = [ 1 \; 3.35 {e}^{- 1} 1.21 {e}^{- 2} 5.17 {e}^{- 5} 2.63 {e}^{- 8} 1.44 {e}^{- 12} ] \qquad ( 59 )$$

where u=i, the discharge current, y=Cₑ, the effective concentration of active species at electrode surface, x's are the internal states of the system. It is important to note that the physical meaning of states of the system in the specific representation of Equation (59) does not necessarily correspond to the concentration of species at a spatial location. However, it is possible to obtain such a form through an equivalent transformation to match a system state to its physical meaning. The detailed description of this transformation is described by control theory.

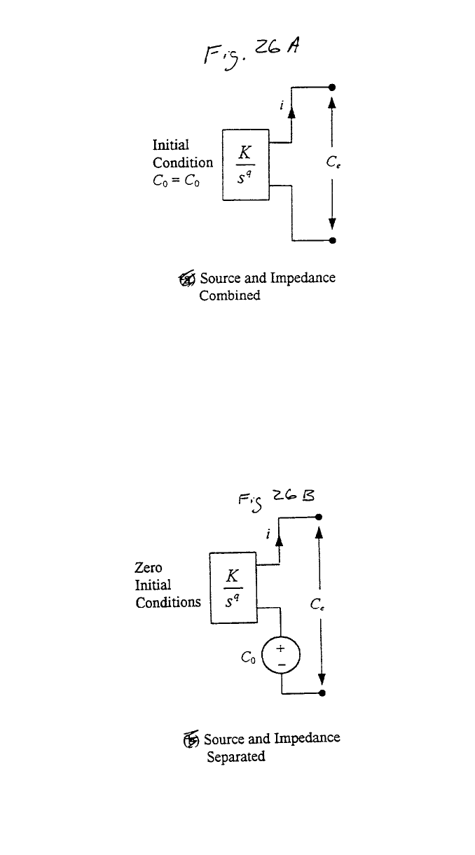

Another form of realization of the transfer function Equation (58) is to use an equivalent electrical circuit. An operational amplifier (Op-Amp) or a R-C net is normally used as a building block for a network to electronically or electrically duplicate a transfer function. The so-called First Cauer form realization using a R-C network can be obtained from the transfer function Equation (58). The circuit realization of the First Cauer form is shown in FIG. 25. The value for the components in FIG. 25 corresponding to Equation (58) is as follows:

$${C}_{1} = 1.00 F , {C}_{2} = 1.42 F , {C}_{3} = 2.45 F , {C}_{4} = 4.53 F , {C}_{5} = 8.97 F , \\ {C}_{6} = 19.29 F$$

$${R}_{1} = 3.08 Ω , {R}_{2} = 11.97 Ω , {R}_{3} = 49.39 Ω , {R}_{4} = 180.20 Ω , \\ {R}_{5} = 594.09 Ω , {R}_{6} = 1461.27 Ω$$

The physical meaning of this representation is very clear. The voltage at each capacitor element is the concentration of active species at a spatial location in the electrolyte.

A state-space representation can also be obtained from FIG. 25 that has a more clear meaning for the states of the system than Equation (59). The following state-space representation results from this approach.

$$\dot{x} = AX + Bu$$

$$y = Cx$$

$$A = [ \begin{matrix}- \frac{1}{{R}_{1} {C}_{1}} & \frac{1}{{R}_{2} {C}_{1}} & 0 & 0 & 0 & 0 \\ \frac{1}{{R}_{1} {C}_{2}} & {a}_{22} & \frac{1}{{R}_{2} {C}_{2}} & 0 & 0 & 0 \\ 0 & \frac{1}{{R}_{2} {C}_{3}} & {a}_{33} & \frac{1}{{R}_{4} {C}_{3}} & 0 & 0 \\ 0 & 0 & \frac{1}{{R}_{3} {C}_{4}} & {a}_{44} & \frac{1}{{R}_{5} {C}_{4}} & 0 \\ 0 & 0 & 0 & \frac{1}{{R}_{4} {C}_{5}} & {a}_{55} & \frac{1}{{R}_{5} {C}_{5}} \\ 0 & 0 & 0 & 0 & \frac{1}{{R}_{5} {C}_{6}} & {a}_{66}\end{matrix} ]$$

$$where$$

$${a}_{22} = - ( \frac{1}{{R}_{1} {C}_{2}} + \frac{1}{{R}_{2} {C}_{2}} ) ; {a}_{33} = - ( \frac{1}{{R}_{2} {C}_{3}} + \frac{1}{{R}_{3} {C}_{3}} ) ;$$

$${a}_{44} = - ( \frac{1}{{R}_{2} {C}_{3}} + \frac{1}{{R}_{3} {C}_{3}} ) , {a}_{55} = - ( \frac{1}{{R}_{4} {C}_{5}} + \frac{1}{{R}_{5} {C}_{5}} ) , \\ {a}_{66} = - ( \frac{1}{{R}_{5} {C}_{6}} + \frac{1}{{R}_{6} {C}_{6}} )$$

B=[100000]^{T}

C=[100000]^{T}

It is verified that the state-space representation of Equation (59) for the circuit of FIG. 25 has the same transfer function and eigenvalues of Equation (58).

In summary, once the original fractional order system is approximated by a transfer function that contains only the integer orders of Laplace transform variables, other equivalent realizations of the system can be obtained. The motivation to have different representations of a system is that one form is usually more convenient than another for certain analysis and design considerations. For example, for a state feedback controller or a state-observer design, the state-space representation of a system should be used. If using a circuit simulation tool such as SPICE, the equivalent circuit representation of the system is easier to implement in areas such as assigning initial conditions for each node in the system.

### Separation of Source and Impedance

The diffusion process in a battery as described to this point has served two functions: energy storage and impedance representation. The energy of a battery is stored or spatially distributed in the electrolyte in terms of concentration of active material. The movement of the active material during the cell reactions is controlled by the inherent impedance of the electrolyte. Both mechanisms were represented by a diffusion process that was described by a CPE in the equivalent circuit model of the battery. The energy storage property is reflected in the initial conditions of the CPE and material movement is controlled by the dynamic response of the CPE. For the constant current discharge of a battery, this response is essentially the relaxation process of a fractional order system from an initially charged state.

For some analysis, however, the diffusion process needs to be separated into two components: an energy source and an impedance associated with the source. This is done for the following reasons. First, for another type of galvanic device, namely, a fuel cell, which will be studied in more detail later, the electrolyte does not store any energy; all the materials for the fuel cell reactions are supplied from external sources. The products of the reactions on one electrode diffuse through the electrolyte to reach the other electrode. In this case, the physical process is more accurately described by a separated energy source, which is the fuel supply, and an impedance to the source. Second, for a battery, the coupled energy source and impedance in the CPE does not clearly indicate the amount of energy still remaining in a cell, i.e., the SOC of the battery, a practical problem of great importance, is difficult to determine. The energy stored in a distributed system such as a fractional order system can only be accurately determined by the physical status of active materials at all spatial locations. This is related to the initialization problem of a fractional order system. By separating the energy source and impedance in the battery model, it will be shown later in this paper that the SOC of a battery can be represented with a single element. Further, in studying the characteristic behavior of a galvanic device using impedance analysis, which will be performed later, it is more natural to separate the impedance of the device from the energy source element.

One approach to separate the energy source or storage element from the coupled source and impedance of the battery model is to recognize that the responses of a CPE of Equation (55) are equivalent under the following two situations:

Situation 1: All the internal states of the CPE start at an initial concentration C₀, then the time response of the diffusion process from the CPE is then:

Cₑ=C₀−Kit_{q}

This is the approach used above.

Situation 2: All internal states start at an initial concentration of zero, the response of the diffusion process under discharge current i alone is then:

Cₑ−Kit_{q}

This response is due wholly to the impedance characteristics of the diffusion process. If there is a separate constant DC source with its voltage being C₀, the total response of the diffusion process to the DC source and input current is again.

Cₑ=C₀−Kit_{q}

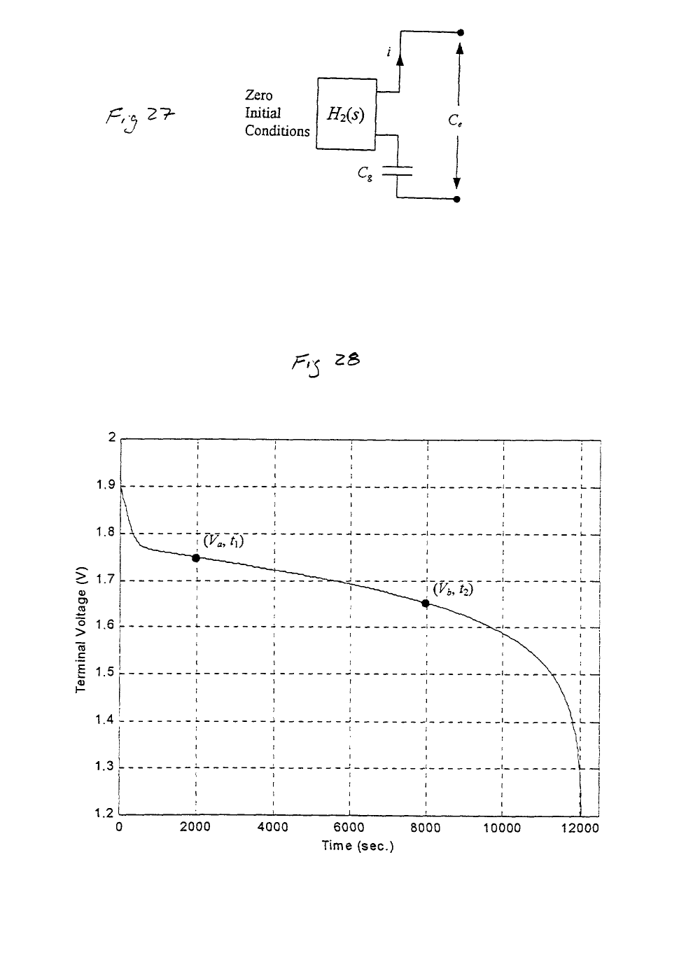

Therefore, the solutions to an initially charged diffusion process under these two situations are mathematically equivalent. Physically, however, they represent two different processes. The physical process expressed by these two views is schematically shown in FIGS. 26A and 26B.

Clearly, the energy source and impedance are separated in the configuration expressed with the second situation. In fact, this method has been used in the previous simulations since the initial condition for all the states in a state-space form of the realization for a CPE can be assigned to zero. Otherwise, it would be more difficult to determine the correct initial condition for each state since the physical meaning of the system states is not necessarily the concentration of the active material, as discussed before.

However, even with separated source and impedance shown in configuration (b) of FIG. 24, the problem to determine the SOC of the battery from a single element is still not resolved. The energy status in this configuration still depends on the knowledge of all the internal states in the impedance element at a certain time instance. To solve this dilemma, the original assumption on the energy storage component in the equivalent circuit is used.

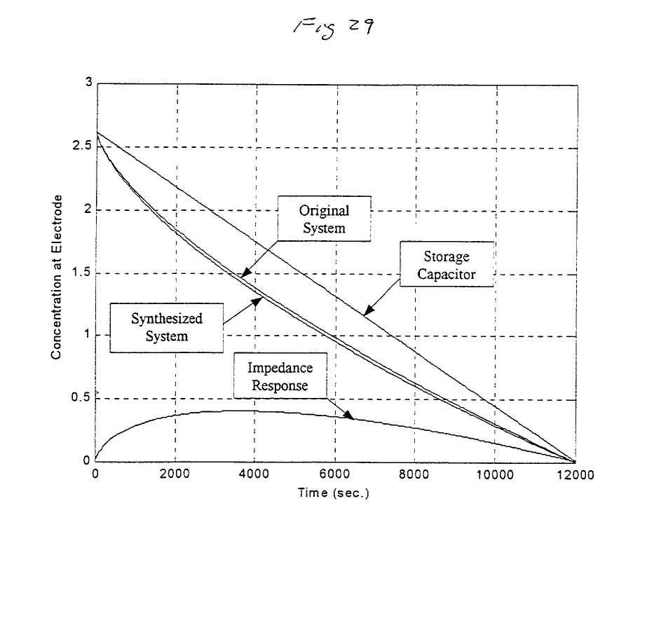

Conceptually, a single capacitor C_{g} can also be used to represent all the energy stored in a battery. Physically, this is not the case since it contradicts with the understanding that energy is spatially distributed. Nonetheless, using a single capacitor to represent the energy stored in a battery is beneficial in that the energy status of a battery can be exclusively determined from this single component. For a conventional capacitor with known capacitance, the energy stored in the capacitor can be exclusively determined from its terminal voltage. When a capacitor is used to represent the energy storage of a battery, it is proposed to replace the DC source in the FIG. 26B with the capacitor as shown in FIG. 27.

With this new configuration, however, the impedance of the diffusion process needs to be modified accordingly to make the system of FIG. 27 behave the same as the one of FIG. 26.

This is quite obvious since a capacitor behaves differently than a constant DC source. An approach is now given which relates the original CPE to an equivalent capacitor plus a new CPE.

The transfer function of the energy storage capacitor C_{g} is:

$${H}_{1} ( s ) = \frac{1}{{sC}_{g}} \qquad ( 60 )$$

It is required to find an impedance whose transfer function H₂(s) satisfies the relationship:

$${H}_{1} ( s ) + {H}_{2} ( s ) = \frac{K}{{s}^{q}} \qquad ( 61 )$$

This requirement is to make the frequency response of the combined system of H₁(s) and H₂(s) behave the same as the original fractional order system. Substitution of Equation (5.1.8) in (5.1.9) yields:

$${H}_{2} ( s ) = \frac{K}{{s}^{q}} - \frac{1}{{sC}_{g}} = \frac{{sKC}_{g} - {s}^{q}}{{s}^{{q}^{+ 1}} {C}_{g}} \qquad ( 62 )$$

Therefore, a passive impedance with transfer function H₂(s) and zero initial conditions can be combined with the energy storage capacitor C_{g}, pre-charged to C₀, to function equivalently as the original CPE with each of the internal states charged to C₀. Schematically, this configuration is shown in FIG. 27. It is emphasized again that the energy storage capacitor C_{g} and the associated passive impedance H₂(s) are artificially created. By themselves, each of them does not represent any actual physical process. Combining the two, however, produces a representation that is representative of the original diffusion process in a battery. Once again, the motivation for this conversion is to solve the battery SOC problem, I as will be discussed below.

The capacitance of the energy storage capacitance can be determined from battery response data. Referring to the typical constant current discharge data of a battery as shown in FIG. 13, the behavior in the quasi steady-state discharge region “B” can be attributed to the discharge of the energy storage capacitor C_{g}. In this region, the transient response from the double-layer capacitor is completed; the charge transfer polarization is in its steady state range; and the effect of the concentration polarization is not significant yet. Therefore, the most important factor in the response of this region is the discharge of the energy storage capacitor.

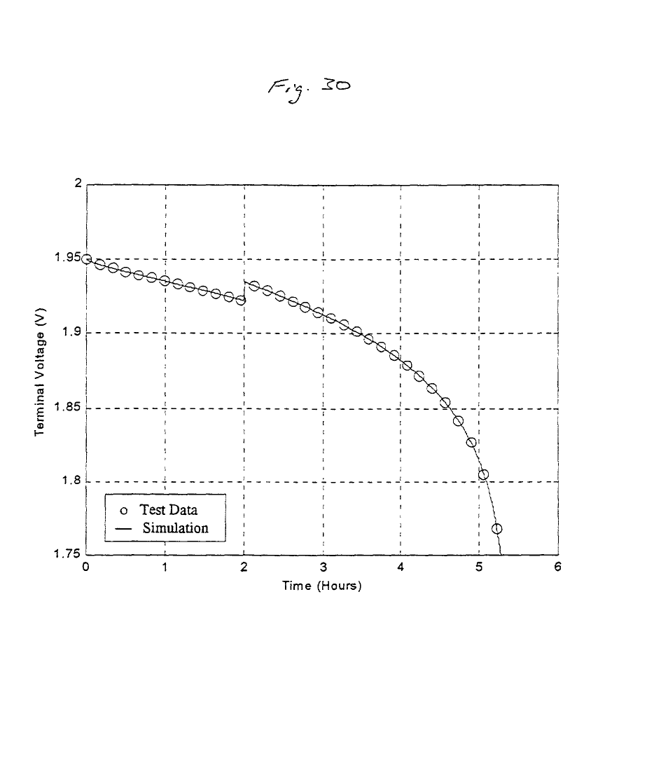

As shown in FIG. 28, two operating points, (Vₐ, t₂) and (V_{b}, t₂) in the quasi steady-state region of a curve corresponding to the discharge current i are selected. Since the voltage at C_{g} is the concentration of the active material, the voltages Vₐ and V_{b}, need to be converted to the values of their corresponding concentrations, Cₐ and C_{b}, respectively. This is done through the Nernst relationship, i.e.,

$${C}_{a} = exp [ \frac{n F}{RT} ( {V}_{a} - {E}_{0} ) ] and {C}_{b} = exp [ \frac{n F}{RT} ( {V}_{b} - {E}_{0} ) ]$$

The capacitance of the energy storage capacitor can then be determined simply from the capacitor discharge relationship:

$${C}_{g} = \frac{i ( {t}_{2} - {t}_{1}}{{C}_{a} - {C}_{b}} \qquad ( 64 )$$

From FIG. 28, which is the response data for discharge current i=1 A for the generic battery used before, two selected operating points are:

(Vₐ,t₁)=(1.75V,2000 sec.) and (V_{b},t₂)=(1.65V,8000 sec.)

The corresponding concentration for Vₐ, and V_{b}, calculated from Equation (63), using the value of the variables defined before, are Cₐ=1.8428, and C_{b}=0.6333. Then from Equation (64), the capacitance of the energy storage capacitor for the generic battery is:

$${C}_{g} = \frac{i ( {t}_{2} - {t}_{1} )}{{C}_{a} - {C}_{b}} = \frac{1 x ( 8000 - 2000 )}{( 1.8428 - 0.6333 )} = 4.961 F$$

The synthesized impedance H₂(s) with respect to C_{g} for the generic battery can be found according to Equation (62) to be:

$${H}_{2} ( s ) = \frac{20.62 s - {s}^{0.68}}{{s}^{1.68} {C}_{g}} \qquad ( 65 )$$

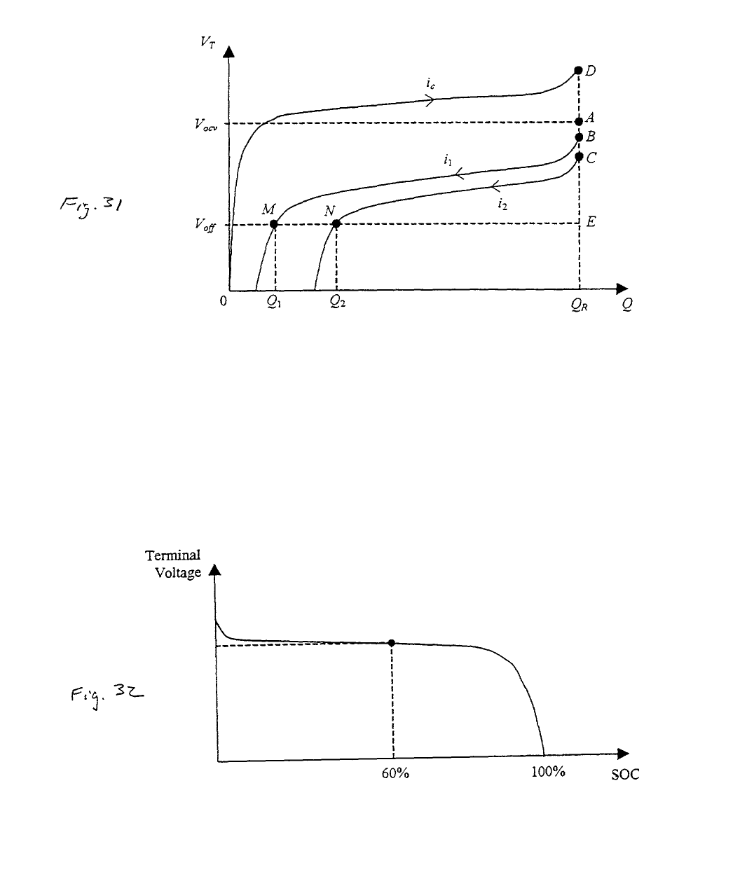

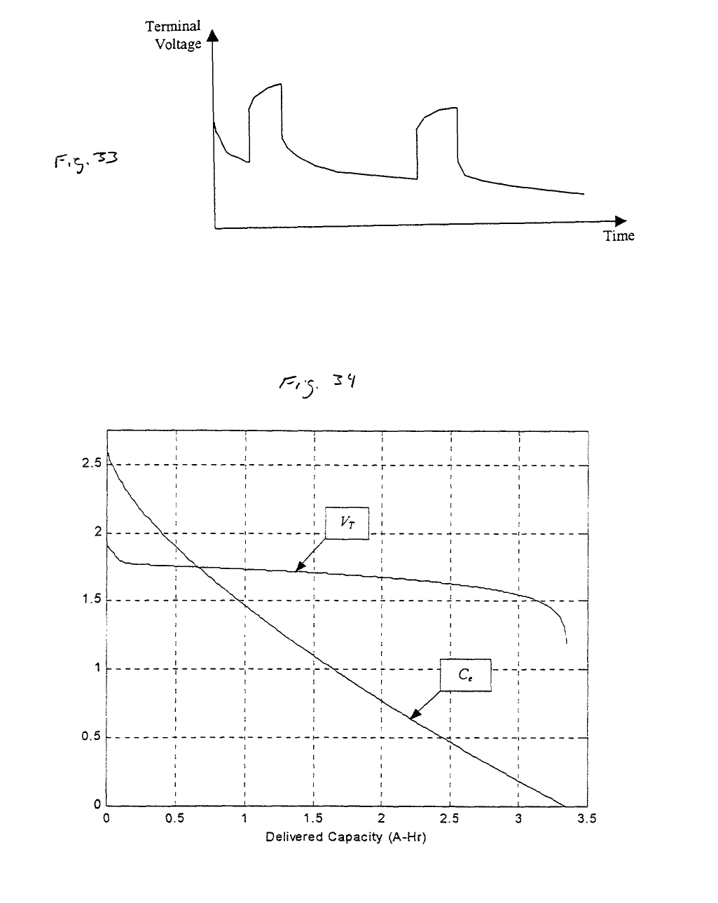

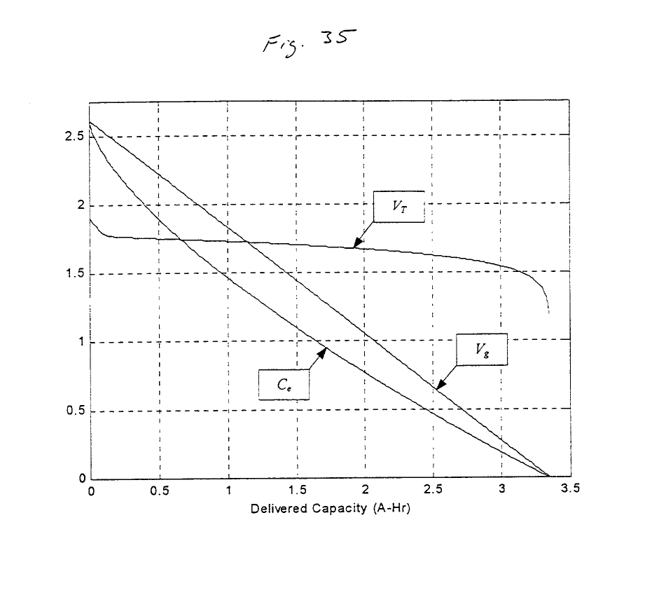

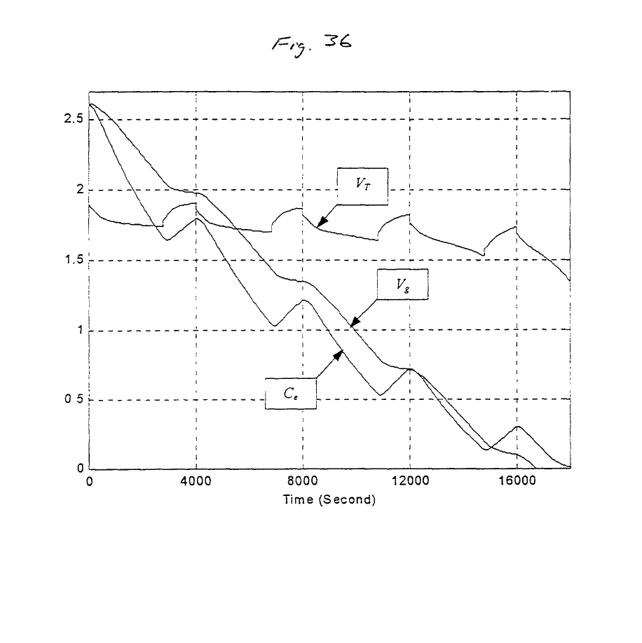

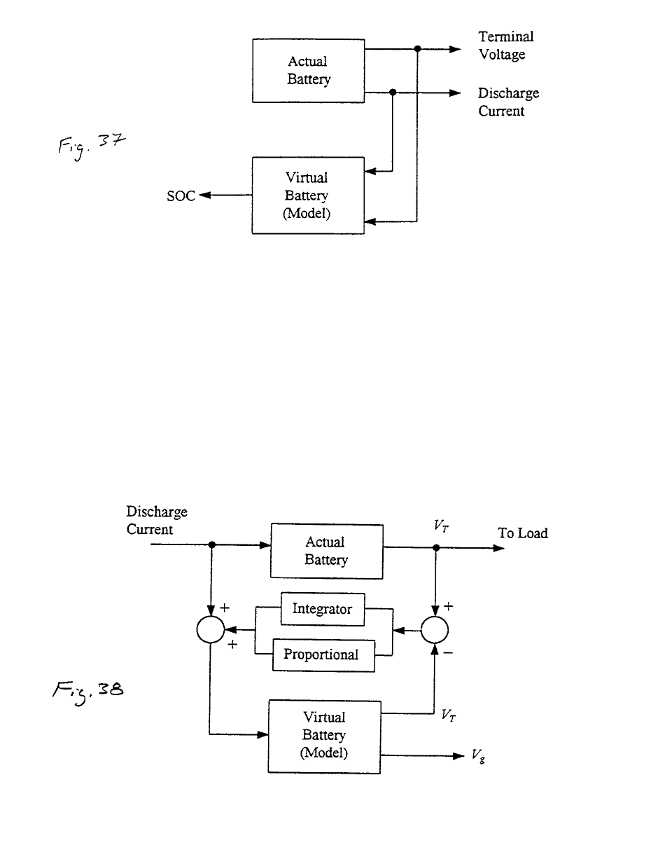

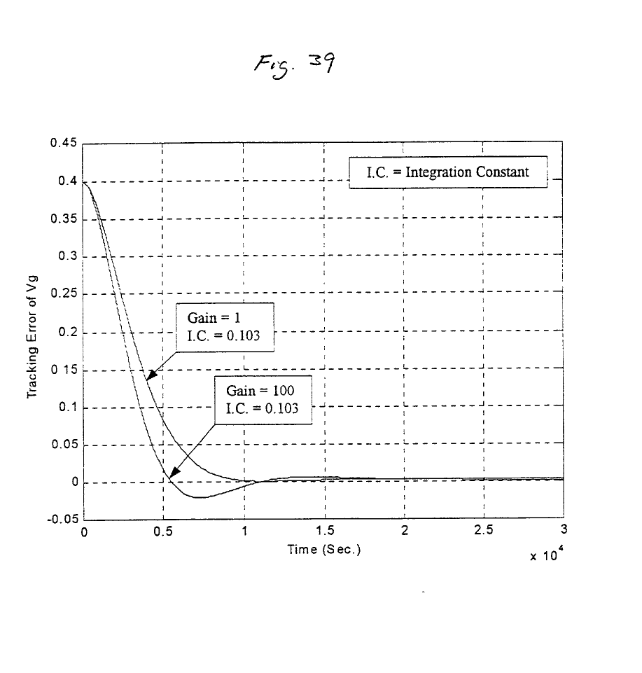

During the simulation of this system, the fractional order functions ofs can be approximated with a transfer function which uses only integer values of s as discussed before. The step responses of the original diffusion process of Equation (57), with charged initial conditions, and the equivalent system made of capacitor C_{g} and impedance H₂(s) are compared in FIG. 29, where the equivalency of the two circuits is clearly demonstrated. The slight discrepancy is due to the fact that in the simulation of the system of Equation (53), the exact solution was used while the solution for the system (FIG. 27) of C_{g} and H₂(s) used an approximate H₂(s) with integer order elements. It is interesting to note the impedance response of the H₂(s), which is the voltage drop, defined as V_{d}, across this impedance. The combined response of the system of FIG. 27 is the response of the capacitor C_{g}, which is a straight line a constant current discharge, subtracting the voltage drop V_{d} of impedance response.

In summary, a diffusion process in a battery which couples energy storage and impedance can be represented by functionally equivalent circuits that have a separate source and impedance.

### Model Applications

The first contribution of this research is to develop a new modeling method for batteries. The validity of the modeling technique and resulting models were verified with several batteries of different chemistry and cell construction, as well as various operating conditions. It was concluded that the new model is an effective representation of a battery's behavior. As the second contribution of this research, the newly developed model is now used to study characteristics of a battery as an electrical device. Through the analysis of device characteristics, performance behavior of a battery can be explained and solutions to practical problems are devised. Most of the applications described herein are first reported and made possible only with the existence of the new model.

The application of the new model to the battery state of charge (SOC) problem will be described. A “virtual battery” concept based on the new battery model is proposed for the SOC problem will be described. Next, the device characteristics of a battery are analyzed using an electrical engineering approach—the impedance analysis. The original nonlinear system of the battery model is linearized, and both the steady-state and dynamic behavior of batteries is analyzed. Applications of the impedance analysis are presented in this section. Further, the new modeling method and device analysis are extended to another galvanic device, namely, the fuel cell. Description of fuel cells and their differences from a battery are discussed. A similar device behavioral model for fuel cells is developed and their behavioral characteristics are analyzed.

### Battery State of Charge

Ever since their invention, batteries have been used in rather primitive ways. When a load calls for energy, the batteries discharge. Little thought is given as to how it should discharge to produce an optimal result such as maximum energy delivery or maximum power output. When a battery's remaining capacity is deemed low, it gets charged, usually at an inconveniently slow rate. When a battery cannot perform its designated function, usually occurring at the moment when its service is needed the most, it is replaced. This primitive mode of utilization has somewhat limited the application of batteries. Therefore, a movement to make a battery “smart,” thanks to the proliferation of intelligent and low-cost electronics, has become very strong recently. The so-called “smart battery” invariably uses the SOC information to make decisions on a battery's operation.

SOC is loosely defined as how much capacity is left in a battery relative to its designed capacity. This feature is important in both discharging and charging of a battery. During battery discharge, SOC can be used to inform a user of how much charge or energy is left in a battery. The practical implementation of this feature for a battery is known as a “gas gauge,” following a familiar concept from automobile usage. The SOC can be interpreted in different ways, however, than the ratio of remaining charge in a battery to its designed capacity. One of these uses the time remaining to completely discharge, also known as time-to-last, for a specific load. Regardless how the SOC is defined, which certainly causes some confusion in practice, the current definition of SOC appears incomplete to accurately represent a battery's function. There are two aspects of a battery's function: charge capacity and deliverable energy. The current definition of battery SOC only deals with the charge capacity. In practice, the energy that can be delivered to a load is probably more important, but none of the current implementations of SOC addresses this aspect of battery function.

### Charge and Energy of Battery

Battery manufacturers use “rated capacity” for this purpose while users are more interested in how muck work, or energy, can be provided by the battery. The basic fact about these “ratings” is that they are obtained under certain operating conditions. Two batteries with the same rating can deliver different amounts of charge and energy depending on the operating condition. A uniform view of a battery's charge and energy can be illustrated with the developed battery model.

Most of the current battery data is the time response of terminal voltage. Using this data, it is difficult to determine the energy that a battery delivers to a load. A better view of charge and energy may be represented by the terminal voltage vs. the charge, as shown in FIG. 31. Production of this type of FIG. is straightforward from the battery terminal voltage information. For constant current discharge and charge, all that is required is to replace the time with charge that is equal to time multiplied by the constant current.

When a battery is charged up, it contains a certain amount of charge at a certain voltage. For example, as shown in FIG. 31, the full charge of a battery is Q_{R} and its open circuit voltage is V_{ocv}. Q_{R} may be used to represent 100 percent of a battery's capacity.

If the battery discharges at an infinitely small current, the terminal voltage of the battery will always be V_{ocv} since there is no loss associated with discharge current and slow process of diffusion. Therefore, the total energy delivered by the battery in this case is V_{ocv} Q_{R}. Graphically, this is the area enclosed by A−V_{ocv}−0−Q_{R}−A. Interestingly, for a capacitor that is charged to a voltage of V_{ocv} with stored charge of Q_{R}, its stored energy is ½V_{ocv}Q_{R}. From this point of view, a battery can store twice as much energy as a capacitor having the same voltage and storing the same charge.

When the discharge current is large, some energy is lost in a battery due to the Ohmic resistance, charge transfer polarization and concentration polarization. At discharge current i₁, for example, the energy delivered by the battery is the area B−0−Q_{R}−B. The energy lost in the battery is the area A−V_{ocv}−0−B−A. At a cut-off voltage V_{off}, there is still some charge and energy left in the battery. For example, if the discharge with i₁ ends at V_{0ff}, there is still Q₁ amount of charge left in the battery. The charge “trapped” in the battery at the end of the discharge is due to the concentration gradient of the active material in the electrolyte, however, some charge may still be recovered by letting the battery rest, which then allows the concentration gradient to equalize. Only when the discharge current is infinitely small can all the charge be delivered. When the discharge current is infinitely small, there is theoretically no concentration gradient for the active materials in the electrolyte, and all the active material can then be converted into electrical charge. The larger the discharge current, the higher the concentration gradient, hence, more charge remains in the battery at the end of the discharge.

There is a similar scenario for the battery charging operation. More energy is required to put the rated charge capacity into the battery to account for the losses during the charge.

Using energy criteria instead of the charge capacity in measuring a battery's performance has several advantages. First, it can be used to compare the true ratings of batteries. Different batteries have different discharge characteristics and ratings tested under different conditions. By subjecting them to the same test conditions and recording the total energy they deliver to a load is a more objective way of rating a battery. Second, any effort in battery usage to improve its performance is aimed to increase the total energy it can deliver to a load. Invariably, this is achieved by modifying characteristics of the terminal voltage during discharge for it to follow as closely as possible the battery OCV.

With this more uniform understanding of battery performance in place, practical ways to determine the SOC of a battery can now be discussed.

### SOC Determination

In the past, there was some effort to determine battery SOC. Several currently used methods to are briefly discussed as follows.

Terminal Voltage Measurement

This is probably the most widely used method for determining the SOC of a battery. It simply measures the terminal voltage during the battery operation. Some algorithm is used to correlate the measured terminal voltage to the amount of charge left in a battery. However, no known algorithm exists for this approach that is accurate enough for any type of battery and arbitrary operating conditions. The difficulty in a good SOC algorithm using the terminal voltage method rises from two areas. First, some batteries have a poor correlation between the terminal voltage and the SOC. This could be caused by the fact that for some batteries; their terminal voltage changes little during the whole discharge range. This situation is illustrated in FIG. 32. It has been reported that SOC based on the terminal voltage often left 40 percent of the usable capacity in a battery when it was decided to turn off. The physical and performance variation of individual batteries also adds to the difficulty in using this method.

Another problem associated with this approach is that under operating conditions other than the constant current discharge, the terminal voltage may not be a good indicator for the battery SOC. For example, a discharge pattern shown in FIG. 33 involves many transient response periods that make the determination of SOC based on the terminal voltage alone very difficult. It is shown that there is almost no corresponding relationship for the terminal voltage to the SOC due to the irregularities introduced by the transient response. In practice, this problem is referred to as “SOC chattering” in that sensing circuit may falsely determine that the SOC is increased because of the increased terminal voltage when actually it is only a reflection of the relaxation process. Therefore, developing an algorithm that can be used for more sophisticated operation becomes essential.

Sometimes, the method of using the terminal voltage for SOC is applied to the OCV instead of the ongoing terminal voltage. This method suffers from the long settling period required for a battery to recover from its previous discharge. Its use is limited to periodic checks of electrical backup batteries to make a “good” or “bad” decision.

Ampere-Hour Measurement

This more sophisticated method records the actual discharge current and time. The product of the two is the ampere-hour capacity that has been delivered by a battery during discharge. Because of high columbic efficiency of most batteries, this method can accurately record the charge information. However, as discussed in the last section, the charge data only is not sufficient to make a shut-off decision. Two batteries at the same SOC can last for a different period of time depending on the future operation performed by the batteries. Thus, the remaining time problem cannot be solved with the ampere-hour recording method alone, and it requires an algorithm to use the SOC of a battery along with its operating conditions. Further, present implementation of this method becomes less and less accurate after repeated discharge and charge cycles because of the shift of battery characteristics. For example, after a period of battery operation involving cycles of discharge and charge, the assumed starting capacity used for the SOC estimate for the next discharge may be far from the initially rated capacity.

Internal Resistance Measurement

This method normally measures the assumed DC resistance of a battery. The assumed DC resistance of a battery with respect to the battery SOC follows the same pattern as the terminal voltage for a constant current discharge. Therefore, the discussion for using the terminal voltage for SOC applies to this method as well. Methods based on the AC impedance method have just appeared recently. It was claimed that this method could be used to determine the health condition as well as the SOC of a battery. While there is not enough information on the practical performance using the AC impedance method, it appears that the principle of this method is sound. Impedance analysis of batteries, and its possible applications in the battery SOC problem, will be discussed later in this paper.

Specific Gravity Measurement

For some batteries, especially the lead-acid battery, the specific gravity of the electrolyte changes with SOC because the electrolyte actually participates in the chemical reactions and its composition changes during battery operation. The specific gravity of the electrolyte and SOC actually have a linear relationship for the lead-acid battery. However, this feature does not hold for most of other types of batteries in general. In addition, implementation of this method is very cumbersome, requiring a sample of the electrolyte from a battery under test. Therefore, the application of this method is limited.

The above discussion indicates that for the very important SOC problem, there does not exist a widely accepted and usable solution. The battery model developed in this study may provide some insights and even offer a solution to this problem. A better solution for battery SOC involves two aspects: a good algorithm that is an accurate refection of battery SOC, and an implementation method that can continuously maintain the accuracy of the algorithm while being implemented. The requirements on the implementation implies that the method should be able to be performed on-line and in real-time. The following describes a new algorithm for battery SOC and a new implementation method. Both utilize the features and capabilities offered by the newly developed battery model.

It is noted that the nonlinearity in the terminal voltage response of a battery, as well as its transient behavior, are the major reasons for the difficulties of the SOC problem. This nonlinearity is mainly caused by the Nernst equation in relating the chemical properties to electrical behavior. Other nonlinear effects are introduced by various polarization relationships. The terminal voltage of a battery can be considered to be a mapping of Cₑ through the Nernst equation to the OCV, less the effects from Ohmic resistance, charge transfer and concentration polarization, and transient response from double-layer capacitor. The logarithmic term in the Nernst relationship

$$E = {E}_{0} + \frac{RT}{n F} ln {C}_{e}$$

effectively attenuates the change of material concentration Cₑ except at a very low value. For a constant current discharge, the response of the effective concentration is:

Cₑ=C₀−Kit_{q}

The response of Cₑ and terminal voltage with respect to the delivered capacity for the generic battery studied earlier is shown in FIG. 34. It is seen from the Fig. that the response of Cₑ has a better-defined relationship with battery capacity than the terminal voltage in that Cₑ is more sensitive than the corresponding terminal voltage V_{T} to a battery's SOC. Defining the sensitivity parameter for Cₑ and V_{T} as:

$${S}_{Ce} = \frac{Δ {C}_{e}}{Δ SOC} and {S}_{VT} = \frac{Δ {V}_{T}}{Δ SOC}$$

Then, the above statement implies S_{Ce}>S_{VT} in the majority of the battery discharge. Therefore, using Cₑ instead of V_{T} can provide better resolution for SOC estimation.

However, there are some inconveniences in using Cₑ to predict SOC. First, the relationship between Cₑ and SOC is not linear. It is not easy to develop an algorithm to accurately relate the Cₑ to the SOC. Equation (66) for the time response of the Cₑ can be rewritten as

$${C}_{e} {C}_{0} - K [ it ] ( {t}^{1 - q} ) = {C}_{0} - {KQ}_{d} {t}^{1 - q} \qquad ( 67 )$$

where Q_{d}=it is the capacity that has been delivered at time t. Therefore, Cₑ is related to the capacity Q_{d} through time involved through the term t^{1-q}. This is not convenient in practical implementation. The second inconvenience in using Cₑ for SOC is that for a more complicated discharge pattern other than constant current discharge, the calculation of Cₑ(t) becomes more difficult, requiring the convolution operation of input signals. This makes the prediction of the remaining time problem more complicated. In determining Cₑ after time t₁, one generally needs the knowledge of all the discharge current before t₁ because the solution of Equation (66) comes from a complicated CPE component. Third, the relaxation response after the discharge current is switched off makes it more difficult to use Cₑ to determine battery SOC.

All these difficulties can be overcome by one of the equivalent variations of the model developed above. In this form of the model, a single capacitor C_{g} is used to represent the energy storage feature of a battery. The voltage at this capacitor, V_{g}, instead of Cₑ, can be used to determine the SOC. For a conventional capacitor with capacitance C_{g} that is initially charged to C₀, the voltage response V_{g}(t) to a continuous discharge current i is:

$${V}_{g} ( t ) = {C}_{0} - \frac{it}{{C}_{g}} \qquad ( 68 )$$

Since Q_{d}=it, the charge that has been delivered at time t, Equation (6.1.3) can be rewritten as

$${V}_{g} ( t ) = {C}_{0} - \frac{{Q}_{d}}{{C}_{g}} \qquad ( 69 )$$

Therefore, the voltage V_{g} is linearly related to the discharged capacity Q_{d}. The response of V_{g} for the generic battery is shown FIG. 35. It is seen from the Fig. that while V_{g} preserves the advantage of high sensitivity by using Cₑ for the SOC estimation, its response is completely linear to SOC. This feature will greatly simplify the algorithm development in practice.

Another advantage of using the energy storage capacitor is that the energy stored in C_{g} at any time can be exclusively determined from a single parameter, namely, the voltage at the capacitor V_{g}. Further, the response of V_{g} after the time t₁ for a constant discharge current i₁ can be determined with the voltage at t₁, V_{g}(t,), and i₁ as:

$${V}_{g} ( t ) = {V}_{g} ( {t}_{1} ) - \frac{{i}_{1} t}{{C}_{g}} for t \geq {t}_{1} \qquad ( 70 )$$

This feature comes as the result of the characteristic of a conventional capacitor. For Cₑ(t), however, it is generally not true that Cₑ(t)=Cₑ(t₁)−Ki₁_{q} for t≧t₁. The correct determination of Cₑ(t), because of the form of time variable tq, needs the discharge current information prior to time t₁, which requires cumbersome convolution terms. The simple relationship of Equation (75) can then be used to predict the time remaining for the discharge current i₁ until the battery reaches a cut-off voltage.

Responses for V_{g} and Cₑ are similar in shape, as can be seen in FIG. 6.1.6, but there is a difference between the two. This difference is the response of the synthesized impedance for the energy storage capacitor when it is separated from the CPE component. The combined response of the V_{g} and this impedance is, of course, the same as Cₑ, as has been shown before, i.e.,

V_{g}(t)=Cₑ(t)−ΔV(t) (71)

where V(t) is the response from the synthesized impedance. The advantage of this configuration is that after the discharge current is shut off, the voltage at the capacitor changes little as the relaxation response almost completely occurs in the synthesized impedance. With the CPE configuration, however, the relaxation response will increase the value of Cₑ. The behavior of both V_{g} and Cₑ under pulsed discharge for the generic battery is shown FIG. 36. It is seen that the relaxation effect of CPE almost completely disappears from V_{g}, since it is now reflected in the relaxation of the synthesized impedance, which goes from a finite voltage drop to zero after the current ceases. Therefore, the equivalent model using the energy storage capacitor C_{g} provides a more realistic interpretation for SOC. The monotonic relationship between V_{g} and the SOC avoids the misinterpretation that the available charge capacity in a battery could be increased without charging because of the increased Cₑ during its relaxation response. Therefore, this method solves the chattering problem of battery SOC.

The remaining time problem for the constant current can be solved using the following algorithm. Using V_{g} for Cₑ, the cut-off voltage and the voltage at C_{g} are:

$$\begin{matrix}{E}_{ocv} = {E}_{0} + 0.052 ln [ {V}_{g} ( t ) ] & ( 72 ) \\ {V}_{off} = {E}_{ocv} - {η}_{ct} - {i}_{1} {R}_{Ω} + h ln [ \frac{{V}_{g} ( t )}{{C}_{0}} ] & ( 73 ) \\ {V}_{g} ( t ) = {V}_{g} ( {t}_{1} ) - \frac{{i}_{1} t}{{C}_{g}} & ( 74 )\end{matrix}$$

where V_{g}(t) is the voltage of C_{g} at the present time. From Equations (72) and (73), the voltage at the energy storage capacitor, V_{goff}, which corresponds to the cut-off voltage V_{off}, can be solved. To illustrate this process, assuming h=0.052, then from Equation (6.1.7) and (6.1.8),

$${V}_{off} = {E}_{0} + 0.052 ln [ {V}_{g} ( t ) ] - {η}_{ct} - {i}_{1} {R}_{Ω} + h ln [ \frac{{V}_{g} ( t )}{{C}_{0}} ] \\ = {E}_{0} - {η}_{ct} - {i}_{1} {R}_{Ω} + 0.052 ln [ \frac{{V}_{g}^{2} ( t )}{{C}_{0}} ] \\ Then \\ {V}_{goff} = {[ {C}_{0} exp ( {V}_{off} - {E}_{0} + {η}_{ct} + {i}_{1} {R}_{Ω} ) / 0.052 ]}^{0.5} \qquad ( 75 )$$

Substituting V_{goff} of Equation (75) into (74) solves for the remaining time t_{off} for the expected discharge current i₁:

$${t}_{off} = [ {V}_{g} ( {t}_{1} ) - {V}_{goff} ] \frac{{C}_{g}}{{i}_{1}} \qquad ( 76 )$$

Application of the SOC determination method described above in practice presents a difficulty in that V_{g} cannot be measured directly. A technique from control theory, namely, the state observer or estimator design can be used to solve this problem. The following is a description of the application of the state observer design to the battery SOC problem.

### A State-Observer Design for Battery SOC

A dynamic system can be represented by a state-space matrix form:

x=Ax+Bu

y=Cx+Du

where x's are the states of system, u is the input and y output; A, B, C, and D are system matrix. The state of the system can be used for control design as in the state feedback control. However, for a practical system, not all the states are measurable entities. In this case, a state observer is used to estimate the internal states of a system from measurable outputs of the system. Details of a state observer design for a linear system are described in Appendix D. The battery SOC determination method described above has a similar situation. There are many advantages in using V_{g} to determine the SOC of a battery, but V_{g} cannot be directly measured. However, V_{g} can be considered as a state of a battery system, thus a state observer can be used to estimate V_{g}, which then can be used to determine the battery SOC.

Using a state observer results in a virtual battery concept as shown in FIG. 37. In this configuration, the measurable battery variables, namely, the terminal voltage and discharge current, are simultaneously fed into a “virtual battery” that, in an ideal situation, behaves in the same way as the actual battery. The implementation of the virtual battery can be an electronic circuit or completely software based. The behavior of the actual battery is reflected in the implementation of the virtual battery. The accuracy or the closeness of the virtual battery response to the actual battery is, of course, dependent on the validity of the model. Using the battery model developed in the paper has several advantages. First, it appears to be reasonably accurate, since it has been verified with the responses of many actual batteries. Second, it is simple, thus, it is easy to implement on-line in real time. This latter point is important in implementing the virtual battery concept in software since the calculation time of the virtual battery response needs to be close to the actual battery response. Compared to the model developed in this paper, the numerical method is ill-fitted for real-time and on-tine implementation because of the complexity and numerical intensity of the latter model.

Using the virtual battery concept, any internal state of the actual battery, including V_{g}, can now be calculated from the virtual battery. The actual implementation of the virtual battery concept is shown in FIG. 38. In this method, only the discharge current, no any other state, is fed into the virtual battery. Since the model cannot be a perfect reflection of the actual battery, the difference between the output of the actual and virtual battery, namely, the terminal voltage, is used as a correction signal to the virtual battery input. This correction signal is modified through a proportional and integral controller, or compensator, and then added to the normal input signal, the discharge current, to be fed into the virtual battery. The state-observer design in this form is called a closed-loop or a tracking observer. The advantage of the tracking observer is that it can tolerate some discrepancies between the model and actual device as well as incorrect selection of the initial condition for the variables in the model. Even under these inevitable imperfections, the tracking observer can still produce the correct response because the difference between the system output of the actual device and model drives the output error to zero.

FIG. 38 shows the simulation results of a virtual battery design for the generic battery used before. For the numerical experiment, the actual battery was also a battery simulation. The initial condition of the voltage at the energy conversion capacitor in the virtual battery is intentionally selected to be 0.4V different from that of the actual battery. The control used for the correction signal is integral-plus-proportional. The result shows that under constant current discharge, the initial error of the system variable is driven to zero, thus, the variable calculated from the virtual battery equals that of the actual device.

This example illustrates the utility of the battery model developed in this paper. It is accurate, thus, it can be used to extract information about the actual battery. It has a compatible format in that the model can be directly plugged into a circuit simulator. It is simple and fast to be implemented with a low-cost microprocessor. These features enable the model to be used to solve the important battery SOC problem. This innovative solution is believed to be better than existing techniques.

### Impedance Analysis of Battery

Techniques based on impedance analysis are an effective tool of describing characteristics of an electrical device. However, little work has been done in this area for batteries, which offers an opportunity to enhance the understanding of a battery.

Impedance analysis is normally performed on two kinds of models from the original nonlinear system: one is the large-perturbation model and the other is the linearized small-signal model. In the large-perturbation model, only the nonlinear relationship of the two-port device in the battery model is linearized and a one-port device model can be obtained. The large-perturbation model is often used to study the steady-state characteristics of the original nonlinear system. For a small-signal model, the system is normally operated at a steady state point. The original nonlinear system is thus linearized around this point. Input signals to the small-signal model are small perturbations to the system. The perturbations may be a small signal to the original system input or an external disturbance to the system. The focus of the small-signal analysis is to investigate the dynamic response of the system at an operating point. The characteristics of the dynamic response can then be used for control design of the system near that single operating point.

### Large-Perturbation One-Port Model

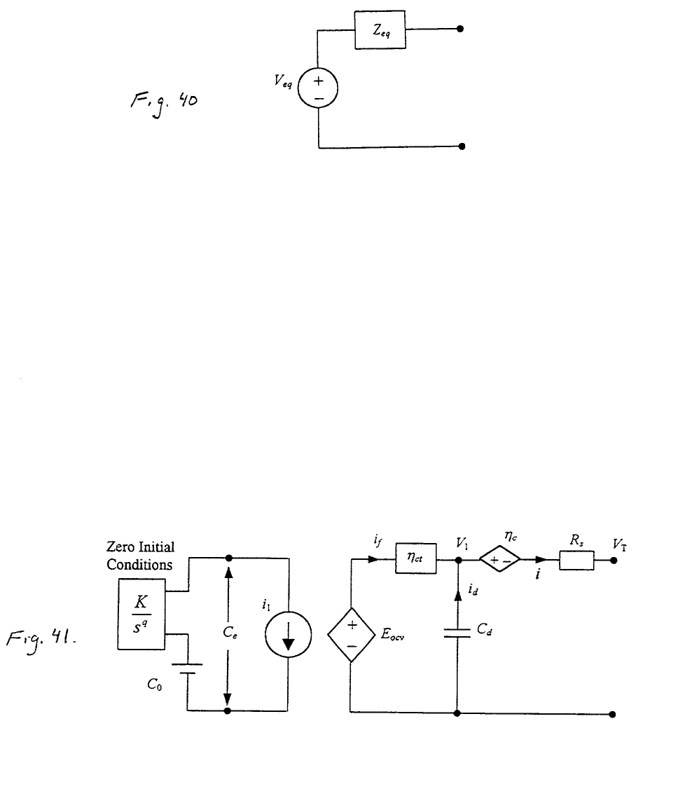

In this analysis, this goal is to obtain a Thevenin equivalent circuit, as shown in FIG. 39. The circuit includes an equivalent source V_{eq} and an equivalent impedance Z_{eq} for the original nonlinear system. Since the Thevenin circuit of FIG. 39 has only one terminal, the two-port device in the developed battery model needs to be eliminated, resulting in an one-port equivalent model. The purpose of the large-perturbation model is to investigate the battery behavior at normal operating conditions, such as a constant current discharge. This is different from a small-signal model where the purpose is to study the dynamic behavior of the battery around a single operating point. The development of the large-perturbation model is described as follows.

One of the equivalent variations of the model described in Section 5.1 uses a separate source and impedance, and is shown in FIG. 41.

The nonlinear components in the battery, according to the new battery model developed in this study, are the Nernst relationship and concentration polarization. Depending on the actual battery response, the charge transfer polarization may also be of the nonlinear Tafel form. These components are expressed with the following equations:

Nernst Equation:

$${E}_{ocv} = {E}_{0} + \frac{RT}{n F} ln {C}_{e} \qquad ( 76 )$$

Concentration polarization:

$${η}_{c} = h ln ( \frac{{C}_{e}}{{C}_{0}} ) \qquad ( 77 )$$

Charge transfer polarization:

η_{ct}=a+b ln(i) (78)

The impedance of the CPE component is

$${Z}_{CPE} = \frac{K}{{s}^{q}} \qquad ( 79 )$$

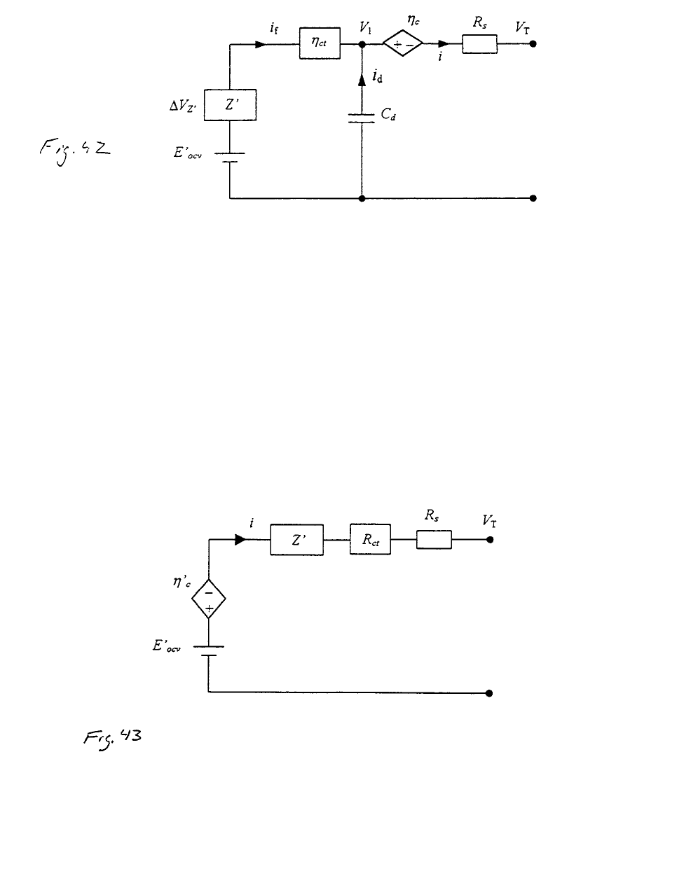

The equation that describes the source characteristic on the chemical side in FIG. 40 is:

Cₑ=C₀−i₁Z_{CPE} (80)

The equations that describes the two-port device are the Nernst equation (76) and Faraday's Law:

i₁=i_{f} (81)

The source subnet relation of Equation (80) should be reflected to the right side of the two-port device to obtain a Thevenin equivalent circuit. This is when the Nenst equation needs to be linearized. Differentiating Equation (76) with respect to Cₑ and evaluating Cₑ at Ĉₑ gives:

$${\frac{ⅆ {E}_{ocv}}{ⅆ {C}_{e}} = ( \frac{RT}{n F} ) \frac{1}{{C}_{e}} \vert}_{{C}_{e} = {\hat{C}}_{e}} = 0.052 \frac{1}{{\hat{C}}_{e}} \qquad ( 82 )$$

Define the conversion constant for the two-port device as:

$$κ = \frac{ⅆ {E}_{ocv}}{ⅆ {C}_{e}} = 0.052 \frac{1}{{\hat{C}}_{e}} \qquad ( 83 )$$

Therefore, if Cₑ, is not far from Cₑ, the Nernst equation (82) can be approximated by:

E_{ocv}=E₀+κĈₑ (84)

Substituting Equation (80) in (84) and using Equation (81) in the result yields:

E_{ocv}=E₀+κ[C₀−i_{f}Z_{CPE}]=(E₀+κC₀)−κi_{f}Z_{CPE} (85)

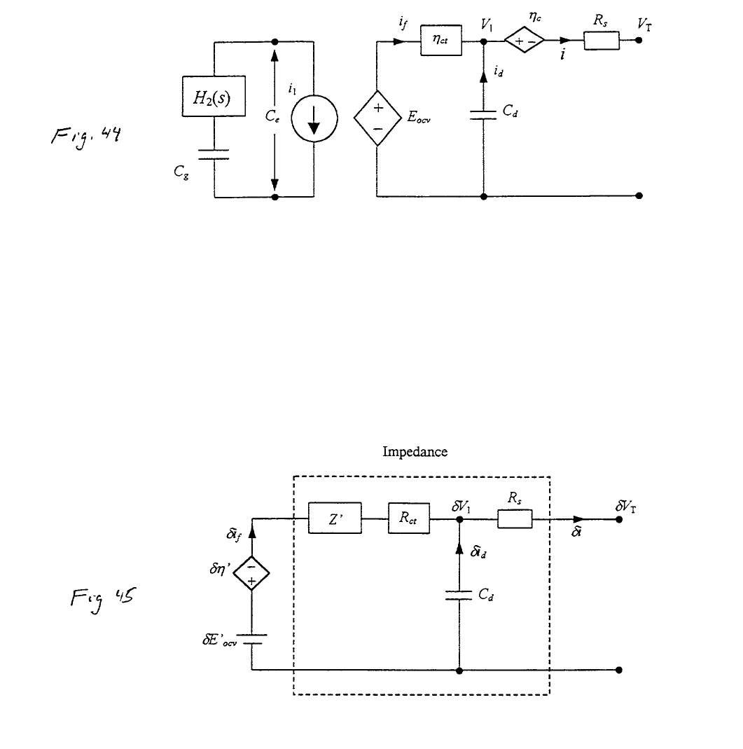

Therefore, the source and impedance on the left side of the two-port device is reflected in the right side of the circuit. The resulting circuit is shown in FIG. 42. The definition of Z′ and E′_{ocv} used in the FIG. 42 are:

E′_{ocv}=E₀+κC₀ (86)

Z′=κZ_{CPE} (87)

The impedance Z′ has some unique features. For a constant DC current, the theoretical impedance of Z′ is infinite, which can be seen from Equation (79) where, when s=0, Z_{CPE}→∞. Therefore, there is no steady-state operation for a battery, and Z′ is always the transient impedance of the battery reflecting the diffusion process. However, the effect of Z′ can be expressed as a function of the state of charge. At different times to a discharge current i, the voltage drop V_{Z′} across Z′ is different. Therefore

$${Z}^{′} ( t ) = \frac{Δ {V}_{{Z}^{′}} ( t )}{i}$$

is a function of time, or the state of charge of battery response.

The rest of components in the battery model of FIG. 41 can be evaluated at the operating conditions. Note that the evaluation of a nonlinear relationship is different from the linearization, since the former applies to the normal operating signal while the latter is only valid to a small-perturbation around the operating point. The concentration polarization of Equation (77) is evaluated at Ĉₑ as:

$${η}_{c}^{′} = h ln ( \frac{{\hat{C}}_{e}}{{C}_{0}} )$$

The concentration polarization is not an impedance in the traditional sense since it does not reflect a voltage-current relationship. It is a voltage drop that is related to the state of charge. Therefore, it is included in the equivalent source portion of the Thevenin circuit.

The charge transfer polarization _{ct} is a function of discharge current in Equation (78). Therefore, for constant discharge current i, the equivalent charge transfer resistance is

$${R}_{ct} = \frac{{η}_{ct}}{i} \qquad ( 89 )$$

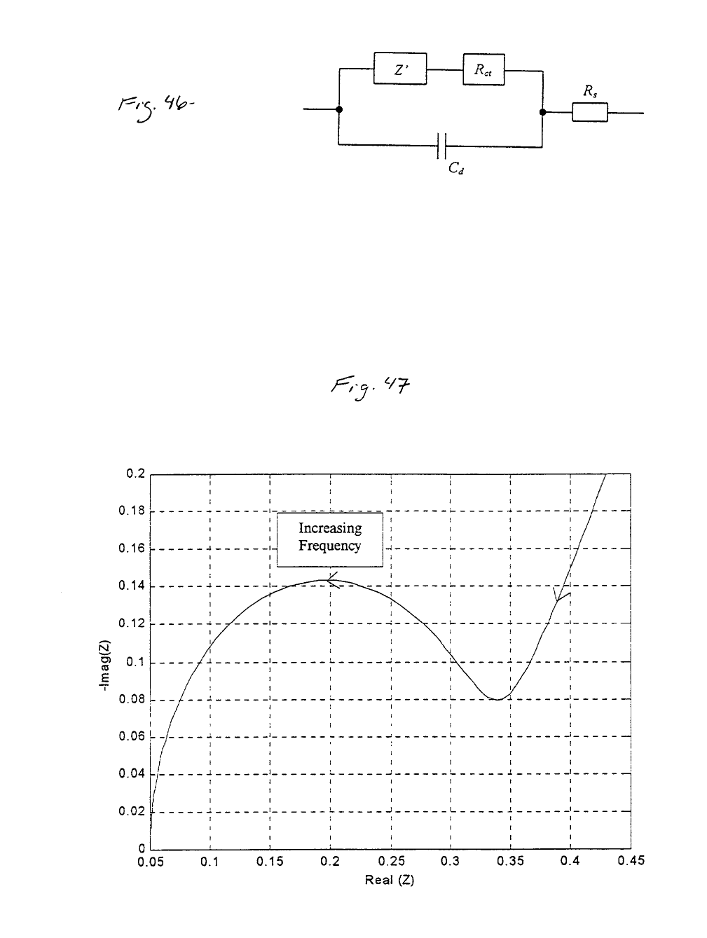

In using the large-perturbation model, the transient response attributed by the double-layer capacitor is not important for the steady-state operation considered here. Therefore, the effect of the double-layer capacitor can be ignored. With this change, the Faradaic current i_{f} becomes the discharge current i, and the circuit of FIG. 42 becomes FIG. 43. Comparing FIG. 43 with FIG. 40, it is seen that the equivalent Thevenin source is:

V_{eq}=E′_{ocv}−η′_{c} (90)

The equivalent Thevenin impedance is:

Z_{eq}=Z′+R_{ct}+Rₛ (91)

Several comments can be made concerning the resulting large-perturbation one-port model. First, the Thevenin equivalent source of Equation (90) is not constant. It is a function of the state of charge, which is a correct reflection of the limited capacity feature of a battery. Secondly, the equivalent impedance of Equation (91) in the Thevenin circuit is not constant either because of the transient impedance nature of the CPE element. The equivalent impedance, due to Z′, is also a function of state of charge. This is the basis of using the DC impedance to determine the battery state of charge. Equations (90) and (91) are quantitative relationships that can be used in algorithms for battery SOC determination.

Another application of the Thevenin equivalent circuit from the large-perturbation model is to determine the maximum power output. A battery delivers maximum power only when the external impedance equals the internal impedance Z_{eq} of the battery. It was shown that the equivalent impedance of a battery is not constant, which varies with the state of charge as well as the discharge current through R_{ct}. Therefore, a switch-mode DC-to-DC converter can be used to match the instantaneous impedance of a battery to the load impedance by continuously adjusting the switch frequency and duty cycle. Again, the result of the above impedance analysis from the model can be used derive the control algorithm of the converter design.

### Small-Signal Model

A small-signal model normally refers to a linearized system that is operated at a steady state point. Dynamic behavior of small perturbations of the system states around the operating point can be studied from the model. A system can often be represented in a state-space form:

x(t)=f[x(t), u(t)] (92)

y(t)=g[x(t), u(t)] (93)

The steady-state operating point for a given input u(t) is solved for x(t) by setting x(t)=0. For a battery, using the model that includes the energy storage capacitor, as shown in FIG. 44, there are two state equations. One is for the double-layer capacitor and the other energy storage capacitor, i.e.,

$$\begin{matrix}{V}_{1} = \frac{1}{{C}_{d}} {i}_{d} & ( 94 ) \\ {V}_{g} = \frac{1}{{C}_{g}} i & ( 95 )\end{matrix}$$

The other equation that is needed for the system realization are the synthesized impedance H₂(s), as discussed above.

Setting Equations (44) and (95) to zero results in i_{d}=0 and i=0. The first result corresponds to zero current in the double-layer capacitor, which is the steady-state condition for a capacity. The second result, i=0, while theoretically correct, represents a trivial condition for the battery operation when there is no discharge current. Also, from the discussion in the last section, the DC impedance of the CPE element is infinite. Therefore, there is no steady-state operating point for a battery during its normal discharge operation. Once again, the reason is due to the limited energy storage capacity of a battery and the transient impedance nature of the CPE element. There is no external energy source to keep a battery operating at a steady-state condition during its discharge condition.

In spite of the difficulty in applying the conventional theory to a normal battery discharge operation, the small-signal model is still meaningful for some applications. First, in the pulsed discharge of a battery, the high-frequency content (pulses) can be considered being superimposed on a DC current. The frequency of the pulses is much higher than that of the base DC current. Therefore, it is valid to consider the DC operation as a steady-state operation and behavior of the high-frequency current can be studied using the small-signal model obtained from the linearization of the original nonlinear model around the DC operating point. Secondly, in measuring the AC impedance of a battery, the external voltage consists of two parts. A DC voltage that is equal in amplitude but opposite in polarity to the terminal voltage of the battery nullifies the normal discharge of the battery. A small AC current signal is then injected into the battery to observe the response of the battery. In this case, the normal discharge current i is indeed zero, but it still represents a valid operating point since the battery is essentially operated in the charge mode. The external energy maintains the steady-state condition of the battery.

Development of the small-signal model for a battery starts with the linearization of the Nernst equation. The resulting CPE impedance is reflected to the right-side of the two-port device in the same way as before, i.e.,

Z′=κZ_{CPE} (96)

The double-layer capacitor needs to be included in the model since its dynamic response is of major interest for small-signal analysis. The concentration polarization needs to be linearized with respect to Cₑ, i.e., from Equation (77):

$${{η}_{c}^{′} = h \frac{1}{{C}_{e}} \vert}_{{C}_{e} = {\hat{C}}_{e}} = h \frac{1}{{\hat{C}}_{e}} \qquad ( 97 )$$

The charge transfer polarization of Equation (78) can also be linearized with respect to discharge current i. This results in a charge transfer resistance R_{ct} for the discharge current close to î as:

$${{R}_{ct} = b \frac{1}{i} \vert}_{i = \hat{i}} = b \frac{1}{\hat{i}} \qquad ( 98 )$$

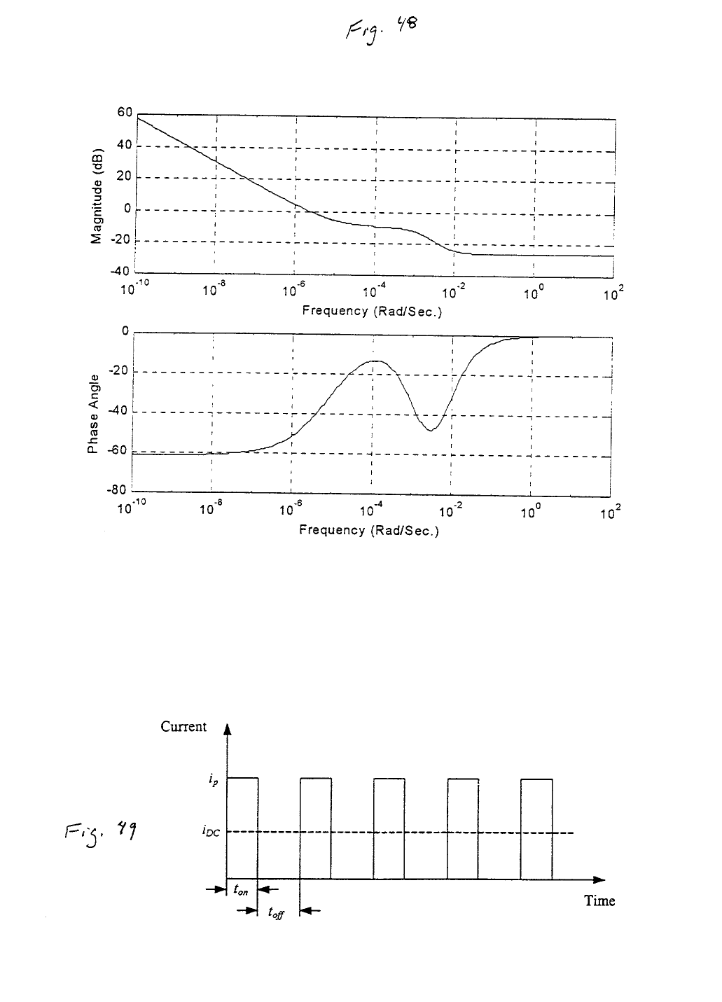

Using these linearized relationships, the small-signal model for the battery is obtained, which is shown in FIG. 45. The “ ” operator in each variable represents a small perturbation.

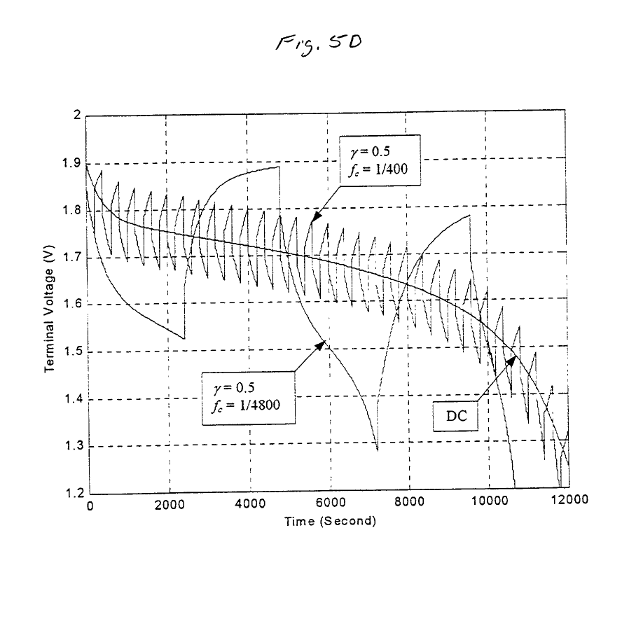

Analysis of small-signal model is conducted through the impedance to the equivalent source. When looking from the source (zeroing the source), the equivalent impedance for the small-signal model is shown in FIG. 46. It is reassuring to observe that this form is easily recognized to the equivalent to a Randles circuit. It is believe that the derivation of this circuit from the battery model is first reported herein.

The transfer function for the impedance shown in FIG. 46 is:

$$Z ( s ) \frac{{Z}^{′} + {R}_{ct}}{{sC}_{d} ( {Z}^{′} + {R}_{ct} )} + {R}_{s} \qquad ( 99 )$$

where Z′ is defined as before as

$${Z}^{′} = κ \frac{K}{{s}^{q}} .$$

The frequency response for the impedance of Equation (99) for the generic battery studied before is shown in FIG. 47. The Nernst equation is linearized at Cₑ=1.80. Thus, from Equation (83), the conversion constant is

$$κ = \frac{0.052}{1.90} = 0.029 .$$

. The impedance Z′, using and CPE component determined before, is

$${Z}^{′} = 0.029 \frac{1}{227.5 {s}^{0.68}} .$$

. The charge transfer polarization resistance R_{ct} is linearized at i=0.1 A. Thus, from Equations (98) and (44),

$${R}_{ct} = b \frac{1}{i} {\vert}_{i = \hat{i}} = \frac{0.028}{0.1} = 0.28 Ω .$$

The Ohmic resistance Rₛ was determined in Parameter Identification discussion to be 0.05. The frequency range shown in FIG. 47 is from 10⁻⁴ to 10² rad./sec.

The impedance Z(s) of Equation (92) consists of a real part and an imaginary part, i.e.,

Z(jω)=Zᵣₑ(jω)+jZᵢₘ(jω)

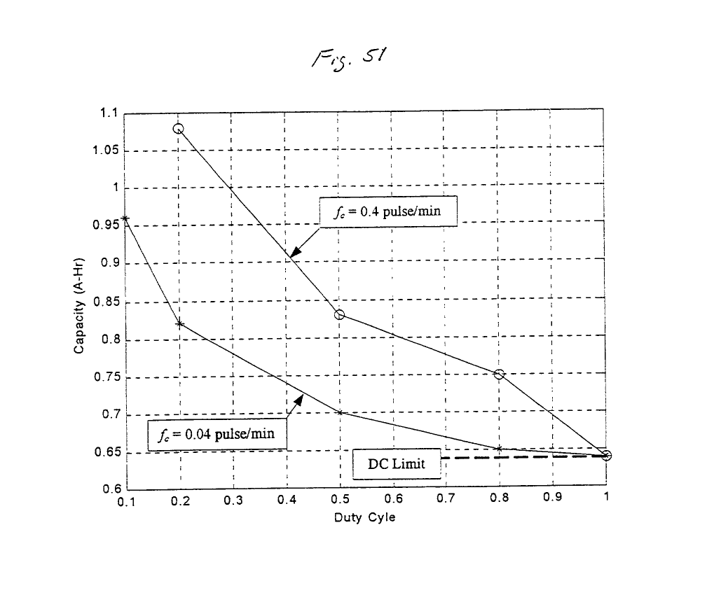

Plot shown in FIG. 42 is actually −Zᵢₘ(jω) vs. Zᵣₑ(jω), a practice commonly used in electrochemical studies. A more conventional representation, namely, the Bode plot, is shown in FIG. 48 for the frequency response of magnitude and phase angle of the impedance Z(s).

The characteristic of the small-signal impedance is analyzed as follows. At higher frequencies shown by the semi-cycle in the impedance response of FIG. 47, the imaginaiy component of the impedance comes solely from the double-layer capacitor C_{d}. Its contribution falls to zero at high frequencies because it offers no impedance. The only impedance the current sees is the Ohmic resistance. As frequency drops, the finite impedance of C_{d} manifests itself as a significant Zm. At very low frequencies, the capacitance of C_{d} offers a high impedance, and hence current passes mostly through R_{ct} and Rₛ. Thus the imaginary impedance component falls off again. The effect of the CPE element through Z′ is dominant at low frequencies. The angle between the impedance line of Z′ and real axis is 900°xq, where q is the fractional power in the CPE component. For the generic battery q=0.68, thus the angle is 61.2°, which is shown in the FIG.

The frequency response for the impedance in a small-signal model is typical for any type of battery. The knowledge of the characteristic of the small-signal impedance can be used to better utilize a battery. Two examples are considered below.

### Pulsed Discharge

It has long been known that the pulsed discharge pattern can deliver more total charge than a continuous discharge. What has not been considered was the quantitative description of this phenomenon. With the small-signal model developed above, this quantitative effect on the charge and energy delivered by a battery can be made clear.

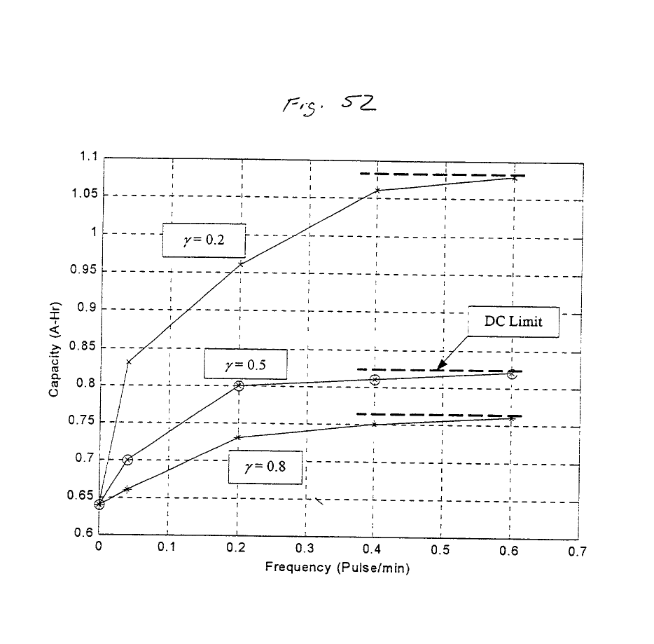

A pulsed discharge current, as shown in FIG. 49, can be considered to be made of two parts: a DC current i_{DC} that is the avenge of the periodic current and an AC current i_{AC}, whose average is zero, that is superimposed on i_{DC}. The duty cycle and frequency of the pulsed current were defined before, which are repeated here:

$$Duty cycle : γ = \frac{{t}_{on}}{{t}_{on} + {t}_{off}}$$

$$Frequency : {f}_{c} = \frac{1}{{t}_{on} + {t}_{off}}$$

The response of a battery to the DC portion of the pulsed discharge is the same as the constant current discharge, which has been considered extensively before. One important feature about DC current response is that it represents the maximum energy that can be delivered, regardless of the shape of actual discharge current pattern. In another words, a pulsed discharge current with an avenge value i_{DC} delivers less total energy than a pure DC current whose value is i_{DC}. This is because, for a pulsed current, it not only has normal loss associated with the DC current, it incurs more loss through its AC content. This situation is clearly shown in FIG. 50. In this simulation, all three discharge patterns have the same average DC current i_{DC}. Therefore, for the pulsed discharge with 50% duty cycle, its peak current is twice as large as i_{DC}, i.e., iₚ=2i_{DC}. For the discharge with shorter frequency f_{c}=1/4800 Hz, it has longer discharge time for each “ON” period. The total energy delivered by this discharge pattern is smaller than the pulsed discharge with higher frequency f_{c}=1/400 Hz. With increasing discharge frequency, the total delivered energy by pulsed discharge approaches to the energy delivered by the DC current with amplitude i_{DC}. This simulation is done to the generic battery studied before.

Therefore, a clarification needs to be made concerning the comparison of continuous and pulsed discharge which says that a pulsed discharge delivers more energy than a continuous discharge. In this statement, it is not that the two discharge patterns with the same average current are compared. Instead, it is a continuous discharge current whose value is the peak value of the pulsed current as compared with the latter. Therefore, this comparison, which is widely referred to in practice and in literature, is not valid or fair from a system loading point of view, because the two patterns have different avenge discharge currents. The application of pulsed discharge, however, is still meaningful. By using the pulsed current with a higher peak value, the instantaneous power during the “ON” period is larger than the average DC current can provide. If a DC current with same peak value of pulsed discharge is used to obtain the same power output, a larger battery is probably needed.

For a pulsed discharge with fixed duty cycle, the higher its frequency, the smaller is the impedance, as has been seen from the small-signal model analysis; hence the less the losses for the AC content. However, the average DC current sets the lower limit of total energy loss. No increase of frequency can make the total loss of the system go below this llinit. If the frequency of the pulsed discharge is fixed, the smaller the duty cycle, the lower the average DC current, thus, the maximum energy that can be delivered is increased.

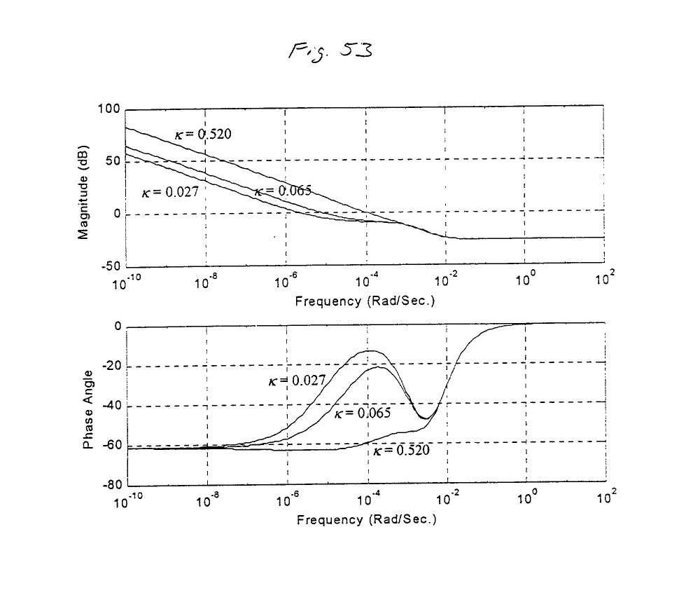

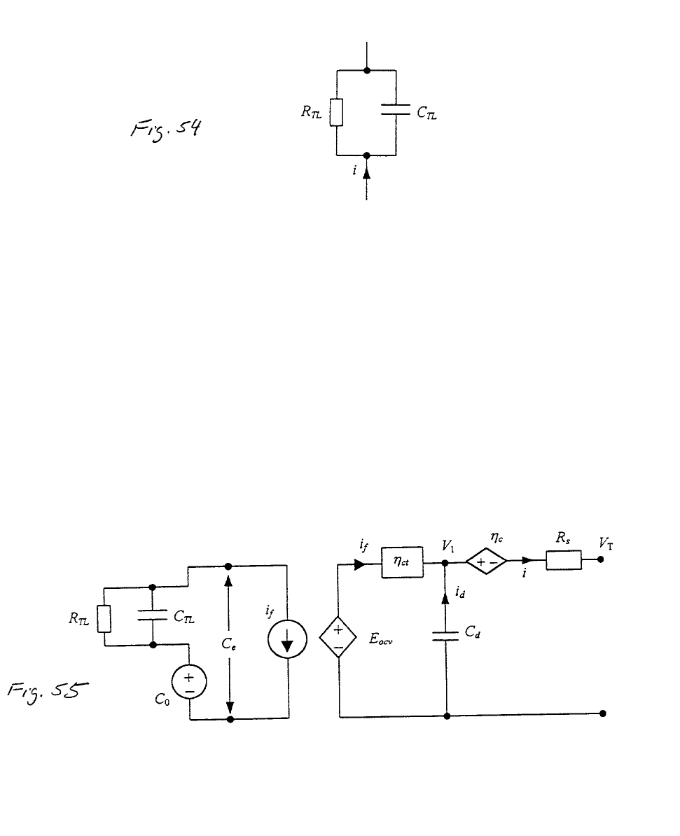

These conclusions were observed during the validation of the model with actual response data. The quantitative value of the impedance can be calculated from the small-signal model developed in this section. Simulation results for the effect of duty cycle on the delivered charge at various frequencies of pulsed discharge for the alkaline battery studied before are shown in FIG. 51, where it is clear that pulsed discharge with a lower duty cycle increases the total delivered charge. A simulation showing the effect of the frequency on the delivered charge at different duty cycles is included in FIG. 52, where it is shown that the total delivered charge approaches the limit determined by the avenge DC current.

### Battery Health Monitoring and Failure Prediction

A battery is usually the weak link in battery-powered traction or battery back-up emergency systems. In the latter case, batteries are used in processing plants, power plants, telecommunications and many other places. The battery is typically the last line of defense against a total shutdown during a power outage.

The commonly used procedure to determine battery and cell health is to perform a load test as defined in IEEE 450 practice. In this method, a resistor bank is used to dissipate the energy discharged by a battery. Under load, cell voltage will decay at a rate proportional to the cell's health condition. Weaker cells show early signs of voltage decay and at a greater rate. The voltage decay characteristic correlates quite well with expected performance. The disadvantage of the load test, however, is that it is labor intensive and cannot be performed on-line. Consequently, the test is infrequently performed in practice, which is evidenced by the IEEE 450 requirement that up to five years can elapse between two checks.

The terminal voltage response of a battery is determined by its impedance. Therefore, a better method to determine battery health is to monitor the impedance of the battery. The DC impedance method should be avoided for this purpose since it requires a significant discharge from the battery in order to obtain repeatable readings. This results in a long measurement cycle and may disturb the normal use of a battery, which restricts its use in on-line monitoring. The AC impedance measurement is a better method for battery health monitoring. A small AC signal is injected into the battery or placed on the normal discharge current. Therefore, this method can be performed on-line without taking out the battery from its service or disturbing its normal usage.

From the small-signal model, it is seen that the AC impedance of a battery is attributed to four components: Z′, C_{d}, R_{ct} and Rₛ. At different frequencies, these components manifest themselves with different magnitudes. At low frequency, the effect of Z′ is dominant. Not only the measurement of Z′ can be used to determine the health condition of the diffusion process of a battery, it can also be used to determine the state of the charge. The conversion constant

$$κ = \frac{ⅆ {E}_{ocv}}{ⅆ {C}_{e}} = 0.052 \frac{1}{{\hat{C}}_{e}} \qquad ( 100 )$$

in Z′ is related to the Cₑ, which is an indicator of SOC. The frequency response of Z′ as a function of, which is obtained at different operating points of Cₑ is shown in FIG. 53 for the generic battery. Therefore, if the impedance of

$${Z}_{CPE} = \frac{K}{{s}^{q}}$$

is known from the battery model at a certain frequency and Z′ is measured from an actual battery, the conversion constant can be calculated from:

$$κ = \frac{{Z}^{′}}{{Z}_{CPE}} \qquad ( 101 )$$

From, Cₑ can be determined from Equation (6.2.17) and used for determining SOC. On the other hand, if is known for an operating point, a measurement of Z′ will give the impedance of Z_{CPE} from Equation (101). Z_{CPE} can then be compared with its expected value calculated from the model to determine the health status of the diffusion process of a battery.

At higher frequency, the effect of Z′ diminishes. Therefore, the AC impedance is completely determined by C_{d}, R_{ct} and Rₛ, whose values do not vary with SOC. Thus, the AC impedance measured at higher frequency bypasses the effect of the Z′. The Battery health condition attributed to the components other than the diffusion process can then be determined with a higher frequency AC signal by comparing the measured impedance with its expected value. The impedance for C_{d}, R_{ct} and Rₛ only is:

$$Z ( s ) = \frac{{R}_{ct}}{s {C}_{d} {R}_{ct} + 1} \qquad ( 102 )$$

The frequency response of Equation (102) is the semi-cycle region of the FIG. 47.

In summary, AC impedance measurement can be used for battery SOC and health condition monitoring. The battery SOC and health condition of the diffusion process can be determined from the impedance at a low frequency AC signal. The health condition of a battery due to the other processes can be determined from the impedance of a higher frequency AC signal.

### Fuel Cells

A fuel cell is another important type of galvanic device whose application is considered to be more promising in the automobile and the electric generation industry. The similarities and major differences between a fuel cell and a battery are compared herein. Previous results obtained for batteries are applied to fuel cells. As in the battery study, the construction and design of a fuel cell are not the major concern; instead, its behavioral characteristics are the focus of this study.

Fuel cells have many inherent advantages over gasoline engines. The theoretical energy conversion efficiencies of 80 percent are not uncommon for fuel cells. This compares favorably to normally 30 percent conversion efficiency for the heat engines, which are limited by the Carnot cycle. A fuel cell does not have any moving part, thus it has a long mechanical life and high operating reliability. A fuel cell does not generate any air pollution at the point of use.

The basic electrochemical reaction in a fuel cell is the oxidization and reduction (redox) processes of hydrogen and oxygen. In these reactions, hydrogen is oxidized at the anode to water and gives up electrons. Oxygen is reduced at the cathode by receiving electrons. These basic processes can be expressed by:

At anode: 2H₂ (gas)+4OH→2H₂O+4e

At cathode: O₂ (gas)+2H₂O+4e→4OH

The overall reaction of the cell is:

2H₂ (gas)+O₂→2H₂O

Other types of fuels such as methanol (CH₃OH), ethanol (C₂H₅OH) and hydrocarbons such as ethylene (C₂H₄), and propane (C₃H₈), etc., can also be used instead of hydrogen. Two methods of using these alternative fuels are possible. One is to first extract hydrogen from the alternative fuels through a device known as the fuel reformer. The generated hydrogen is then used as fuel in the cell reactions as described above. The other method is to directly oxidize the alternative fuels. In this case, the reaction products also include carbon dioxide (CO₂), in addition to water. The electrolyte can be either acidic or caustic, and be aqueous or solid state such as a polymer membrane. The greatest challenge in the chemical reactions of a fuel cell is to increase the current rate for practical applications. This is usually achieved by using a reaction catalyst or operating the fuel cell at an elevated temperature. Impurities in fuels can chemically poison the electrode materials; therefore high-purity fuels and special electrode materials are often used to minimize the chemical poisoning. Minimizing the losses associated with the electrochemical processes of a fuel cell so that it can approach the theoretical efficiency is also a major research area. Those are the challenges faced in the design of a fuel cell.

The most distinct difference between a fuel cell and a battery is that fuels are stored outside the fuel cell itself and continuously supplied to the reaction chamber. The electrical potential of a fuel cell is not established by the electrodes and the electrolyte of the cell, but rather by the chemical reactions of the fuels. The electrodes in this case are merely reaction sites for other active materials. In fact, the same material is used for both electrodes in a fuel cell, thus no electrical potential exists without fuels. In this sense, a fuel cell is more of a convener or a continuous battery, similar to an internal combustion engine. This property makes it possible for a fuel cell to have a high power and energy density, thus overcoming one of the most serious drawbacks of batteries.

Tremendous amounts of effort have been directed to fuel cell modeling. As for the batteries, most of the existing fuel cell models use the numerical method and some are empirical in nature. Application of a physics-based model, as developed for batteries in this study, to fuel cells is thus a positive contribution for fuel cell researches. The resulting model for fuel cells can improve the understanding of fuel cells behavior and be used to enhance its utilization.

### Behavioral Model of Fuel Cells

Application of the modeling method developed for batteries in this study to a behavioral model for fuel cells can be best implemented by starting with the battery model of FIG. 41. All the essential physical processes in a battery also apply to a fuel cell. The justifications of consolidating individual processes into lumped-parameter components in the model are also valid for fuel cells. Therefore, the basic structure of the model for a fuel cell is the same as the one for a battery. However, several modifications need to be made for some specific components in the model due to the differences of the processes these components represent between a fuel cell and a battery.

First, the energy source on the chemical side for a fuel cell is the fuels, supplied externally, that can be independently controlled. This opens up several important control problems that will be discussed later in this section. Secondly, the diffusion process in a fuel cell is very different from that of a battery. In the latter case, the diffusion process is represented by a CPE in the newly developed model. The CPE has an infinite DC gain. For a fuel cell, however, experimental results have shown that the DC gain of the diffusion processes is finite; thus, a fuel cell can operate at a true steady-state condition. In one fuel cell, the time to reach the steady-state operation was experimentally tested to be 2 to 3 seconds at certain current rate. A possible physical reason for this phenomenon may be that for a battery, the electrolyte not only supports the mass transport, it also stores the charge of the battery. Therefore, the physical size, or the volume, of the electrolyte needs to be relatively large to store the charge. This property validates the assumption of a semi-infinite diffusion process used in the battery model. For a fuel cell, the electrolyte only functions as a current conduction media, albeit also mainly through diffusion processes, between the two electrodes. Its physical size is designed to be very thin, enough to provide electrical insulation between the electrodes and no more; thus the semi-infinite assumption is probably not valid for the diffusion processes of a fuel cell. Examination of physical design parameters of various fuel cells and batteries has confirmed this statement.

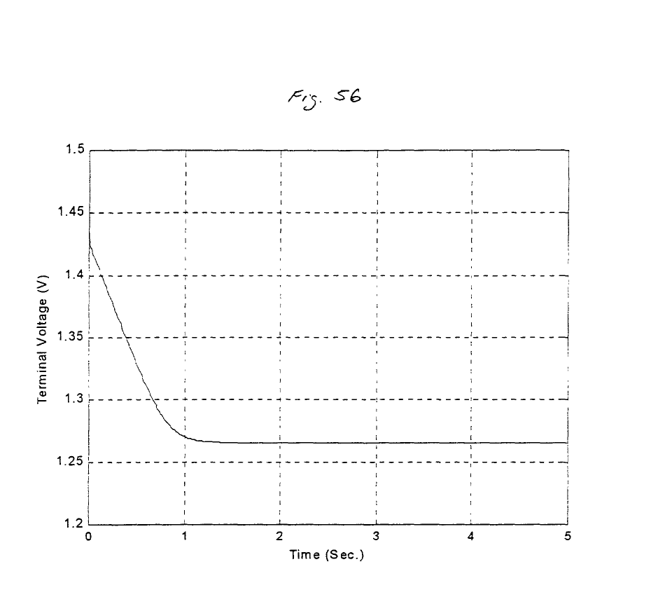

The above discussion implies that the component representing the diffusion processes in a fuel cell model needs to reflect the transient response as well as the nature of a finite DC gain. A finite-order R-C network model can be used for this purpose. In fact, assuming the DC gain of a diffusion process is R_{TL} and the settling time to the steady-state operation is tₛ, a simple R-C network, shown in FIG. 54, where

$${C}_{TL} = \frac{{t}_{s}}{{R}_{TL}} ,$$

is a good representation of the diffusion process. More segments of the R-C ladder element can be added to refine the accuracy of the dynamics of the transient response.

The third change that needs to the made to a fuel cell model is the expression of the concentration polarization. Since in many cases, a fuel cell is operated at a steady-state condition, the effective concentration of active material at the electrode (Cₑ) is also at a steady state. Traditionally, the concentration polarization for a fuel cell is expressed in term of the discharge current. It is known that Cₑ and discharge current i are related though:

$$\frac{{C}_{e}}{{C}_{0}} = 1 - \frac{i}{{i}_{l}} \qquad ( 103 )$$

where i₁ is the limiting current dependent on the diffusion process of a fuel cell. Therefore, the concentration polarization for a fuel cell can be expressed by:

$${η}_{c} = h ln [ 1 - \frac{i}{{i}_{l}} ] \qquad ( 104 )$$

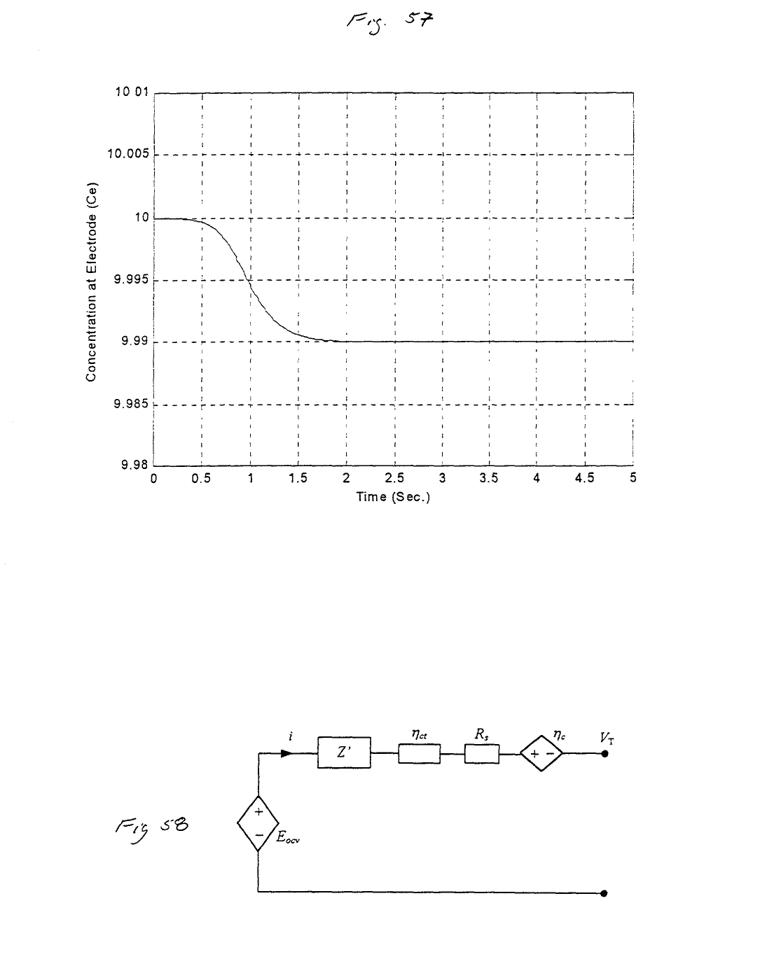

With these modifications, a behavioral model for a fuel cell is shown in FIG. 55. The energy source is now represented by an independent voltage source C₀, which is the concentration of supplied fuel in this model.

The above model is simulated with values for practical fuel cells:

Concentration of fuel:

C₀=10

Diffusion process:

R_{TL}=0.001 Ω, C_{TL}=200 F

Nernst equation:

E_{OCV}=1.4+0.0521 ln Cₑ (105)

Charge transfer polarization:

η_{ct}=a+b ln(i_{f})=0.1+0.026 ln(i_{f}) (106)

Ohmic resistance:

Rₛ=0.002 Ω

Double-layer capacitor:

C_{d}=50 F

Concentration polarization:

$${η}_{c} = h ln [ 1 - \frac{i}{{i}_{l}} ] = 0.06 ln [ 1 - \frac{i}{100} ] \qquad ( 107 )$$

Discharge current:

i=10 A

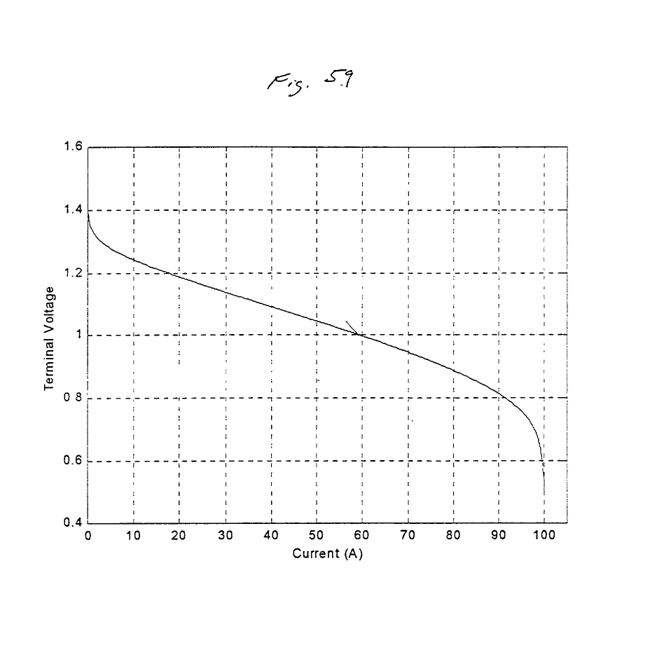

The terminal voltage response of the above fuel cell is shown in FIG. 56. The simulation result is representative of the response of practical fuel cells. An important result of the simulation is the response of Cₑ, which, determined by the diffusion process components in the model, reaches a steady-state value, as shown in FIG. 57.

The dynamic equations for the fuel cell model of FIG. 55 are:

$$\begin{matrix}{\dot{C}}_{e} = \frac{{i}_{f}}{{C}_{TL}} - \frac{1}{{C}_{TL} {R}_{TL}} ( {C}_{0} - {C}_{e} ) & ( 108 ) \\ {\dot{V}}_{1} = \frac{1}{{C}_{d}} ( i - {i}_{f} ) & ( 109 )\end{matrix}$$

These equations, combined with the Equations (105), (106) and (107), form the nonlinear model for the fuel cell. Now, the same methods of analyzing battery characteristics can be used for fuel cells. The following is an analysis of the steady state and dynamic behavior of fuel cells.

### Steady-State Analysis of Fuel Cells

As opposed to a battery, a fuel cell can operate at a steady-state condition, provided the load and fuel supply remain constant. For steady-state analysis of a fuel cell, the effect of the double-layer capacitor and the capacitor in the diffusion process model are ignored as they become open circuit. Therefore, for the fuel cell model of FIG. 55, the impedance from the diffusion process is simply the resistor R_{TL}. This impedance needs to be reflected to the electrical side of the two-port device through:

Z′=κR_{TL}

where is the conversion coefficient defined by Equation (83), which is repeated here:

$$κ = \frac{ⅆ {E}_{ocv}}{ⅆ {C}_{e}} = 0.052 \frac{1}{{\hat{C}}_{e}}$$

The steady-state of Cₑ can now be calculated from the relationship:

$${R}_{TL} = \frac{{C}_{0} - {\hat{C}}_{e}}{i} as \\ {\hat{C}}_{e} - {C}_{0} - {iR}_{TL} \qquad ( 110 )$$

where Ĉₑ is the steady-state value of Cₑ.

The steady-state operation of the fuel cell can be represented by the model of FIG. 58. E_{ocv} in the model is calculated from Equation (105) with Cₑ evaluated at Ĉₑ from Equation (110).

The equivalent source of the steady-state model of the fuel cell is V_{eq}=E_{ocv} and the equivalent impedance is Z_{eq}=z′+_{ct}+Rₛ+_{c}. The terminal voltage is then V_{T}=V_{eq}−iZ_{eq}, where i is the operating current. Since a fuel cell is an electrical source, its characteristic can be represented by a source characteristic relationship between the terminal voltage and operating current. This relationship is shown in FIG. 59 for die fuel cell modeled above.

The voltage drop in the low current range of the source characteristics is mainly due to the charge transfer polarization and the voltage drop in the high current range is due to the concentration polarization. The source characteristics of a power source component, such as a fuel cell, can be used in system design by correctly sizing the source and the load. Simulation results of many existing models for fuel cells are similar to the response shown in FIG. 59. In other words, the behavior predicted by existing models did not appear beyond the static operation of a fuel cell. Many of these models used empirical relationships to fit the experimental data. In comparison, the result shown in FIG. 59 comes from a physics-based model following widely accepted electrical engineering techniques.

In the above analysis, the input fuel concentration C₀ is the only controlling variable for the OCV of the cell. However, for practical fuel cells, many other factors affect the OCV. These factors include the pressure and flow rate of fuel gas, concentration of electrolyte, percentage of fuel mix, type of the fuel, and operating temperature, etc. However, there are few published results, thus no widely accepted theoretical conclusion, to quantitatively relate these factors to the electrical behavior of a fuel cell. Experiments conducted in this area are still considered as trade secrets in much of the fuel cell development. It is believed that the effects of these variables are best reflected in the Nernst relationship that relates the physiochemical parameters to the OCV of the fuel cell.

In the next study, the pressure of the input fuel gas is also considered to be a controlling variable in addition to the fuel concentration. The fuel pressure is introduced into the Nernst equation through a simple term as:

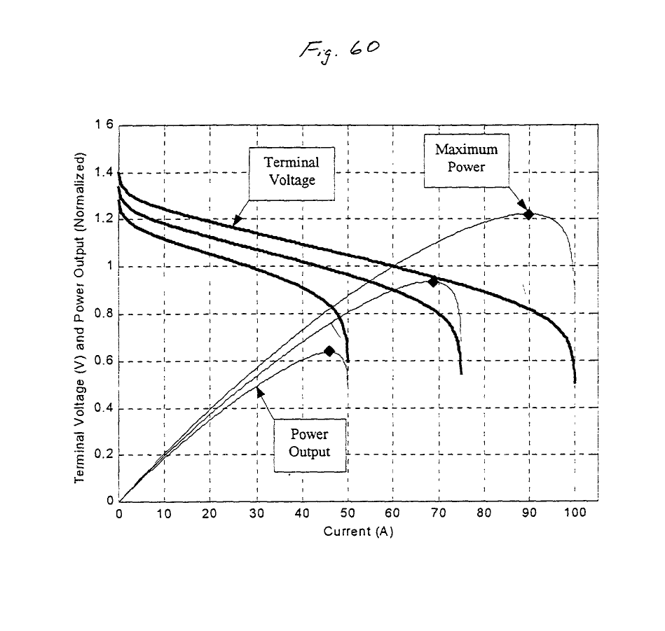

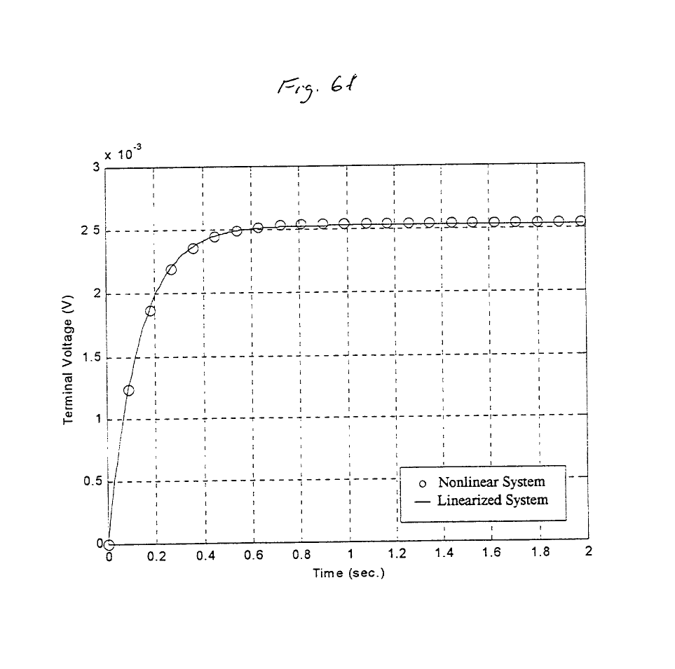

E_{ocv}=1.4+0.052(2p₀)ln Cₑ (111)

where p₀ is the pressure of fuel gas. Note that this relationship is not theoretically derived and experimentally verified, but it does reflect the behavior of the terminal voltage response to the fuel pressure change. With the new Nernst relationship, the source characteristic of the fuel cell is now a function of the operating current as well as the fuel pressure with constant fuel concentration. The result of the source characteristic of this fuel cell is shown FIG. 60. A series of source characteristic curves correspond to the different fuel pressures.

An important application of the steady-state analysis of fuel cells is the maximum power output problem. Generally, it is desirable to have a fuel cell operate at its maximum output power. The power output of a fuel cell is P=V_{T}x i, which is also shown in FIG. 60. Because of the source characteristics of the fuel cell, there is a maximum power output point at a certain current for each fuel pressure. The maximum power output problem is to operate the fuel cell at the maximum power output point for the corresponding fuel input at different pressures The control problem for the maximum power output has been solved for photovoltaic (solar) cells and windmills. While the solutions to this problem for other devices can be adopted, the formulation of the problem and associated model for fuel cells is first proposed in this paper.

The above is an analysis for the steady-state behavior of a fuel cell. The dynamic behavior of a fuel cell is analyzed in the following section.

### Dynamic Analysis of Fuel Cells

Dynamic control of a fuel cell is an important practical problem. During the operation of a fuel cell, both load and fuel input can change. Knowledge of the dynamic behavior is required to predict the response and control a fuel cell's operation for a desired performance in the face of both internal and external disturbances. The dynamic behavior of a fuel cell can be best studied through the linearized small-signal model, which, however, is not known to exist previously. The approach used to obtain the small-signal model for batteries is used here again for fuel cells.

First, the steady-state operating point is obtained by setting differential equations \dot{V}₀=0 and \dot{C}ₑ=0. From Equations (108) and (109), this yields:

i_{f}−i (112)

Cₑ=C₀−i_{f}R_{TL}=C₀−iR_{TL} (113)

For the fuel cell studied earlier, if the operating at current is i=10 A, the steady-state point for Cₑ is, from Equation (110):

Ĉₑ=C0−i_{f}R_{TL}=1−10×0.001=0.99

Linearization of the Nernst equation (105) and the charge transfer polarization of Equation (106) around the steady-state operating point results in the conversion constant and charge transfer resistance,

$$κ = \frac{ⅆ {E}_{ocv}}{ⅆ {C}_{e}} = 0.052 \frac{1}{{\hat{C}}_{e}} = \frac{0.052}{0.99} = 0.053 \qquad ( 114 )$$

$${{R}_{ct} = b \frac{1}{i} \vert}_{i = \hat{i}} = b \frac{1}{\hat{i}} = \frac{0.026}{20} = 0.0013 \qquad ( 115 )$$

The concentration polarization of Equation (104) can also be linearized with respect to the operating current i as:

$${R}_{c} = \frac{ⅆ {η}_{c}}{ⅆ i} = h \frac{\hat{i}}{{i}_{L} - \hat{i}} = 0.06 x \frac{10}{100 - 10} = 0.0067 \qquad ( 116 )$$

For the linearized small-signal model, if can now be expressed as:

$$δ {i}_{f} = \frac{{δη}_{ct}}{{R}_{ct}} = \frac{δ {E}_{ocv}^{1} - δ {V}_{1}}{{R}_{ct}} = \frac{κ δ {C}_{e} - δ {V}_{1}}{{R}_{ct}} \qquad ( 117 )$$

Use of Equation (117) in (108) and (109) produces the state equations for the small-signal model of the fuel cell:

$$\begin{matrix}δ {\dot{V}}_{1} = \frac{1}{{R}_{ct} {C}_{d}} δ {V}_{1} - \frac{K}{{R}_{ct} {C}_{d} } δ {C}_{e} + \frac{1}{{C}_{d}} δ i & ( 118 ) \\ δ {\dot{C}}_{e} = - \frac{1}{{R}_{ct} {C}_{TL}} δ {V}_{1} + ( \frac{K}{{R}_{ct} {C}_{TL}} + \frac{1}{{R}_{TL} {C}_{TL}} ) δ {C}_{e} - \frac{1}{{R}_{TL} {C}_{TL}} δ {C}_{0} & ( 119 )\end{matrix}$$

These state equations can also be obtained using the normal method in control theory to derive i the linearized small-signal model from a nonlinear system. The dynamic equations of the fuel cell are Equations (108) and (109). The nonlinearity of the system comes from the Faradaic current relationship:

$$\begin{matrix}{η}_{ct} = a + b1 n ( {i}_{f} ) \\ Therefore & \\ {i}_{f} = exp [ \frac{{η}_{ct} - a}{b} ] & ( 120 )\end{matrix}$$

The charge polarization Ct is:

η=E_{ocv}−V₁=E₀+0.0521n[Cₑ]=V (121)

Substituting Equation (121) into (120) and using the result in Equations (108) and (109) yields:

$$\begin{matrix}{\dot{V}}_{1} = \frac{1}{{C}_{d}} \{ i - exp [ \frac{{E}_{0} + 0.0521 {nC}_{e} - {V}_{1} - a}{b} ] \} & ( 122 ) \\ {\dot{C}}_{e} = \frac{exp [ ( {E}_{0} + 0.0521 n {C}_{e} - {V}_{1} - a ]}{{C}_{TL}} - \frac{1}{{C}_{TL} {R}_{TL}} ( {C}_{0} - {C}_{e} & ( 123 )\end{matrix}$$

The system matrix A for the small-signal model can be obtained from:

$$A = [ \begin{matrix}\frac{\partial {\dot{V}}_{1}}{\partial {V}_{1}} & \frac{\partial {\dot{V}}_{1}}{\partial {C}_{e}} \\ \frac{\partial {\dot{C}}_{e}}{\partial {V}_{1}} & \frac{\partial {\dot{C}}_{e}}{\partial {C}_{e}}\end{matrix} ] \qquad ( 124 )$$

Performing the derivatives in Equations (124) yields:

$$\begin{matrix}\frac{\partial {\dot{V}}_{1}}{\partial {V}_{1}} = \frac{1}{{C}_{d}} [ {\hat{i}}_{d} \frac{1}{b} ] = \frac{1}{{C}_{d}} \frac{{\hat{i}}_{d}}{b} & ( 125 ) \\ \frac{\partial {\dot{V}}_{1}}{\partial {C}_{e}} = \frac{1}{{C}_{d}} [ - {\hat{i}}_{d} \frac{1}{b} \frac{0.052}{{C}_{e}} ] & ( 126 ) \\ \frac{\partial {\dot{C}}_{e}}{\partial {V}_{1}} = - \frac{1}{{C}_{TL} {R}_{TL}} & ( 127 ) \\ \frac{\partial {\dot{C}}_{e}}{\partial {C}_{e}} = \frac{1}{{C}_{TL}} \frac{{\hat{i}}_{d}}{b} \frac{0.052}{{C}_{e}} + \frac{1}{{C}_{TL} {R}_{TL}} & ( 128 )\end{matrix}$$

where î_{d}=exp[E₀+0.0521nCₑ−V₁−a]|b. Recognizing that:

$$\begin{matrix}{R}_{cl} = \frac{b}{{\hat{i}}_{d}} \\ and & ( 129 ) \\ K = \frac{0.052}{{C}_{e}} & ( 130 )\end{matrix}$$

Using Equations (129) and (130) in Equations (125) to (128) yields:

$$\begin{matrix}\frac{\partial {\dot{V}}_{1}}{\partial {V}_{1}} = \frac{1}{{C}_{d} {R}_{TL}} \\ \frac{\partial {\dot{V}}_{1}}{\partial {C}_{e}} = - \frac{K}{{C}_{d} {R}_{TL}} \\ \frac{\partial {\dot{C}}_{e}}{\partial {V}_{1}} = - \frac{1}{{C}_{TL} {R}_{TL}} \\ \frac{\partial {\dot{C}}_{e}}{\partial {C}_{e}} = \frac{K}{{C}_{TL} {R}_{TL}} + \frac{1}{{C}_{TL} {R}_{TL}}\end{matrix}$$

These coefficients are the same as the ones used in Equations (118) and (119) and verifies the linearization process to obtain a small-signal model for the fuel cell.

The output of the small-signal model is:

$$δ {V}_{T} = [ 10 ] [ \begin{matrix}δ {V}_{1} \\ {δC}_{e}\end{matrix} ] - ( {R}_{c} \_ + {R}_{s} ) δ i \qquad ( 131 )$$

There are two inputs to the small-signal model. One is the variation of the fuel concentration C₀, the other is a small disturbance to the operating current i. The input matrix of the linearized system for the input vector

$$[ \begin{matrix}δ i \\ δ {C}_{0}\end{matrix} ] is :$$

$$B = [ \begin{matrix}\frac{1}{{C}_{d}} & 0 \\ 0 & - \frac{1}{{R}_{TL} {C}_{TL}}\end{matrix} ]$$

To see the effect of the load change, i.e., i, the following state-space equations, using numerical values, are obtained.

$$[ \frac{\partial {\dot{V}}_{1}}{\partial {\dot{C}}_{e}} ] = [ \begin{matrix}- 15.3846 & 0.0038 \\ 3.8462 & - 3.8512\end{matrix} ] [ \frac{\partial {V}_{1}}{\partial {C}_{e}} ] + [ \begin{matrix}0.02 \\ 0\end{matrix} ] δ i$$

$$δ {\dot{V}}_{T} = [ 10 ] [ \begin{matrix}δ {V}_{1} \\ {δC}_{e}\end{matrix} ] - ( 0.0067 + 0.02 ) δ i$$

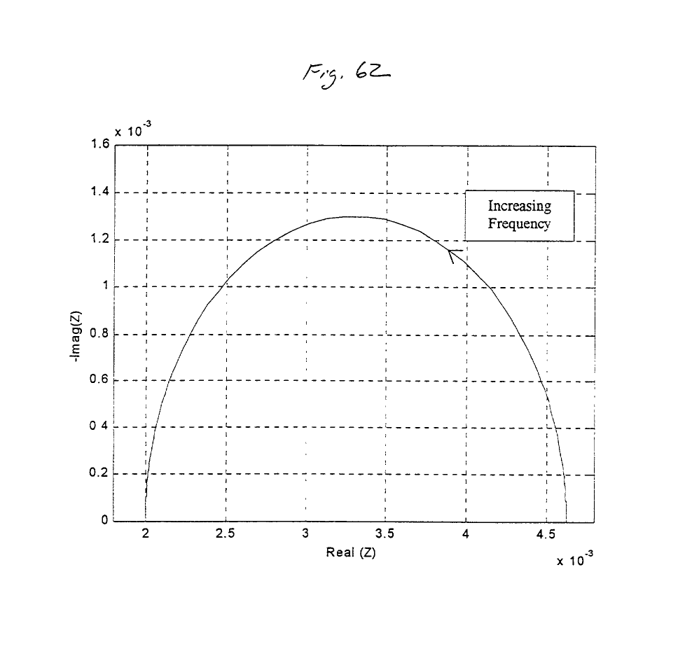

The linearized response of the V_{T} a step input i=1 A is shown in FIG. 61 where it is compared with the dynamic response of the nonlinear system. Here i=1 A represents a change of the discharge current from a steady-state 10 A to 9 A, thus the increase of the terminal voltage. It is seen from the Fig. that the linearized model is an excellent representation of the dynamic behavior of the original nonlinear fuel cell model at the selected operating point. The impedance of the small-signal model of the fuel cell is shown in FIG. 62. Compared to batteries, a notable feature about the impedance of the small-signal model for fuel cells is that the CPE behavior for the diffusion process of a battery no longer exists with a fuel cell. The diffusion process for the fuel cell is now represented by a R-C circuit, which simplifies matters considerably.

In summary, the modeling method developed for batteries was extended to fuel cells. The differences between fuel cells and batteries were compared and then reflected in the fuel cell model. The steady-state and dynamic behavior of a fuel cell was analyzed. The maximum power output problem was formulated from the analysis of the fuel cell's steady-state operation. Knowledge about the dynamic behavior obtained from the small-signal model analysis of the fuel cell can be used in the control system design.

The major contributions and advantages of the research described above are in two areas. First a new modeling approach was developed for galvanic devices including batteries and fuel cells. The new approach overcomes some drawbacks of the existing modeling methods based on the First Principles or the empirical approach. Compared to the First Principles modeling approach, it is simpler to obtain a battery model using the new approach, thanks to the fact that the new modeling approach does not require extensive electrochemical data and device-specific information. The resulting model from the new approach is thus chemistry- and device-independent. This feature is important and highly desirable in practical applications. The new modeling approach is physics-based in that important electrochemical processes are reflected in the model. This is the fundamental difference between the new approach and the empirical approach. In the development of the new modeling approach, a battery model expressed by an equivalent electrical circuit was first constructed. The physical meaning of each component in the model is clearly related to the processes or mechanisms of a battery. The physiochemical processes m a battery were analyzed and their representations by the equivalent circuit components were justified. This model structure, or framework, is representative of many batteries in their working mechanisms and can be used as a starting point in obtaining models of the actual devices. All that is left is to determine the values of the parameters for each component in the model from the response data of the actual device. A parameter identification process was developed to relate the device response data to the parameters of the model components. The model structure along with the parameter identification process together is the novelty of the modeling approach for galvanic devices presented in this paper. The new technique provides a practical approach for battery users to obtain a useful, accurate and valid model of batteries.

The validity of the model and modeling procedures were verified with several actual devices operating under various conditions. The results of the validation process demonstrate that the new model is an accurate and effective representation of the performance behavior of different types of batteries over a wide range of operating modes. The capabilities of the model to simulate many practical operating conditions, which include arbitrary discharge and charge patterns, by one uniform model is unprecedented. The new model is also versatile in that it is easy to add new components to account for the behavior that are deemed important in specific situations. Thanks to the compatible format of the new model and its simplicity, the new model can be used in a circuit simulator to study the interactions between a galvanic device and the rest of the system. This capability from the new model is not feasible with existing battery models.

The second contribution of this research is the application of the newly developed battery model. The utility of the model was first shown in an innovative solution to the battery state of charge problem. The solution is based on the insight gained about the operation of a battery and the capability to extract accurate internal information from the new battery model. The device characteristics of a battery were then studied using circuit analysis techniques. Linearized models were used for the analysis of both steady-state and dynamic behavior of a battery. The steady-state analysis reveals the relationship of the state of charge to the internal impedance. It can also be used for algorithm development for the maximum power output problem. The dynamic behavior of a battery was analyzed using a small-signal model, derived from the new model. The dynamic analysis explained the effect of the pulsed discharge on the delivered charge capacity and energy of a battery. It also provides a theoretical basis to use AC impedance technique in battery health monitoring and failure prediction.

The modeling approach developed for batteries was then extended to fuel cells. Differences between a fuel cell and a battery were compared and reflected in the fuel cell model. The device characteristics of a fuel cell were analyzed with the new model. Some device behavior of a fuel cell, such as maximum power output and dynamic response, were revealed in this paper. Again, this analysis enhances the understanding of the behavior of fuel cells and may assist in developing more efficient use of the device.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A method for improving the design and performance of an actual galvanic device, comprising:
establishing an equivalent circuit that includes electrical components for the galvanic device;
consolidating physical processes for said electrical components;
establishing mathematical relationships describing the behavioral components of each said component; and
identifying parameters of each said component to develop a model of the actual galvanic device.

2. The method according to claim 1, further comprising:
correlating response data to the parameters of said components.

3. The method according to claim 2, further comprising:
analyzing the device characteristics for optimizing design of the device.

4. The method according to claim 3, further comprising:
manufacturing galvanic devices based on said analyzing step.
